(19) United States
(12) Patent Application Publication
(10) Pub. No.: US 2026/0068915 A1
(43) Pub. Date: Mar. 12, 2026

(54) Lipid Compositions and Methods Thereof

(71) Applicant: National University of Singapore, Singapore (SG)

(72) Inventors: Max Jing Rui Tham, Singapore (SG); Jia Yang Chia, Singapore (SG); Wee Han Ang, Singapore (SG); Lai Peng Leong, Singapore (SG); Tai Wei David Leong, Singapore (SG); Carina Shu Ying Teh, Singapore (SG)

(21) Appl. No.: 19/325,250

(22) Filed: Sep. 10, 2025

(30) Foreign Application Priority Data
Sep. 10, 2024 (SG) 10202402815T

(51) Int. Cl. A23L 27/26; A23D 9/00

(52) U.S. Cl. CPC A23L 27/26; A23D 9/00

(57) ABSTRACT

The present disclosure concerns a lipid composition, comprising monounsaturated fatty acids at about 10% w/w to about 50% w/w relative to the lipid composition; polyunsaturated fatty acids at about 5% w/w to about 40% w/w relative to the lipid composition; glycerides at about 30% w/w to about 70% w/w relative to the lipid composition; and a catalyst for oxidising the fatty acids and glycerides into volatiles in the presence of heat. The present disclosure also concerns a method of generating a flavour profile, comprising heating a lipid composition as disclosed herein and a method of generating a flavour profile, comprising heating a mixture, the mixture comprising a lipid composition as disclosed herein.

### TECHNICAL FIELD

The present invention relates, in general terms, to lipid compositions and their methods of use thereof.

### BACKGROUND

Livestock husbandry poses a significant problem to climate change, water and land use and pollution. They are also inefficient sources of proteins due to their high feed conversion ratio. For example, 10 kg of feed is required to produce 1 kg of beef. Also, animal meats are becoming a less affordable source of protein for the common masses and the price of meats have inflated by 10.8%, higher than the inflation rate of 8%. These factors calls for the need for alternative proteins in our diets to replace meats to ensure food security and sustainability for the growing population.

Therefore, to increase consumer adoption of alternative proteins, manufacturers must ensure that alternative proteins are substantially more affordable but equally delicious to animal meats. Market survey studies have indicated that at least 50% of American participants and at least 75% of Singaporeans are willing to replace animal meats with alternative meats should these price and quality parameters be met.

Therefore, to increase consumer adoption of alternative proteins, manufacturers must ensure that alternative proteins are substantially more affordable but equally delicious to animal meats.

Thus far, contemporary flavouring solutions employed by major flavour manufacturers remain expensive, as the production of meat-identical flavours using current technologies and methodologies continue to be ineffective, inefficient, and tedious. These flavourings often fail to replicate the chemical complexity of animal meats as their manufacturing depends on limited scope of cooking reactions, specifically focusing on the Maillard Reaction. Particularly, the industry continues to rely on a technique called process flavours wherein amino acids are reacted with reducing sugars in a high temperature and high-pressure environment to generate Maillard Reaction Products such as odorous nitrogen and sulfur-containing heterocycles. For example, traditional synthetic meat flavourings are produced by mixing hydrolysed vegetable proteins (HVP) with difference spices and alliaceous to provide an umami flavour that mimics the brothiness of meats. Attempts of improving the meatiness and beefiness of the flavours include addition of beefy aroma molecules such as 3-methy-2-butanethiol and 2-methyl-3-furanthiol to the process flavours.

Moreover, attempts have been made to increase flavour complexity formed in these process reactions by increasing the chemical complexities of the inputs to obtain a more complex chemical output. Correspondingly, these efforts have ranged from incorporating (i) yeast extracts, (ii) hydrolysed vegetable proteins and (iii) animal fats such as pork, beef and mutton fats into the reaction flavour production processes.

However, these methodologies still fail to replicate the chemical diversity that defines meat flavours, as other modes of cooking reactions, such as Strecker degradation and lipid oxidation that are critical for generating meaty volatiles (see FIG. 1), are not employed as they remain difficult to access and utilize for flavour generation. It has been noted that thermal treatment of lipids to initiate oxidation and formation of lipid oxidation compounds requires high temperature and is difficult to control, as excessive thermal activation produces undesirable volatiles associated with rancidity.

Despite knowledge of fats providing the chemical basis for species-specific meat flavour generation, the industry has focused on using plant-derived lipids to recreate mouthfeel and/or texture of animal-based counterparts, through modulation of melting temperatures and rheological properties respectively. Plant-based fats normally utilise emulsion and encapsulation technologies to modulate textural properties and melting point. Some formulations have been developed to provide controlled release of flavour compounds. However, none have described the use of vegan fat as substrates to drive the generation of meaty volatiles when activated and reacted with flavour catalysts.

It would be desirable to overcome or ameliorate at least one of the above-described problems.

### SUMMARY

The present disclosure concerns a lipid composition, comprising:
a) monounsaturated fatty acids at about 10% w/w to about 50% w/w relative to the lipid composition;
b) polyunsaturated fatty acids at about 5% w/w to about 40% w/w relative to the lipid composition;
c) glycerides at about 30% w/w to about 70% w/w relative to the lipid composition; and
d) a catalyst for oxidising the fatty acids and glycerides into volatiles in the presence of heat.

In some embodiments, the monounsaturated fatty acids, polyunsaturated fatty acids and glycerides are derived from plants, fungal, insect, bacterial, in vitro origins and a combination thereof.

In some embodiments, the monounsaturated fatty acids, polyunsaturated fatty acids and glycerides are derived from a plant source. The plant source may be a vegetable oil.

In some embodiments, the vegetable oil comprises less than about 1 wt % of antioxidants.

In some embodiments, the monounsaturated fatty acids comprise a first C₁₀-C₂₄ monounsaturated fatty acid and a second C₁₀-C₂₄ monounsaturated fatty acid, wherein a concentration of the first monounsaturated fatty acid is about 0.5 times to about 5 times more than the second monounsaturated fatty acid.

In some embodiments, the monounsaturated fatty acids comprise at least three monounsaturated fatty acids, wherein each monounsaturated fatty acid independently comprises C₁₀-C₂₄ alkyl.

In some embodiments, the polyunsaturated fatty acids comprise a first C₁₀-C₂₄ polyunsaturated fatty acid and a second C₁₀-C₂₄ polyunsaturated fatty acid, wherein a concentration of the first polyunsaturated fatty acid is about 0.5 times to about 5 times more than the second polyunsaturated fatty acid.

In some embodiments, the polyunsaturated fatty acids comprise at least three polyunsaturated fatty acids, wherein each polyunsaturated fatty acid independently comprises C₁₀-C₂₄ alkyl.

In some embodiments, the catalyst is an iron-containing complex.

In some embodiments, the catalyst is selected from heme, iron chlorophyllin, a derivative, salt, solvate and a combination thereof.

In some embodiments, the catalyst is at about 0.05% w/w to about 2% w/w relative to the lipid composition.

In some embodiments, the lipid composition further comprises a saturated fatty acid at about 20% w/w to about 60% w/w relative to the lipid composition.

In some embodiments, the volatiles comprise alkane, aldehyde, epoxide, thiol, salt, ester, ketone, alcohol, heterocycle, carboxylic acid, hydrazine, or a combination thereof.

In some embodiments, when heated, the lipid composition is characterised by a volatile profile comprising C₁ to C₁₅ acyl compound.

In some embodiments, the lipid composition is characterised by a wt % of about 0.5 wt % to about 90 wt % of C₁ to C₁₅ acyl compound relative to the volatile profile.

In some embodiments, the lipid composition is characterised by a % increase of C₁ to C₁₅ acyl compound of about 150% to about 2500% in the volatile profile relative to the volatile profile of a control, the control being a lipid composition without a catalyst.

In some embodiments, when heated, the lipid composition is characterised by a volatile profile further comprising C₁ to C₁₅ alcohol.

In some embodiments, the lipid composition is characterised by a wt % of about 5 wt % to about 20 wt % of C₁ to C₁₅ alcohol relative to the volatile profile.

In some embodiments, the lipid composition is characterised by a % increase of C₁ to C₁₅ alcohol of about 100% to about 300% in the volatile profile relative to the volatile profile of a control, the control being a lipid composition without a catalyst.

In some embodiments, when heated, the lipid composition is characterised by a volatile profile further comprising C₁ to C₁₅ carboxyl compound.

In some embodiments, the lipid composition is characterised by a wt % of about 0.5 wt % to about 20 wt % of C₁ to C₁₅ carboxyl compound relative to the volatile profile.

In some embodiments, the lipid composition is characterised by a % increase of C₁ to C₁₅ carboxyl compound of about 5% to about 200% in the volatile profile relative to the volatile profile of a control, the control being a lipid composition without a catalyst.

In some embodiments, when heated, the lipid composition is characterised by a volatile profile further comprising C₅ to C₁₅ alkane.

In some embodiments, the lipid composition is characterised by a wt % of about 0.5 wt % to about 20 wt % of C₅ to C₁₅ alkane relative to the volatile profile.

In some embodiments, the lipid composition is characterised by a presence of C₅ to C₁₅ alkane in the volatile profile relative to the absence of C₅ to C₁₅ alkane in the volatile profile of a control, the control being a lipid composition without a catalyst.

In some embodiments, when heated, the lipid composition is characterised by a volatile profile further comprising C₄ to C₁₀ furan.

In some embodiments, the lipid composition is characterised by a wt % of about 1 wt % to about 35 wt % of C₄ to C₁₀ furan relative to the volatile profile.

In some embodiments, the lipid composition is characterised by a presence of C₄ to C₁₀ furan in the volatile profile relative to the absence of C₄ to C₁₀ furan in the volatile profile of a control, the control being a lipid composition without a catalyst.

In some embodiments, when heated, the lipid composition is characterised by a volatile profile further comprising C₁ to C₁₅ sulfur-containing compound.

In some embodiments, the lipid composition is characterised by a wt % of 0 wt % to about 20 wt % of C₁ to C₁₅ sulfur-containing compound relative to the volatile profile.

In some embodiments, the lipid composition is characterised by a % increase of C to C₁₅ sulfur-containing compound of about 5% to about 200% in the volatile profile relative to the volatile profile of a control, the control being a lipid composition without a catalyst.

In some embodiments, the volatile profile is characterised using solid-phase microextraction gas chromatography.

In some embodiments, the lipid composition is encapsulated into a semisolid or solid form.

The present disclosure also concerns a method of generating a flavour profile, comprising heating monounsaturated fatty acids, polyunsaturated fatty acids and glycerides in the presence of a catalyst;
wherein the monounsaturated fatty acids is about 10% w/w to about 50% w/w relative to a total composition;
wherein the polyunsaturated fatty acids is about 5% w/w to about 40% w/w relative to the total composition; and
wherein the glycerides is about 30% w/w to about 70% w/w relative to the total composition.

The present disclosure also concerns a method of generating a flavour profile, comprising heating a lipid composition as disclosed herein.

The present disclosure also concerns a method of generating a flavour profile, comprising heating a mixture, the mixture comprising a lipid composition as disclosed herein.

In some embodiments, the mixture comprises at least one flavour precursor.

In some embodiments, the at least one flavour precursor is selected from sugar, amino acid, vitamin, flavour enhancer, salt and a combination thereof.

In some embodiments, the sugar is selected from monosaccharides, disaccharides, oligosaccharides, polysaccharides, their derivatives and a combination thereof.

In some embodiments, the amino acid is L-amino acid.

In some embodiments, the vitamin is selected from Vitamin A, Vitamin B, Vitamin C, Vitamin D, Vitamin E, Vitamin K and a combination thereof.

In some embodiments, the flavour enhancer is selected from glutamic acid salt (monosodium glutamate), glycine salt, guanylic acid salt, inosinic acid salt, 5′-ribonucleotide salts and a combination thereof.

In some embodiments, the salt is sodium chloride.

In some embodiments, the mixture is characterised by a % w/w of lipid composition of about 40% w/w to about 80% w/w relative to the mixture. In some embodiments, the % w/w is about 50% w/w to about 70% w/w relative to the mixture.

In some embodiments, the mixture is characterised by a % w/w of sugars of about 1% w/w to about 15% w/w relative to the mixture. In some embodiments, the % w/w is about 5% w/w to about 10% w/w relative to the mixture.

In some embodiments, the mixture is characterised by a % w/w of amino acid of about 5% w/w to about 40% w/w relative to the mixture. In some embodiments, the % w/w is about 10% w/w to about 30% w/w relative to the mixture.

In some embodiments, the mixture is characterised by a % w/w of vitamins of about 0.5% w/w to about 10% w/w relative to the mixture. In some embodiments, the

In some embodiments, the mixture is characterised by a % w/w of flavour enhancers of about 0.5% w/w to about 10% w/w relative to the mixture. In some embodiments, the % w/w is about 1% w/w to about 5% w/w relative to the mixture.

In some embodiments, the mixture is characterised by a % w/w of salt of about 1% w/w to about 12% w/w relative to the mixture. In some embodiments, the % w/w is about 3% w/w to about 7% w/w relative to the mixture.

In some embodiments, the mixture is hydrated to form a biphasic solution.

In some embodiments, the mixture is heated at a temperature of about 70° C. to about 400° C.

In some embodiments, the mixture oxidised to form volatiles, generating a flavour profile.

In some embodiments, the volatiles comprise alkane, aldehyde, epoxide, thiol, salt, ester, ketone, alcohol, heterocycle, carboxylic acid, hydrazine, or a combination thereof.

In some embodiments, the flavour profile is characterised by a positive correlation to the amount of volatiles.

### BRIEF DESCRIPTION OF THE DRAWINGS

Embodiments of the present invention will now be described, by way of non-limiting example, with reference to the drawings in which:

FIG. 1. Chemical reactions underlying the formation of key volatiles and non-volatiles in cooked animal meats.

FIG. 2. Volatile profile of lipid composition referred to as Vegan Version of Animal Fat (VVAFP) (in figure) system without Heme Flavour Catalyst (Black, Mixture A) and with Heme Flavour Catalyst (Grey, Mixture B). Coloured circles indicate higher abundance of volatiles found in Mixture B when compared to Mixture A.

FIG. 3. Volatile profile of Beef Fat System without Heme Flavour Catalyst (Grey, Mixture C) and with Heme Flavour Catalyst (Black, Mixture D). Coloured circles indicate higher abundance of volatiles found in Mixture D when compared to Mixture C.

FIG. 4. Quantified abundances of selected volatiles for Mixtures A to D by normalising peak area of volatile against peak area of ethyl acetate internal standard.

FIG. 5. Radial diagram indicating the aroma score given by semi-trained panelists (n=30) when asked to rate Mixture B (VVAFP+Heme), Mixture C (Beef Fat-Heme) and Mixture D (Beef Fat+Heme) against references shown in Table 5. A score of 0 indicates that mixture does not smell like reference, 5 means that mixture smells like reference, and 10 means mixture smells more strongly than reference.

FIG. 6. Volatile composition of flavours produced from animal fats in reaction with the catalyst.

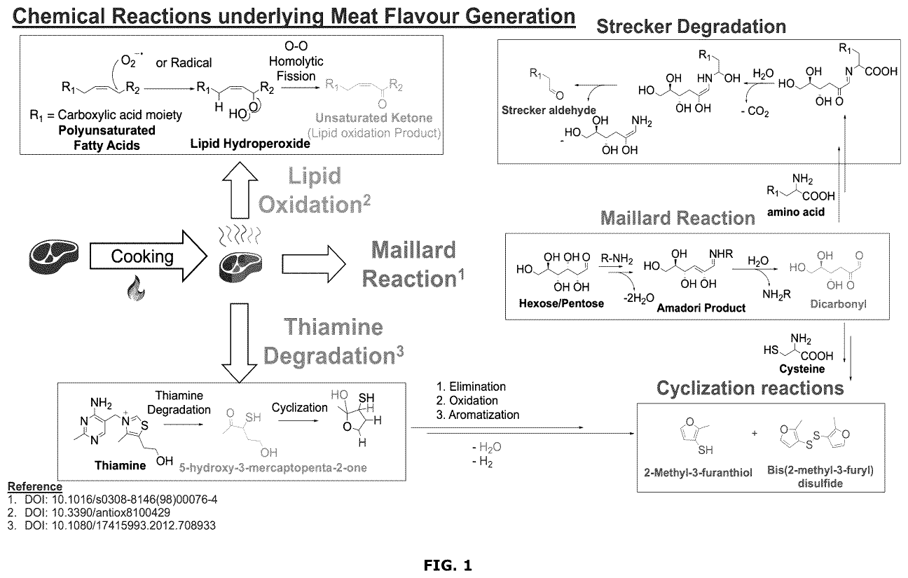

### DETAILED DESCRIPTION

Without wanting to be bound by theory, the manifold complexity of the chemical environment formed in cooked meats is due to the presence of Heme B, which functions as a catalyst that enables many of these reactions. It was found that soy leghemoglobin and myoglobin respectively can significantly increase the abundance and diversity of volatiles formed when cooked together with flavour precursors. Unfortunately, these findings do not conclusively elucidate the major molecular mechanisms of how these hemoproteins catalyse these cooking reactions, nor do they identify major volatile output patterns. Furthermore, haemoglobin have shown to have contradictory effects on flavour generation in certain experiments, with haemoglobin suppressing lipid oxidation reactions in some flavour systems while accelerating these reactions in others. Hence, without a clear understanding of the catalytic mechanisms, it remains elusive how hemoproteins could be exploited to achieve species-specific outcomes.

The present disclosure concerns a lipid composition comprising monounsaturated fatty acids, polyunsaturated fatty acids, triglycerides and a catalyst for breaking down the fatty acids and triglycerides into volatiles in the presence of heat. The lipid composition is designed to mimic fat and may be an alternative meat analogue, such as a vegan version of animal fat. The fatty acids and triglycerides may be obtained from plants, fungal, insect, bacterial or in vitro origins. The lipid composition may improve the flavour of plant-based meat flavourings by shifting the focus away from Maillard reaction as a primary method for meat flavour production, and enabling the same higher order, complex cooking reactions to occur, resulting in a meat-identical, palatable flavours from vegan ingredients. The added layer of fatty aroma through the reaction between the catalyst and the fatty acids and triglycerides contributes to the overall meatiness and complexity of the flavours, as well as conferring species-specific flavours, such as pork, chicken, fish, beef, mutton and unagi.

Recognisable meaty flavours currently still depend on animal meat extracts to produce species-specific flavours, which are subjected to unsustainable livestock farming, volatile prices and limitations to the vegetarian and vegan community. Current flavours are dependent on animal product to achieve meat-identical flavours, which are expensive and excludes demographics (i.e. vegans and vegetarians). The lipid composition may mimic the chemical environment of animal fat to give a complete and identical species-specific meat flavour while increasing customer scope. Providing low-cost plant-based versions of these flavouring components, such as the lipid composition disclosed herein, may decouple this dependency on animal products, at a sustainable and cost-effective manner. The use of existing flavourings for plant-based meats may contribute to around 40% of the bill of materials of plant-based meat analogues due to the incomplete nature of meat analogue flavourings that are unable to recreate the complexity of meat flavour without the fatty portion. The lipid composition may present an all-in-one flavour solution for the alternative protein manufacturers, hence lowering their flavouring costs significantly as they are only depending on one flavouring. The potential benefits may include the development of highly affordable flavouring ingredients given their derivation from more abundant sources and the introduction of a higher throughput, more cost-effective method for flavour development.

Lipid oxidation has been known to confer species-specific flavours. For example, studies have shown that the flavour profile of beef is heavily predicated on the fatty acid content of the cows, as the feed and breed strongly influences the flavour perception of the resultant beef. The lipid composition may undergo lipid oxidation, where the presence of the catalyst may improve the efficiency of flavour generation, generating flavours that may be identical to meat flavours. The lipid composition may be varied to emit species-specific flavours such as flavours of eel, fish and pork. The lipid composition may be applied to alternative protein products as an ingredient to alter their flavour (by modulating aroma and taste), textural (by changing mouthfeel and melting temperature) and nutritional properties (providing more nutritious unsaturated lipids).

Accordingly, the present disclosure concerns a lipid composition, comprising:
a) monounsaturated fatty acids at about 10% w/w to about 50% w/w relative to the lipid composition;
b) polyunsaturated fatty acids at about 5% w/w to about 40% w/w relative to the lipid composition;
c) glycerides at about 30% w/w to about 70% w/w relative to the lipid composition; and
d) a catalyst for breaking down the fatty acids and glycerides into volatiles in the presence of heat.

Lipids are components of plant and animal tissues such as vegetable oils, meat, eggs and milk. Lipids contribute to food flavour generation due to their degradation to volatile compounds during food processing, heating/cooking, and storage and/or interactions with other constituents developed from the Maillard reaction and Strecker degradation, among others. The degradation of lipids mainly occurs via autoxidation, photooxidation, and enzymatic oxidation, which produce a myriad of volatile compounds. The oxidation of unsaturated fatty acids generates hydroperoxides that then further break down to odour-active volatile secondary lipid oxidation products including aldehydes, alcohols, and ketones. They are organic compounds and esters of fatty acids and glycerol or other alcohols. Lipids may be fats. A fatty acid is a carboxylic acid with an aliphatic chain, which may be saturated or unsaturated. A saturated fatty acid has no double bonds and are straight chained. An unsaturated fatty acid may contain a single double bond (monounsaturated) or more than one double bond (polyunsaturated). Polyunsaturated fatty acids may be important substrates for lipid oxidation reactions due to their high propensity for radical hydrogen abstraction. Fatty acid composition and structure may determine the physical property and nutritional quality of fats. Accordingly, in some embodiments, the lipid composition comprises fatty acids. In some embodiments, the fatty acid is monounsaturated fatty acid. In some embodiments, the fatty acid is polyunsaturated fatty acid.

Having both monounsaturated and polyunsaturated fatty acids may increase the chemical diversity of the flavour precursor starting mixture. This means that when the reaction between the oxidising catalyst and the fatty acids are initiated (through application of heat), the resultant catalysed lipid oxidation reactions may produce a greater abundance and heterogeneity of odorous lipid oxidation volatile product matrix, which when perceived by one's olfactory (smell) and gustatory (taste) sensorial faculties may translate into a more natural, more meat-identical flavour being perceived. If either monosaturated or polyunsaturated fatty acids are used in isolation of each other and/or in an inappropriate proportions, unidentifiable or unappealing flavours may result.

Glycerides are esters formed from glycerol and fatty acids. Glycerol has three hydroxyl functional groups, which may be esterified with one, two or three fatty acids to form monoglycerides, diglycerides, and triglycerides. The structures of the different glycerides may vary in their fatty acid residues as the fatty acids residues may contain different carbon numbers, different degrees of unsaturation, and different configurations. It is believe that the glycerides “protect” the fatty acids from oxidation, and delays the release of volatiles from fatty acids derived from glycerides. Thus, upon contact with heat, monounsaturated fatty acids and polyunsaturated fatty acids provides a first burst of volatiles, while fatty acids derived from glycerides are provided in delayed release. This prolongs the sensory profile of the food. The gradual formation and release of the volatiles may create a more complex and long lasting sensory experience.

In some embodiments, the lipid composition comprises glycerides. In some embodiments, the lipid composition comprises monoglycerides, diglycerides, triglycerides or a combination thereof.

In some embodiments, the lipid composition comprises:
a) monounsaturated fatty acids at about 10% w/w to about 50% w/w relative to the lipid composition;
b) polyunsaturated fatty acids at about 5% w/w to about 40% w/w relative to the lipid composition;
c) triglycerides at about 30% w/w to about 70% w/w relative to the lipid composition; and
d) a catalyst for breaking down the fatty acids and triglycerides into volatiles in the presence of heat.

In some embodiments, the lipid composition comprises triglycerides. A triglyceride is an ester derived from glycerol and three fatty acids. Triglycerides are the main constituents of body fats in humans and other vertebrates as well as vegetable fats. The three fatty acids may differ in chain length and may be saturated or unsaturated. The number of double bonds in the fatty acids may also vary. The three fatty acids may be the identical for a triglyceride or different, known as a mixed triglyceride. Triglycerides with saturated fatty acids may have a higher melting point than triglycerides with unsaturated fatty acids of the same molecular weight and thus tend to be solids at room temperature. Triglycerides with unsaturated fatty acids may have a lower melting point and thus tend to be liquids at room temperature.

Depending on the fatty acid composition of the triglycerides, where if the triglyceride contains monounsaturated and/or polyunsaturated fatty acid residues, these residues may undergo the same lipid oxidation upon interaction with the catalyst as their corresponding free monounsaturated and free polyunsaturated fatty acids.

In some embodiments, the lipid composition comprises a catalyst for breaking down the fatty acids and glycerides into volatiles in the presence of heat. The catalyst may lower the activation energy of the lipid oxidation reactions of breaking down the fatty acids and glycerides into volatiles. The lipid oxidation of the lipid composition may confer flavour complexity and species-specific flavour profiles. The catalyst may improve the efficiency of flavour generations and may ensure efficacious formation of meat-identical flavours at milder reaction conditions and shorter heating times compared to conventional processed flavours.

Heating promotes the oxidation of unsaturated fatty acids, leading to the formation of aldehydes, ketones, alcohols, and other volatile compounds. These oxidation products may impart desirable nutty, toasted, or savoury flavours. High temperatures may cause the breakdown of fatty acids through pyrolysis and other thermal reactions. This may generate a wide range of volatile compounds, including alkanes, alkenes, furans, and aromatic compounds. These thermal degradation products may contribute to the roasted, caramelized, or smoky flavours. Heating may cause the isomerization of unsaturated fatty acids, converting cis-configurations to trans-configurations. This may alter the physical and sensory properties of the lipid, potentially contributing to changes in flavour perception.

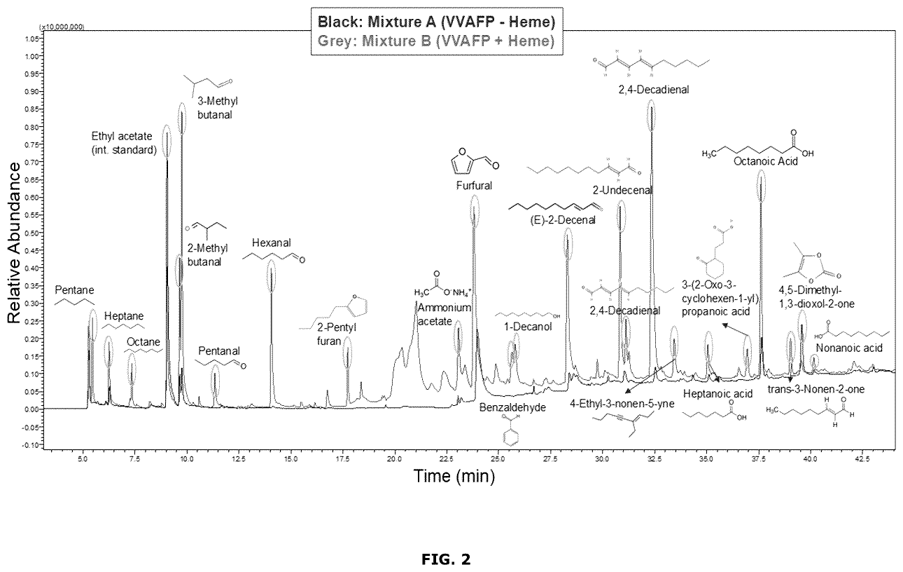

When the lipid composition is heated, the chemical pre-environment may result in a cascade of chemical reactions that result in the formation of a chemical environment similar to that of animal meats, thus producing a flavour profile that resembles that of a particular animal. The catalyst reacts with the lipid composition to form and release a matrix of volatiles that may be specific to a particular animal species, thus mimicking the flavour profile of the animal species. For example in FIG. 2, the catalyst catalyses the formation of more volatiles from a lipid composition with a catalyst when compared to the volatiles obtained from a lipid composition without a catalyst.

In some embodiments, the monounsaturated fatty acids are at about 10% w/w to about 50% w/w relative to the lipid composition. In other embodiments, the % w/w is about 10% w/w to about 45% w/w, about 10% w/w to about 40% w/w, about 10% w/w to about 35% w/w, about 15% w/w to about 50% w/w, about 15% w/w to about 45% w/w, 15% w/w to about 40% w/w, about 15% w/w to about 35% w/w, about 20% w/w to about 50% w/w, about 20% w/w to about 45% w/w, about 20% w/w to about 40% w/w, about 20% w/w to about 35% w/w, about 25% w/w to about 50% w/w, about 25% w/w to about 45% w/w, about 25% w/w to about 40% w/w, about 25% w/w to about 35% w/w, about 30% w/w to about 50% w/w, about 30% w/w to about 45% w/w, about 30% w/w to about 40% w/w, or about 30% w/w to about 35% w/w relative to the lipid composition. In some embodiments, the % w/w is about 20% w/w to about 40% w/w relative to the lipid composition.

In some embodiments, the polyunsaturated fatty acids are at about 5% w/w to about 40% w/w relative to the lipid composition. In other embodiments, the % w/w is about 5% w/w to about 35% w/w, about 5% w/w to about 30% w/w, about 5% w/w to about 25% w/w, about 5% w/w to about 20% w/w, about 10% w/w to about 40% w/w, about 10% w/w to about 35% w/w, about 10% w/w to about 30% w/w, about 10% w/w to about 25% w/w, about 10% w/w to about 20% w/w, about 15% w/w to about 40% w/w, about 15% w/w to about 35% w/w, about 15% w/w to about 30% w/w, about 15% w/w to about 25% w/w, about 15% w/w to about 20% w/w, about 20% w/w to about 40% w/w, about 20% w/w to about 35% w/w, about 20% w/w to about 30% w/w, about 20% w/w to about 25% w/w, about 25% w/w to about 40% w/w, about 25% w/w to about 35% w/w, or about 25% w/w to about 30% w/w relative to the lipid composition. In some embodiments, the % w/w is about 20% w/w to about 30% w/w relative to the lipid composition.

In some embodiments, the glycerides are at about 30% w/w to about 70% w/w relative to the lipid composition. In other embodiments, the % w/w is about 30% w/w to about 65% w/w, about 30% w/w to about 60% w/w, about 30% w/w to about 55% w/w, about 30% w/w to about 50% w/w, about 35% w/w to about 70% w/w, about 35% w/w to about 65% w/w, about 35% w/w to about 60% w/w, about 35% w/w to about 55% w/w, about 35% w/w to about 50% w/w, about 40% w/w to about 70% w/w, about 40% w/w to about 65% w/w, about 40% w/w to about 60% w/w, about 40% w/w to about 55% w/w, about 40% w/w to about 50% w/w, about 45% w/w to about 70% w/w, about 45% w/w to about 65% w/w, about 45% w/w to about 60% w/w, about 45% w/w to about 55% w/w, or about 45% w/w to about 50% w/w relative to the lipid composition. In some embodiments, the % w/w is about 40% w/w to about 60% w/w relative to the lipid composition.

Accordingly, in some embodiments, the lipid composition comprises:
a) monounsaturated fatty acids at about 20% w/w to about 40% w/w relative to the lipid composition;
b) polyunsaturated fatty acids at about 20% w/w to about 30% w/w relative to the lipid composition;
c) glycerides at about 40% w/w to about 60% w/w relative to the lipid composition; and
d) a catalyst for breaking down the fatty acids and glycerides into volatiles in the presence of heat.

In some embodiments, the triglycerides are at about 30% w/w to about 70% w/w relative to the lipid composition. In other embodiments, the % w/w is about 30% w/w to about 65% w/w, about 30% w/w to about 60% w/w, about 30% w/w to about 55% w/w, about 30% w/w to about 50% w/w, about 35% w/w to about 70% w/w, about 35% w/w to about 65% w/w, about 35% w/w to about 60% w/w, about 35% w/w to about 55% w/w, about 35% w/w to about 50% w/w, about 40% w/w to about 70% w/w, about 40% w/w to about 65% w/w, about 40% w/w to about 60% w/w, about 40% w/w to about 55% w/w, about 40% w/w to about 50% w/w, about 45% w/w to about 70% w/w, about 45% w/w to about 65% w/w, about 45% w/w to about 60% w/w, about 45% w/w to about 55% w/w, or about 45% w/w to about 50% w/w relative to the lipid composition. In some embodiments, the % w/w is about 40% w/w to about 60% w/w relative to the lipid composition.

In some embodiments, the lipid composition comprises:
a) monounsaturated fatty acids at about 20% w/w to about 40% w/w relative to the lipid composition;
b) polyunsaturated fatty acids at about 20% w/w to about 30% w/w relative to the lipid composition;
c) triglycerides at about 40% w/w to about 60% w/w relative to the lipid composition; and
d) a catalyst for breaking down the fatty acids and triglycerides into volatiles in the presence of heat.

The above mentioned lipid composition may be used as a healthy additive for meat and plant based food as unsaturated fats are used.

The lipid composition may vary depending on the type of flavour profile targeted as the fat content of the various meat differs from each other. For example, chicken fat may approximately comprises 32.5% saturated fatty acids, 47.5% monounsaturated fatty acid and 20% polyunsaturated fatty acids. Pork fat may approximately comprises 42.5% saturated fatty acids, 45% monounsaturated fatty acids and 12.5% polyunsaturated fatty acids. Beef fat may approximately comprises 45% saturated fatty acids, 50% monounsaturated fatty acids and 5% polyunsaturated fatty acids based on Fatty Acid Methyl Ester (FAMES) quantification experiments. Generic fish fats may approximately contain 35% saturated fatty acids, 25% monounsaturated fatty acids and 40% polyunsaturated fatty acids. In order to mimic the flavour of the various meat with differing fat contents, the w/w % of the monounsaturated fatty acids, polyunsaturated fatty acids and glycerides may be varied.

Fatty acids may be classified according to the length of the fatty acid. Short-chain fatty acids have aliphatic tails of 5 or fewer carbon atoms. Medium-chain fatty acids have aliphatic tails of 6 to 12 carbon atoms. Long-chain fatty acids have aliphatic tails of 13 to 21 carbon atoms. Very long-chain fatty acids have aliphatic tails of 22 or more carbon atoms. In some embodiments, the fatty acids is selected from short-chain fatty acids, medium-chain fatty acids, long-chain fatty acids, very long-chain fatty acids and a combination thereof.

In some embodiments, the monounsaturated fatty acids is selected from short-chain monounsaturated fatty acids, medium-chain monounsaturated fatty acids, long-chain monounsaturated fatty acids, very long-chain monounsaturated fatty acids and a combination thereof. Short-chain monounsaturated fatty acids may be butyric acid and pentatonic acid. Medium-chain monounsaturated fatty acids may be hexenoic acid, caproleic acid, caproleic acid and lauroleic acid. Long-chain monounsaturated fatty acids may be tridecenoic acid, myristoleic acid, pentadecenoic acid, palmitoleic acid, heptadecenoic acid, oleic acid, gadoleic acid, and heneicosenoic acid. Very long-chain monounsaturated fatty acids may be erucic acid, nervonic acid, hexacosenoic acid and octacosenoic acid.

In some embodiments, the monounsaturated fatty acids is selected from caproleic acid, oenanthic acid, caproleic acid, pelargonic acid, decanoic acid, undecanoic acid, dodecenoic acid, tridecanoic acid, euric acid, nervonic acid, oleic acid, myristoleic acid, palmitoleic acid, elaidic acid, vaccenic acid, gadoleic acid, and a combination thereof. In some embodiments, the monounsaturated fatty acid is oleic acid. In some embodiments, the monounsaturated fatty acids is selected from oleic acid, myristoleic acid, palmitoleic acid, elaidic acid, vaccenic acid, gadoleic acid, and a combination thereof. In some embodiments, the monounsaturated fatty acid is oleic acid.

In some embodiments, the polyunsaturated fatty acids is selected from short-chain polyunsaturated fatty acids, medium-chain polyunsaturated fatty acids, long-chain polyunsaturated fatty acids, very long-chain polyunsaturated fatty acids and a combination thereof. Short-chain polyunsaturated fatty acids may be butynoic acid. Medium-chain polyunsaturated fatty acids may be hexadienoic acid, octadienoic acid, decadienoic acid, dodecadienoic acid. Long-chain polyunsaturated fatty acids are more prevalent as compared to short-chain and medium-chain polyunsaturated fatty acids. Long-chain polyunsaturated fatty acids may be tetradecadienoic acid, hexadecadienoic acid, linolenic acid, and heneicosapentaenoic acid. Very long-chain polyunsaturated fatty acids may be docosadienoic acid, docosapentaenoic acid, and tetracosahexaenoic acid. The polyunsaturated fatty acids may be omega-6 and omega-3 fatty acids. The omega-3 fatty acids may be α-linolenic acid (ALA), eicosapentaenoic acid (EPA) and docosahexaenoic acid (DHA). The omega-6 fatty acids may be linoleic acid and arachidonic acid.

In some embodiments, the polyunsaturated fatty acids is selected from hexadienoic acid, heptadienoic acid, octadienoic acid, nonadienoic acid, decadienoic acid, dodecadienoic acid, hexadecadienoic acid, linoleic acid, linolenic acid, docosahexaenoic acid, eicosapentaenoic acid, tetracosahexaenoic acid and a combination thereof. In some embodiments, the polyunsaturated fatty acids is selected from linoleic acid, linolenic acid, docosahexaenoic acid, eicosapentaenoic acid, and a combination thereof.

In some embodiments, the glycerides comprise short-chain fatty acids, medium-chain fatty acids, long-chain fatty acids, very long-chain fatty acids or a combination thereof. Glycerides with short-chain fatty acids are uncommon and an example may be glycerides comprising butyric acid. Glycerides with medium-chain fatty acids may be glycerides comprising caproic acid, capryic acid, capric acid, or a combination thereof. Glycerides with long-chain fatty acids may be glycerides comprising oleic acid, linoleic acid, or a combination thereof. Glycerides with very long-chain fatty acids may be glycerides comprising erucic acid, nervonic acid, hexacosenoic acid, or a combination thereof.

In some embodiments, the glycerides comprise fatty acids selected from C₅-C₃₀ fatty acids.

In some embodiments, the glycerides comprise fatty acids selected from C₅-C₂₅ fatty acids.

In some embodiments, the glycerides comprise fatty acids selected from C₆-C₂₀ fatty acids.

In some embodiments, the glycerides comprise fatty acids selected from C₁₂-C₂₄ fatty acids.

In some embodiments, the glycerides comprise fatty acids selected from C₁₀-C₂₄ fatty acids.

In some embodiments, the glycerides comprise triglycerides with short-chain fatty acids, medium-chain fatty acids, long-chain fatty acids, very long-chain fatty acids or a combination thereof. Triglycerides with short-chain fatty acids are uncommon and an example may be tributyrin. Triglycerides with medium-chain fatty acids may be tricaproin, tricaprylin, tricaprin, trilaurin, tricaproenoin, tricotenoin, tridecenoin, and trilinolein. Triglycerides with long-chain fatty acids may be tridecanoylglycerol, tripentadecanoylglycerol, tripalmitoleoylglycerol (tripalmitolein), trioleylglycerol (triolein), trilinolein, trilinolenin, and trieicosenoylglycerol. Triglycerides with very long-chain fatty acids may be tribehenylglycerol, trierucylglycerol, and tetracosenoylglycerol. The triglycerides may be a mixture of triglycerides derived from vegetable oil. The vegetable oil may be seed oil or fat such as soybean oil, grape seed oil, cocoa butter, or fat from another part of the plant such as olive oil, palm oil and rice bran oil.

In some embodiments, the glycerides comprise triglycerides with fatty acids, the fatty acids selected from C₅-C₃₀ fatty acids. In some embodiments, the glycerides comprise triglycerides with fatty acids, the fatty acids selected from C₅-C₂₅ fatty acids. In some embodiments, the glycerides triglycerides with fatty acids, the fatty acids selected from C₆-C₂₄ fatty acids. In some embodiments, the glycerides comprise triglycerides with fatty acids, the fatty acids selected from C₁₂-C₂₄ fatty acids. In some embodiments, the glycerides comprise triglycerides with fatty acids, the fatty acids selected from C₁₀-C₂₄ fatty acids.

In some embodiments, the monounsaturated fatty acids, polyunsaturated fatty acids and glycerides are derived from plants, fungal, insect, bacterial, in vitro origins and a combination thereof. Plant foods such as nuts, whole grains, vegetable oils are generally high in polyunsaturated fatty acids and monounsaturated fatty acids. The fatty acid composition may vary among the different plant foods and plant oils. For example, grape seed oil may have a high level of polyunsaturated fatty acids and canola oil may have a high level of monounsaturated fatty acid. Microbial oils may be accumulated by microorganisms such as fungal, bacteria and algae, and may be used as a sustainable source for food-related purposes. The fatty acid compositions of these oils are similar to those of vegetable oils with a varying level of polyunsaturated fatty acids and monounsaturated fatty acids such as palmitic acid, oleic acid, linoleic acid and α-linolenic acid. Insect oils may also contain comparable amounts of saturated and unsaturated fatty acids with vegetable oils such as sesame oil, groundnut oil, sunflower oil and cottonseed oil. Insect oils may be obtained from larvae of raphia weevil, crickets, grasshoppers, termites and caterpillars.

In some embodiments, the monounsaturated fatty acids, polyunsaturated fatty acids and glycerides are derived from a plant source. The plant source may be a vegetable oil. Vegetable oils are oils extracted from seeds or from other parts of edible plants. They are mixtures of triglycerides. Soybean oil, grape seed oil and cocoa butter are examples of seed oils. Olive oil, palm oil and rice bran oil are examples of fats from other parts of the plants.

In some embodiments, the triglycerides are derived from vegetable-based cooking oils. Vegetable oils such as olive oil, sunflower oil, soybean oil, canola oil, and corn oil may contain triglycerides. For example, olive oil is a monounsaturated fat that primarily comprises triglycerides, with oleic acid being the abundant fatty acid. Corn oil is a polyunsaturated fat that comprises triglycerides, with linoleic acid being the abundant fatty acid.

Antioxidants may be present in vegetable oils and may be present naturally or added post production for preservative purposes. They may be tocopherols (vitamin E), carotenoids, phenolic compounds and sterols. Antioxidants present in vegetable oils may interfere with the flavour generating reactions and may lead to poor flavour and little meaty properties. The antioxidants may be removed from the vegetable oils to ensure generation of meaty aromas at milder conditions. It may also allow access to a more economical feedstock for the generation of meat-identical flavours. In some embodiments, the vegetable oil is absent of antioxidant. In some embodiments, the lipid composition is absent of an antioxidant. In some embodiments, the vegetable oil comprises less than about 1 wt % of antioxidants. In some embodiments, the lipid composition comprises less than about 1 wt % of antioxidants.

In some embodiments, the catalyst is an iron-containing complex. The iron-containing complex catalyses the flavour generation reactions and may produce meat-identical flavours from the lipid composition. The flavour outcomes may be primarily driven by lipid oxidation reactions as lipid oxidation products, such as aliphatic aldehydes, are formed in abundance only when the iron-containing complexes are present in the lipid composition or in a flavour mixture comprising the lipid composition. The lipid oxidation products may be volatiles. The flavour profile may be species-specific flavours of eel, fish and pork.

In some embodiments, the catalyst is selected from heme, iron chlorophyllin, a derivative, salt, solvate and a combination thereof. The heme may be derived from a plant, algal, bacterial and/or animal source. The iron chlorophyllin may be derived from a plant source such as vegetables or vegan products, or from green algae and chlorophyll-containing bacteria. Preferably, the catalyst is selected from heme derived from a plant source, iron chlorophyllin derived from a plant source, a derivative, salt, solvate and a combination thereof.

Heme is a porphyrin ring complexed with ferrous iron and protoporphyrin IX (PPY9). An example of heme is heme B. Heme B is attached to the surrounding protein matrix (apoprotein) through a single coordination bond between the heme iron and an amino acid side chain. Hemin is a specific form of heme in which protoporphyrin IX contains a ferric iron (Fe³⁺) ion with a coordinating chloride ligand. Hematin is a specific form of heme in which protoporphyrin IX contains a ferric iron (Fe³⁺) ion with a coordinating hydroxide ion.

Structurally identical protoporphyrin IX may also be extracted from animal blood, such as porcine or bovine blood.

The heme may be derived from a non-plant origin (such as eggshell), which is a sustainable source. In particular, eggshells from non-genetically modified animals can be used, thus eliminating the concerns of non-genetic modified organism origins. Eggshells are currently regarded as waste in liquid eggs industries, and being able to use these “waste” solves environmental issues and is green. It is also a cheap source of heme precursor. The heme may also be derived from a plant, alga or bacterium, which expands the available sources of PPY9. For example, the plant source may be spinach. The process of converting PPY9 into heme is disclosed in PCT/SG2022/050864, which is herein incorporated by reference.

In some embodiments, the catalyst is a heme comprising a protoporphyrin IX derived from a plant, algal, bacterial and/or animal source.

In some embodiments, the plant, algal, bacterial and/or animal source is eggshell. In some embodiments, the eggshell is derived from eggs of Gallus gallus domesticus (Chicken), Anas platyrhynchos domesticus (Duck), Coturnix genus (Quails), or a combination thereof.

Animal sources can also include animal bodily fluids (i.e. blood or intramuscular fluid, including plasma and platelets), which contains heme-containing proteins such as, but not limited to, hemoglobin and myoglobin proteins. These bodily fluids can be derived from the slaughter of domesticated animals reared for human consumption including, but not limited to, Gallus gallus domesticus (Chicken), Anas platyrhynchos domesticus (Duck), Bos primigenius taurus (Cow), Suinae sus domesticus (Pig), Capra capra hircus (Goat) and Ovis ovis aries (Sheep).

In some embodiments, the animal source is a blood source. The blood may be derived from porcine or bovine. In some embodiments, the animal source is a non-blood source. In some embodiments, the animal source is not blood, plasma or platelet.

In some embodiments, the plant, algal or bacterial sources is selected from photosynthetic plants, photosynthetic algae, non-photosynthetic algae, cyanobacteria organisms containing chlorophyll, or a combination thereof. Accordingly, fungi are not included within this scope. These plant, algal and bacterial sources generate protoporphyrin IX as a precursor of chlorophyll. For example, plant sources include organisms from Kingdom Plantae. Algae sources include organisms from the Chlorophyta phylum. Cyanobacteria include organisms from the Cyanobacteria phylum, such as, but not limited to, Arthrospira platensis, Arthrospira fusiformis and Arthrospira maxima. PPY9 and Heme may be obtained from non-photosynthetic algae as they contain the cellular machinery for PPY9 and Heme biosynthesis, and therefore would produce and possess these molecules.

In some embodiments, the catalyst is characterised by a presence of an impurity. The impurity may be a heme analog, precursor, or derivative. For example, the impurity may be Protoporphyrinogen IX, Coporphyrinogen III, Uroporphyrinogen III, Coporphyrin, Uroporphyrin, pentacarboxylic porphyrin, or a combination thereof. These impurities may be present in small amounts as a result of the heme extraction process.

In some embodiments, the catalyst is characterised by a presence of Protoporphyrinogen IX. This impurity may be present at less than about 5 wt % relative to the heme. In other embodiments, the concentration is less than about 4 wt %, about 3 wt %, about 2 wt %, about 1 wt %, about 0.8 wt %, about 0.6 wt %, about 0.5 wt %, about 0.4 wt %, about 0.3 wt %, about 0.2 wt %, about 0.1 wt %.

In some embodiments, the catalyst is characterised by a presence of Coporphyrinogen III. This impurity may be present at less than about 5 wt % relative to the heme. In other embodiments, the concentration is less than about 4 wt %, about 3 wt %, about 2 wt %, about 1 wt %, about 0.8 wt %, about 0.6 wt %, about 0.5 wt %, about 0.4 wt %, about 0.3 wt %, about 0.2 wt %, about 0.1 wt %.

In some embodiments, the catalyst is characterised by a presence of Uroporphyrinogen III. This impurity may be present at less than about 5 wt % relative to the heme. In other embodiments, the concentration is less than about 4 wt %, about 3 wt %, about 2 wt %, about 1 wt %, about 0.8 wt %, about 0.6 wt %, about 0.5 wt %, about 0.4 wt %, about 0.3 wt %, about 0.2 wt %, about 0.1 wt %.

In some embodiments, the catalyst is characterised by a presence of Coporphyrin. This impurity may be present at less than about 5 wt % relative to the heme. In other embodiments, the concentration is less than about 4 wt %, about 3 wt %, about 2 wt %, about 1 wt %, about 0.8 wt %, about 0.6 wt %, about 0.5 wt %, about 0.4 wt %, about 0.3 wt %, about 0.2 wt %, about 0.1 wt %.

In some embodiments, the catalyst is characterised by a presence of Uroporphyrin. This impurity may be present at less than about 5 wt % relative to the heme. In other embodiments, the concentration is less than about 4 wt %, about 3 wt %, about 2 wt %, about 1 wt %, about 0.8 wt %, about 0.6 wt %, about 0.5 wt %, about 0.4 wt %, about 0.3 wt %, about 0.2 wt %, about 0.1 wt %.

In some embodiments, the catalyst is characterised by a presence of pentacarboxylic porphyrin. This impurity may be present at less than about 5 wt % relative to the heme. In other embodiments, the concentration is less than about 4 wt %, about 3 wt %, about 2 wt %, about 1 wt %, about 0.8 wt %, about 0.6 wt %, about 0.5 wt %, about 0.4 wt %, about 0.3 wt %, about 0.2 wt %, about 0.1 wt %.

In some embodiments, the catalyst is characterised by a presence of one or more impurities. This impurity may be present at less than about 5 wt % relative to the heme. In other embodiments, the concentration is less than about 4 wt %, about 3 wt %, about 2 wt %, about 1 wt %, about 0.8 wt %, about 0.6 wt %, about 0.5 wt %, about 0.4 wt %, about 0.3 wt %, about 0.2 wt %, about 0.1 wt %.

Iron chlorophyllin is a water soluble derivative of chlorophyll that has iron as part of its molecular structure. The iron chlorophyllin may be sodium iron chlorophyllin or iron chlorophyllin acid.

Sodium iron chlorophyllin (SIC) is a stable water soluble pigment made by replacement of magnesium in the porphyrin ring by iron and by hydrolysis with alkali. SIC includes the following forms, namely trisodium iron (III) chlorophyllin a, trisodium iron (III) chlorophyllin b, trisodium iron (II) chlorophyllin a, trisodium iron (II) chlorophyllin b, disodium iron (III) chlorophyllin a, disodium iron (III) chlorophyllin b, disodium iron (II) chlorophyllin a, disodium iron (II) chlorophyllin b, monosodium iron (III) chlorophyllin a, monosodium iron (III) chlorophyllin b, monosodium iron (II) chlorophyllin a, monosodium iron (II) chlorophyllin b.

Iron chlorophyllin acid may be iron (III) chlorophyllin a acid, iron (III) chlorophyllin b acid, iron (II) chlorophyllin a acid, iron (II) chlorophyllin b acid, iron (III) pheophytin a, iron (III) pheophytin b, iron (II) pheophytin a and iron (II) pheophytin b.

In some embodiments, the iron chlorophyllin is derived from a vegetable or vegan product. The iron chlorophyllin may be derived from green vegetables that are natural and not genetically modified. Green vegetables may often be discarded as excess food waste at multiple stages of the supply chain, and being able to use this excess food waste solves environmental issues and provides a cheap source of iron chlorophyllin precursors. The extraction of chlorophyll from the vegetable or vegan product as an iron chlorophyllin precursor and the synthesis of iron chlorophyllin is disclosed in the Singapore patent 10202400548U, which is herein incorporated by reference.

The iron chlorophyllin may be derived from organisms under the Kingdom Plantae, such as xiao bai cai (Brassica rapa), kang kong (Ipomoea aquatica), spinach (Spinacia oleracea L.), spring onion (Allium fistulosum), kai lan (Brassica oleracea Alboglabra Group), chye sim (Brassica rapa Caisin Group), and various types of cabbages. Other sources may be green algae and chlorophyll-containing bacteria under the Kingdom Protista and Monera.

In some embodiments, the iron chlorophyllin is capable of interacting with a flavour precursor in order to generate a flavour and/or odour/aroma.

In some embodiments, the iron chlorophyllin is capable of hydrolysing protein.

The catalyst may result in a colouration of food when the lipid composition is added to the food. For example, heme may result in a reddish to brownish colouration of the food, while iron chlorophyllin may result in a greenish to greenish-brown colouration of the food. The catalyst may be at about 0.05% w/w to about 2% w/w relative to the lipid composition. At this % w/w range, the colouration of the food due to the catalyst may be subtle and not obvious. A food colourant may be added to offset the colouration from the catalyst. The food colourant may help to mask or blend in any subtle colouring from the catalyst. The food colourant may be carotenoids which may provide an orange colouration, anthocyanins which may provide a reddish-purple, reddish-pink, or purple colouration, turmeric which may provide a yellowish-orange colouration, or synthetic food dyes.

In some embodiments, the catalyst is at about 0.05% w/w to about 2% w/w relative to the lipid composition. In other embodiments, the % w/w is about 0.05% w/w to about 1.5% w/w, about 0.05% w/w to about 1% w/w, about 1% w/w to about 2% w/w, or about 1% w/w to about 1.5% w/w.

Accordingly, in some embodiments, the lipid composition comprises:
a) monounsaturated fatty acids at about 10% w/w to about 50% w/w relative to the lipid composition;
b) polyunsaturated fatty acids at about 5% w/w to about 40% w/w relative to the lipid composition;
c) glycerides at about 30% w/w to about 70% w/w relative to the lipid composition; and
d) a catalyst for breaking down the fatty acids and glycerides into volatiles in the presence of heat, the catalyst at about 0.05% w/w to about 2% w/w relative to the lipid composition.

In some embodiments, the lipid composition comprises:
a) monounsaturated fatty acids at about 20% w/w to about 40% w/w relative to the lipid composition;
b) polyunsaturated fatty acids at about 20% w/w to about 30% w/w relative to the lipid composition;
c) glycerides at about 40% w/w to about 60% w/w relative to the lipid composition; and
d) a catalyst for breaking down the fatty acids and glycerides into volatiles in the presence of heat, the catalyst at about 0.05% w/w to about 2% w/w relative to the lipid composition.

In some embodiments, the lipid composition comprises:
a) monounsaturated fatty acids at about 20% w/w to about 40% w/w relative to the lipid composition;
b) polyunsaturated fatty acids at about 5% w/w to about 40% w/w relative to the lipid composition;
c) triglycerides at about 40% w/w to about 60% w/w relative to the lipid composition; and
d) a catalyst for breaking down the fatty acids and triglycerides into volatiles in the presence of heat, the catalyst at about 0.05% w/w to about 2% w/w relative to the lipid composition.

In some embodiments, the lipid composition comprises:
a) monounsaturated fatty acids at about 20% w/w to about 40% w/w relative to the lipid composition;
b) polyunsaturated fatty acids at about 20% w/w to about 30% w/w relative to the lipid composition;
c) triglycerides at about 40% w/w to about 60% w/w relative to the lipid composition; and
d) a catalyst for breaking down the fatty acids and triglycerides into volatiles in the presence of heat, the catalyst at about 0.05% w/w to about 2% w/w relative to the lipid composition.

In some embodiments, the monounsaturated fatty acids comprise C₅-C₃₀ monounsaturated fatty acids. In some embodiments, the monounsaturated fatty acids comprise from C₅-C₂₅ monounsaturated fatty acids, C₅-C₂₀ monounsaturated fatty acids, C₁₀-C₃₀ monounsaturated fatty acids, C₁₀-C₂₅ monounsaturated fatty acids, C₁₀-C₂₀ monounsaturated fatty acids, C₂₀-C₃₀ monounsaturated fatty acids, or a combination thereof. In some embodiments, the monounsaturated fatty acids comprise C₆-C₂₄ monounsaturated fatty acids. In some embodiments, the monounsaturated fatty acids comprise C₆-C₂₀ monounsaturated fatty acids. In some embodiments, the monounsaturated fatty acids comprise C₁₂-C₂₄ monounsaturated fatty acids. In some embodiments, the monounsaturated fatty acids comprise C₁₀-C₂₄ monounsaturated fatty acids.

In some embodiments, the monounsaturated fatty acids comprise C₁₀ monounsaturated fatty acids, C₁₂ monounsaturated fatty acids, C₁₄ monounsaturated fatty acids, C₁₆ monounsaturated fatty acids, C₁₈ monounsaturated fatty acids, C₂₀ monounsaturated fatty acids, C₂₂ monounsaturated fatty acids, or a combination thereof.

In some embodiments, the monounsaturated fatty acids comprise a first C₁₀-C₂₄ monounsaturated fatty acid and a second C₁₀-C₂₄ monounsaturated fatty acid, wherein a concentration of the first monounsaturated fatty acid is about 0.5 times to about 5 times more than the second monounsaturated fatty acid. In other embodiments, the concentration of the first monounsaturated fatty acid is about 0.5 times to about 4 times, 0.5 times to about 3 times, 0.5 times to about 2 times, about 0.5 times to about 1.5 times, about 0.5 times to about 1 time, about 1 time to about 5 times, about 1 time to about 4 times, about 1 time to about 3 times, about 1 time to about 2 times, about 1 time to about 1.5 times, about 1.5 times to about 5 times, about 1.5 times to about 4 times, about 1.5 times to about 3 times, about 1.5 times to about 2 times, about 2 times to about 5 times, about 2 times to about 4 times, about 2 times to about 3 times, about 3 times to about 4 times, or about 3 times to about 5 times more than the second monounsaturated fatty acid. In some embodiments, the concentration of the first monounsaturated fatty acid is about 0.5 times to about 1.5 times more than the second monounsaturated fatty acid. In some embodiments, the concentration of the first monounsaturated fatty acid is about 0.5 times more than the second monounsaturated fatty acid. In some embodiments, the concentration of the first monounsaturated fatty acid is about 1.5 times more than the second monounsaturated fatty acid.

In some embodiments, the monounsaturated fatty acids comprise a first C₁₀-C₂₄ monounsaturated fatty acid and a third C₁₀-C₂₄ monounsaturated fatty acid, wherein a concentration of the first monounsaturated fatty acid is about 0.5 times to about 40 times more than the third monounsaturated fatty acid. In other embodiments, the concentration of the first monounsaturated fatty acid is about 0.5 times to about 30 times, about 0.5 times to about 20 times, about 0.5 times to about 10 times, about 0.5 times to about 5 times, about times to about 40 times, about 5 times to about 30 times, about 5 times to about 20 times, about 5 times to about 10 times, about 10 times to about 50 times, about 10 times to about times, about 10 times to about 30 times, about 10 times to about 20 times, about 20 times to about 50 times, about 20 times to about 40 times, about 20 times to about 30 times, about 30 times to about 50 times, about 30 times to about 40 times, or about 40 times to about 50 times more concentrated than the third monounsaturated fatty acid. In some embodiments, the concentration of the first monounsaturated fatty acid is about 1 time to about 24 times more than the third monounsaturated fatty acid. In some embodiments, the concentration of the first monounsaturated fatty acid is about 1 time more concentrated than the third monounsaturated fatty acid. In some embodiments, the concentration of the first monounsaturated fatty acid is about 24 times more than the third monounsaturated fatty acid.

In some embodiments, the monounsaturated fatty acids comprise a second C₁₀-C₂₄ monounsaturated fatty acid and a third C₁₀-C₂₄ monounsaturated fatty acid, wherein a concentration of the second monounsaturated fatty acid is about 0.1 times to about 20 times more than the third monounsaturated fatty acid. In other embodiments, the concentration of the second monounsaturated fatty acid is about 0.1 times to about 15 times, about 0.1 times to about 10 times, about 0.1 times to about 5 times, about 0.1 times to about 1 time, about 0.1 times to about 0.5 times, about 0.5 times to about 20 times, about 0.5 times to about 15 times, about 0.5 times to about 10 times, about 0.5 times to about 5 times, about 0.5 times to about 1 time, about 1 time to about 20 times, about 1 time to about 15 times, about 1 time to 10 times, about 1 time to 5 times, about 5 times to about 15 times, about 5 times to about 10 times, about 10 times to about 20 times, about 10 times to about 15 times, or about times to about 20 times more than the third monounsaturated fatty acid. In some embodiments, the concentration of the second monounsaturated fatty acid is about 0.25 times more than the third monounsaturated fatty acid. In some embodiments, the concentration of the second monounsaturated fatty acid is about 10 times more than a third monounsaturated fatty acid.

In some embodiments, the monounsaturated fatty acids comprise a first C₁₀-C₂₄ monounsaturated fatty acid, a second C₁₀-C₂₄ monounsaturated fatty acid, and a third C₁₀-C₂₄ monounsaturated fatty acid, wherein a concentration of the first monounsaturated fatty acid is about 0.5 times to about 5 times more than the second monounsaturated fatty acid, wherein a concentration of the first monounsaturated fatty acid is about 0.5 times to about times more than the third monounsaturated fatty acid, and wherein a concentration of the second monounsaturated fatty acid is about 0.1 times to about 20 times more than the third monounsaturated fatty acid.

The lipid composition may be used as a pork fat additive or pork meat flavour additive. In some embodiments, the monounsaturated fatty acids comprise a first C₁₀-C₂₄ monounsaturated fatty acid and a second C₁₀-C₂₄ monounsaturated fatty acid, wherein a concentration of the first monounsaturated fatty acid is about 0.5 times to about 5 times more than the second monounsaturated fatty acid. The first monounsaturated fatty acid may be a C₁₈ monounsaturated fatty acid. The second monounsaturated fatty acid may be a C₁₆ monounsaturated fatty acid. In some embodiments, the monounsaturated fatty acids comprise a C₁₈ monounsaturated fatty acid and a C₁₆ monounsaturated fatty acid, wherein a concentration of the C₁₈ monounsaturated fatty acid is about 1 time to about 2 times more than the C₁₆ monounsaturated fatty acid.

In some embodiments, the monounsaturated fatty acids comprise a first C₁₀-C₂₄ monounsaturated fatty acid and a third C₁₀-C₂₄ monounsaturated fatty acid, wherein a concentration of the first monounsaturated fatty acid is about 15 times to about 25 times more than the third C₁₀-C₂₄ monounsaturated fatty acid. The third monounsaturated fatty acid may be a C₁₄ monounsaturated fatty acid. In some embodiments, the monounsaturated fatty acids comprise a C₁₈ monounsaturated fatty acid and a C₁₄ monounsaturated fatty acid, wherein a concentration of the C₁₈ monounsaturated fatty acid is about 20 times to about 25 times more than the C₁₄ monounsaturated fatty acid.

In some embodiments, the monounsaturated fatty acids comprise a second C₁₀-C₂₄ monounsaturated fatty acid and a third C₁₀-C₂₄ monounsaturated fatty acid, wherein a concentration of the second monounsaturated fatty acid is about 5 times to about 15 times more than the third C₁₀-C₂₄ monounsaturated fatty acid. In some embodiments, the monounsaturated fatty acids comprise a C₁₆ monounsaturated fatty acid and a C₁₄ monounsaturated fatty acid, wherein a concentration of the C₁₆ monounsaturated fatty acid is about 8 times to about 12 times more than the C₁₄ monounsaturated fatty acid.

In some embodiments, the monounsaturated fatty acids comprise a first C₁₀-C₂₄ monounsaturated fatty acid, a second C₁₀-C₂₄ monounsaturated fatty acid, and a third C₁₀-C₂₄ monounsaturated fatty acid, wherein a concentration of the first monounsaturated fatty acid is about 0.5 times to about 5 times more than the second monounsaturated fatty acid, wherein a concentration of the first monounsaturated fatty acid is about 15 times to about 25 times more than the third monounsaturated fatty acid, and wherein a concentration of the second monounsaturated fatty acid is about 5 times to about 15 times more than the third monounsaturated fatty acid. In some embodiments, the monounsaturated fatty acids comprise a C₁₈ monounsaturated fatty acid, a C₁₆ monounsaturated fatty acid, and a C₁₄ monounsaturated fatty acid, wherein a concentration of the C₁₈ monounsaturated fatty acid is about 1 time to about 2 times more than the C₁₆ monounsaturated fatty acid, wherein a concentration of the C₁₈ monounsaturated fatty acid is about 20 times to about 25 times more than the C₁₄ monounsaturated fatty acid, and wherein a concentration of the C₁₆ monounsaturated fatty acid is about 8 times to about 12 times more than the C₁₄ monounsaturated fatty acid.

The lipid composition may be used as a fish fat additive or fish meat flavour additive. In some embodiments, the monounsaturated fatty acids comprise a first C₁₀-C₂₄ monounsaturated fatty acid and a second C₁₀-C₂₄ monounsaturated fatty acid, wherein a concentration of the first monounsaturated fatty acid is about 0.5 times to about 2 times more than the second monounsaturated fatty acid. The first monounsaturated fatty acid may be a C₁₆ monounsaturated fatty acid. The second monounsaturated fatty acid may be a C₁₈ monounsaturated fatty acid. In some embodiments, the monounsaturated fatty acids comprise a C₁₆ monounsaturated fatty acid and a C₁₈ monounsaturated fatty acid, wherein a concentration of the C₁₆ monounsaturated fatty acid is about 0.5 times to about 1 time more than the C₁₈ monounsaturated fatty acid.

In some embodiments, the monounsaturated fatty acids comprise a first C₁₀-C₂₄ monounsaturated fatty acid and a third C₁₀-C₂₄ monounsaturated fatty acid, wherein a concentration of the first monounsaturated fatty acid is about 0.5 times to about 10 times more than the third C₁₀-C₂₄ monounsaturated fatty acid. The third monounsaturated fatty acid may be a C₂₀ monounsaturated fatty acid. In some embodiments, the monounsaturated fatty acids comprise a C₁₆ monounsaturated fatty acid and a C₂₀ monounsaturated fatty acid, wherein a concentration of the C₁₆ monounsaturated fatty acid is about 0.5 times to about 2 times more than the C₂₀ monounsaturated fatty acid.

In some embodiments, the monounsaturated fatty acids comprise a second C₁₀-C₂₄ monounsaturated fatty acid and a third C₁₀-C₂₄ monounsaturated fatty acid, wherein a concentration of the second monounsaturated fatty acid is about 0.1 times to about 2 times more than the third C₁₀-C₂₄ monounsaturated fatty acid. In some embodiments, the monounsaturated fatty acids comprise a C₁₈ monounsaturated fatty acid and a C₂₀ monounsaturated fatty acid, wherein a concentration of the C₁₈ monounsaturated fatty acid is about 0.1 times to about 0.5 times more than the C₂₀ monounsaturated fatty acid.

In some embodiments, the monounsaturated fatty acids comprise a first C₁₀-C₂₄ monounsaturated fatty acid, a second C₁₀-C₂₄ monounsaturated fatty acid, and a third C₁₀-C₂₄ monounsaturated fatty acid, wherein a concentration of the first monounsaturated fatty acid is about 0.5 times to about 2 times more than the second monounsaturated fatty acid, wherein a concentration of the first monounsaturated fatty acid is about 0.5 times to about times more than the third monounsaturated fatty acid, and wherein a concentration of the second monounsaturated fatty acid is about 0.1 times to about 2 times more than the third monounsaturated fatty acid. In some embodiments, the monounsaturated fatty acids comprise a C₁₆ monounsaturated fatty acid, a C₁₈ monounsaturated fatty acid, and a C₂₀ monounsaturated fatty acid, wherein a concentration of the C₁₈ monounsaturated fatty acid is about 1 time to about 2 times more than the C₁₆ monounsaturated fatty acid, wherein a concentration of the C₁₈ monounsaturated fatty acid is about 20 times to about 25 times more than the C₁₄ monounsaturated fatty acid, and wherein a concentration of the C₁₆ monounsaturated fatty acid is about 8 times to about 12 times more than the C₁₄ monounsaturated fatty acid.

The lipid composition may be used as a beef fat additive or beef meat flavour additive. In some embodiments, the monounsaturated fatty acids comprise a first C₁₀-C₂₄ monounsaturated fatty acid and a second C₁₀-C₂₄ monounsaturated fatty acid, wherein a concentration of the first monounsaturated fatty acid is about 0.5 times to about 5 times more than the second monounsaturated fatty acid. The first monounsaturated fatty acid may be a C₁₈ monounsaturated fatty acid. The second monounsaturated fatty acid may be a C₁₆ monounsaturated fatty acid. In some embodiments, the monounsaturated fatty acids comprise a C₁₈ monounsaturated fatty acid and a C₁₆ monounsaturated fatty acid, wherein a concentration of the C₁₈ monounsaturated fatty acid is about 1.5 times to about 3 times more than the C₁₆ monounsaturated fatty acid.

In some embodiments, the monounsaturated fatty acids comprise a first C₁₀-C₂₄ monounsaturated fatty acid and a third C₁₀-C₂₄ monounsaturated fatty acid, wherein a concentration of the first monounsaturated fatty acid is about 10 times to about 40 times more than the third C₁₀-C₂₄ monounsaturated fatty acid. The third monounsaturated fatty acid may be a C₁₄ monounsaturated fatty acid. In some embodiments, the monounsaturated fatty acids comprise a C₁₈ monounsaturated fatty acid and a C₁₄ monounsaturated fatty acid, wherein a concentration of the C₁₈ monounsaturated fatty acid is about 15 times to about 35 times more than the C₁₄ monounsaturated fatty acid.

In some embodiments, the monounsaturated fatty acids comprise a second C₁₀-C₂₄ monounsaturated fatty acid and a third C₁₀-C₂₄ monounsaturated fatty acid, wherein a concentration of the second monounsaturated fatty acid is about 1 time to about 20 times more than the third C₁₀-C₂₄ monounsaturated fatty acid. In some embodiments, the monounsaturated fatty acids comprise a C₁₆ monounsaturated fatty acid and a C₁₄ monounsaturated fatty acid, wherein a concentration of the C₁₆ monounsaturated fatty acid is about 3 times to about 15 times more than the C₁₄ monounsaturated fatty acid.

In some embodiments, the monounsaturated fatty acids comprise a first C₁₀-C₂₄ monounsaturated fatty acid, a second C₁₀-C₂₄ monounsaturated fatty acid, and a third C₁₀-C₂₄ monounsaturated fatty acid, wherein a concentration of the first monounsaturated fatty acid is about 0.5 times to about 5 times more than the second monounsaturated fatty acid, wherein a concentration of the first monounsaturated fatty acid is about 10 times to about 40 times more than the third monounsaturated fatty acid, and wherein a concentration of the second monounsaturated fatty acid is about 1 time to about 20 times more than the third monounsaturated fatty acid. In some embodiments, the monounsaturated fatty acids comprise a C₁₈ monounsaturated fatty acid, a C₁₆ monounsaturated fatty acid, and a C₁₄ monounsaturated fatty acid, wherein a concentration of the of the C₁₈ monounsaturated fatty acid is about 1.5 times to about 3 times more than the C₁₆ monounsaturated fatty acid, wherein a concentration of the C₁₈ monounsaturated fatty acid is about 15 times to about 35 times more than the C₁₄ monounsaturated fatty acid, and wherein a concentration of the C₁₆ monounsaturated fatty acid is about 3 times to about 15 times more than the C₁₄ monounsaturated fatty acid.

The lipid composition may be used as a mutton fat additive or mutton meat flavour additive. In some embodiments, the monounsaturated fatty acids comprise a first C₁₀-C₂₄ monounsaturated fatty acid and a second C₁₀-C₂₄ monounsaturated fatty acid, wherein a concentration of the first monounsaturated fatty acid is about 0.5 times to about 5 times more than the second monounsaturated fatty acid. The first monounsaturated fatty acid may be a C₁₈ monounsaturated fatty acid. The second monounsaturated fatty acid may be a C₁₆ monounsaturated fatty acid. In some embodiments, the monounsaturated fatty acids comprise a C₁₈ monounsaturated fatty acid and a C₁₆ monounsaturated fatty acid, wherein a concentration of the C₁₈ monounsaturated fatty acid is about 1 time to about 2.5 times more than the C₁₆ monounsaturated fatty acid.

In some embodiments, the monounsaturated fatty acids comprise a first C₁₀-C₂₄ monounsaturated fatty acid and a third C₁₀-C₂₄ monounsaturated fatty acid, wherein a concentration of the first monounsaturated fatty acid is about 10 times to about 40 times more than the third C₁₀-C₂₄ monounsaturated fatty acid. The third monounsaturated fatty acid may be a C₂₀ monounsaturated fatty acid. In some embodiments, the monounsaturated fatty acids comprise a C₁₈ monounsaturated fatty acid and a C₂₀ monounsaturated fatty acid, wherein a concentration of the C₁₈ monounsaturated fatty acid is about 12 times to about 35 times more than the C₂₀ monounsaturated fatty acid.

In some embodiments, the monounsaturated fatty acids comprise a second C₁₀-C₂₄ monounsaturated fatty acid and a third C₁₀-C₂₄ monounsaturated fatty acid, wherein a concentration of the second monounsaturated fatty acid is about 10 times to about 20 times more than the third C₁₀-C₂₄ monounsaturated fatty acid. In some embodiments, the monounsaturated fatty acids comprise a C₁₆ monounsaturated fatty acid and a C₂₀ monounsaturated fatty acid, wherein a concentration of the C₁₆ monounsaturated fatty acid is about 3 times to about 15 times more than the C₂₀ monounsaturated fatty acid.

In some embodiments, the monounsaturated fatty acids comprise a first C₁₀-C₂₄ monounsaturated fatty acid, a second C₁₀-C₂₄ monounsaturated fatty acid, and a third C₁₀-C₂₄ monounsaturated fatty acid, wherein a concentration of the first monounsaturated fatty acid is about 0.5 times to about 5 times more than the second monounsaturated fatty acid, wherein a concentration of the first monounsaturated fatty acid is about 10 times to about 40 times more than the third monounsaturated fatty acid, and wherein a concentration of the second monounsaturated fatty acid is about 1 time to about 20 times more than the third monounsaturated fatty acid. In some embodiments, the monounsaturated fatty acids comprise a C₁₈ monounsaturated fatty acid, a C₁₆ monounsaturated fatty acid, and a C₂₀ monounsaturated fatty acid, wherein a concentration of the C₁₈ monounsaturated fatty acid is about 1 time to about 2.5 times more than the C₁₆ monounsaturated fatty acid, wherein a concentration of the C₁₈ monounsaturated fatty acid is about 12 times to about 35 times more than the C₂₀ monounsaturated fatty acid, and wherein a concentration of the C₁₆ monounsaturated fatty acid is about 3 times to about 15 times more than the C₂₀ monounsaturated fatty acid.

In some embodiments, the monounsaturated fatty acids comprise at least three monounsaturated fatty acids, wherein each monounsaturated fatty acid independently comprises C₁₀-C₂₄ alkyl. In some embodiments, the monounsaturated fatty acids comprise at least four, at least five, or at least six monounsaturated fatty acids, wherein each monounsaturated fatty acid independently comprises C₁₀-C₂₄ alkyl.

In some embodiments, the monounsaturated fatty acids comprise at least three monounsaturated fatty acids, wherein each monounsaturated fatty acid independently comprises even-numbered C₁₀-C₂₄ alkyl. In some embodiments, each monounsaturated fatty acid independently comprises C₁₀ alkyl, C₁₂ alkyl, C₁₄ alkyl, C₁₆ alkyl, C₁₈ alkyl, C₂₀ alkyl, C₂₂ alkyl, or C₂₄ alkyl.

In some embodiments, the polyunsaturated fatty acids comprise C₅-C₃₀ polyunsaturated fatty acids. In some embodiments, the polyunsaturated fatty acids comprise from C₅-C₂₅ polyunsaturated fatty acids, C₅-C₂₀ polyunsaturated fatty acids, C₁₀-C₃₀ polyunsaturated fatty acids, C₁₀-C₂₅ polyunsaturated fatty acids, C₁₀-C₂₀ polyunsaturated fatty acids, C₂₀-C₃₀ polyunsaturated fatty acids, or a combination thereof. In some embodiments, the polyunsaturated fatty acids comprise C₆-C₂₄ polyunsaturated fatty acids. In some embodiments, the polyunsaturated fatty acids comprise C₆-C₂₀ polyunsaturated fatty acids. In some embodiments, the polyunsaturated fatty acids comprise C₁₂-C₂₄ polyunsaturated fatty acids. In some embodiments, the polyunsaturated fatty acids comprise C₁₀-C₂₄ polyunsaturated fatty acids.

In some embodiments, the polyunsaturated fatty acids comprise C₁₀ polyunsaturated fatty acids, C₁₂ polyunsaturated fatty acids, C₁₄ polyunsaturated fatty acids, C₁₆ polyunsaturated fatty acids, C₁₈ polyunsaturated fatty acids, C₂₀ polyunsaturated fatty acids, C₂₂ polyunsaturated fatty acids, or a combination thereof.

In some embodiments, the polyunsaturated fatty acids comprise a first C₁₀-C₂₄ polyunsaturated fatty acid and a second C₁₀-C₂₄ polyunsaturated fatty acid, wherein a concentration of the first polyunsaturated fatty acid is about 0.5 times to about 5 times more than the second polyunsaturated fatty acid. In other embodiments, the concentration of the first polyunsaturated fatty acid is about 0.5 times to about 4 times, 0.5 times to about 3 times, 0.5 times to about 2 times, about 0.5 times to about 1.5 times, about 0.5 times to about 1 time, about 1 time to about 5 times, about 1 time to about 4 times, about 1 time to about 3 times, about 1 time to about 2 times, about 1 time to about 1.5 times, about 1.5 times to about 5 times, about 1.5 times to about 4 times, about 1.5 times to about 3 times, about 1.5 times to about 2 times, about 2 times to about 5 times, about 2 times to about 4 times, about 2 times to about 3 times, about 3 times to about 4 times, or about 3 times to about 5 times more than the second polyunsaturated fatty acid. In some embodiments, the concentration of the first polyunsaturated fatty acid is about 0.5 times to about 1.5 times more than the second polyunsaturated fatty acid. In some embodiments, the concentration of the first polyunsaturated fatty acid is about 0.5 times more than the second polyunsaturated fatty acid. In some embodiments, the concentration of the first polyunsaturated fatty acid is about 1.5 times more than the second polyunsaturated fatty acid.

In some embodiments, the polyunsaturated fatty acids comprise a first C₁₀-C₂₄ polyunsaturated fatty acid and a third C₁₀-C₂₄ polyunsaturated fatty acid, wherein a concentration of the first polyunsaturated fatty acid is about 0.5 times to about 40 times more than the third polyunsaturated fatty acid. In other embodiments, the concentration of the first polyunsaturated fatty acid is about 0.5 times to about 30 times, about 0.5 times to about 20 times, about 0.5 times to about 10 times, about 0.5 times to about 5 times, about 5 times to about 40 times, about 5 times to about 30 times, about 5 times to about 20 times, about 5 times to about 10 times, about 10 times to about 50 times, about 10 times to about 40 times, about 10 times to about 30 times, about 10 times to about 20 times, about 20 times to about 50 times, about 20 times to about 40 times, about 20 times to about 30 times, about 30 times to about 50 times, about 30 times to about 40 times, or about 40 times to about 50 times more concentrated than the third polyunsaturated fatty acid. In some embodiments, the concentration of the first polyunsaturated fatty acid is about 1 time to about 24 times more than the third polyunsaturated fatty acid. In some embodiments, the concentration of the first polyunsaturated fatty acid is about 1 time more concentrated than the third polyunsaturated fatty acid. In some embodiments, the concentration of the first polyunsaturated fatty acid is about 24 times more than the third polyunsaturated fatty acid.

In some embodiments, the polyunsaturated fatty acids comprise a second C₁₀-C₂₄ polyunsaturated fatty acid and a third C₁₀-C₂₄ polyunsaturated fatty acid, wherein a concentration of the second polyunsaturated fatty acid is about 0.1 times to about 20 times more than the third polyunsaturated fatty acid. In other embodiments, the concentration of the second polyunsaturated fatty acid is about 0.1 times to about 15 times, about 0.1 times to about 10 times, about 0.1 times to about 5 times, about 0.1 times to about 1 time, about 0.1 times to about 0.5 times, about 0.5 times to about 20 times, about 0.5 times to about 15 times, about 0.5 times to about 10 times, about 0.5 times to about 5 times, about 0.5 times to about 1 time, about 1 time to about 20 times, about 1 time to about 15 times, about 1 time to 10 times, about 1 time to 5 times, about 5 times to about 15 times, about 5 times to about 10 times, about 10 times to about 20 times, about 10 times to about 15 times, or about times to about 20 times more than the third polyunsaturated fatty acid. In some embodiments, the concentration of the second polyunsaturated fatty acid is about 0.25 times more than the third polyunsaturated fatty acid. In some embodiments, the concentration of the second polyunsaturated fatty acid is about 10 times more than a third polyunsaturated fatty acid.

In some embodiments, the polyunsaturated fatty acids comprise a first C₁₀-C₂₄ polyunsaturated fatty acid, a second C₁₀-C₂₄ polyunsaturated fatty acid, and a third C₁₀-C₂₄ polyunsaturated fatty acid, wherein a concentration of the first polyunsaturated fatty acid is about 0.5 times to about 5 times more than the second polyunsaturated fatty acid, wherein a concentration of the first polyunsaturated fatty acid is about 0.5 times to about 40 times more than a third polyunsaturated fatty acid, and wherein a concentration of the second polyunsaturated fatty acid is about 0.1 times to about 20 times more than the third polyunsaturated fatty acid.

The lipid composition may be used as a pork fat additive or pork meat flavour additive. In some embodiments, the polyunsaturated fatty acids comprise a first C₁₀-C₂₄ polyunsaturated fatty acid and a second C₁₀-C₂₄ polyunsaturated fatty acid, wherein a concentration of the first polyunsaturated fatty acid is about 0.5 times to about 5 times more than the second polyunsaturated fatty acid. The first polyunsaturated fatty acid may be a C₁₈ polyunsaturated fatty acid. The second polyunsaturated fatty acid may be a C₁₆ polyunsaturated fatty acid. In some embodiments, the polyunsaturated fatty acids comprise a C₁₈ polyunsaturated fatty acid and a C₁₆ polyunsaturated fatty acid, wherein a concentration of the C₁₈ polyunsaturated fatty acid is about 1 time to about 2 times more than the C₁₆ polyunsaturated fatty acid.

In some embodiments, the polyunsaturated fatty acids comprise a first C₁₀-C₂₄ polyunsaturated fatty acid and a third C₁₀-C₂₄ polyunsaturated fatty acid, wherein a concentration of the first polyunsaturated fatty acid is about 15 times to about 25 times more than the third C₁₀-C₂₄ polyunsaturated fatty acid. The third polyunsaturated fatty acid may be a C₁₄ polyunsaturated fatty acid. In some embodiments, the polyunsaturated fatty acids comprise a C₁₈ polyunsaturated fatty acid and a C₁₄ polyunsaturated fatty acid, wherein a concentration of the C₁₈ polyunsaturated fatty acid is about 20 times to about 25 times more than the C₁₄ polyunsaturated fatty acid.

In some embodiments, the polyunsaturated fatty acids comprise a second C₁₀-C₂₄ polyunsaturated fatty acid and a third C₁₀-C₂₄ polyunsaturated fatty acid, wherein a concentration of the second polyunsaturated fatty acid is about 5 times to about 15 times more than the third C₁₀-C₂₄ polyunsaturated fatty acid. In some embodiments, the polyunsaturated fatty acids comprise a C₁₆ polyunsaturated fatty acid and a C₁₄ polyunsaturated fatty acid, wherein a concentration of the C₁₆ polyunsaturated fatty acid is about 8 times to about 12 times more than the C₁₄ polyunsaturated fatty acid.

In some embodiments, the polyunsaturated fatty acids comprise a first C₁₀-C₂₄ polyunsaturated fatty acid, a second C₁₀-C₂₄ polyunsaturated fatty acid, and a third C₁₀-C₂₄ polyunsaturated fatty acid, wherein a concentration of the first polyunsaturated fatty acid is about 0.5 times to about 5 times more than the second polyunsaturated fatty acid, wherein a concentration of the first polyunsaturated fatty acid is about 15 times to about 25 times more than the third polyunsaturated fatty acid, and wherein a concentration of the second polyunsaturated fatty acid is about 5 times to about 15 times more than the third polyunsaturated fatty acid. In some embodiments, the polyunsaturated fatty acids comprise a C₁₈ monounsaturated fatty acid, a C₁₆ polyunsaturated fatty acid, and a C₁₄ polyunsaturated fatty acid, wherein a concentration of the of the C₁₈ polyunsaturated fatty acid is about 1 time to about 2 times more than the C₁₆ polyunsaturated fatty acid, wherein a concentration of the C₁₈ polyunsaturated fatty acid is about 20 times to about 25 times more than the C₁₄ polyunsaturated fatty acid, and wherein a concentration of the C₁₆ polyunsaturated fatty acid is about 8 times to about 12 times more than the C₁₄ polyunsaturated fatty acid.

The lipid composition may be used as a fish fat additive or fish meat flavour additive. In some embodiments, the polyunsaturated fatty acids comprise a first C₁₀-C₂₄ polyunsaturated fatty acid and a second C₁₀-C₂₄ polyunsaturated fatty acid, wherein a concentration of the first polyunsaturated fatty acid is about 0.5 times to about 2 times more than the second polyunsaturated fatty acid. The first polyunsaturated fatty acid may be a C₁₆ polyunsaturated fatty acid. The second polyunsaturated fatty acid may be a C₁₈ polyunsaturated fatty acid. In some embodiments, the polyunsaturated fatty acids comprise a C₁₆ polyunsaturated fatty acid and a C₁₈ polyunsaturated fatty acid, wherein a concentration of C₁₈ polyunsaturated fatty acid is about 0.5 times to about 1 time more than the C₁₈ polyunsaturated fatty acid.

In some embodiments, the polyunsaturated fatty acids comprise a first C₁₀-C₂₄ polyunsaturated fatty acid and a third C₁₀-C₂₄ polyunsaturated fatty acid, wherein a concentration of the first polyunsaturated fatty acid is about 0.5 times to about 10 times more than the third C₁₀-C₂₄ polyunsaturated fatty acid. The third polyunsaturated fatty acid may be a C₂₀ polyunsaturated fatty acid. In some embodiments, the polyunsaturated fatty acids comprise a C₁₆ polyunsaturated fatty acid and a C₂₀ polyunsaturated fatty acid, wherein a concentration of the C₁₆ polyunsaturated fatty acid is about 0.5 times to about 2 times more than the C₂₀ polyunsaturated fatty acid.

In some embodiments, the polyunsaturated fatty acids comprise a second C₁₀-C₂₄ polyunsaturated fatty acid and a third C₁₀-C₂₄ polyunsaturated fatty acid, wherein a concentration of the second polyunsaturated fatty acid is about 0.1 times to about 2 times more than the third C₁₀-C₂₄ polyunsaturated fatty acid. In some embodiments, the polyunsaturated fatty acids comprise a C₁₈ polyunsaturated fatty acid and a C₂₀ polyunsaturated fatty acid, wherein a concentration of the C₁₆ polyunsaturated fatty acid is about 0.1 times to about 0.5 times more than the C₂₀ polyunsaturated fatty acid.

In some embodiments, the polyunsaturated fatty acids comprise a first C₁₀-C₂₄ polyunsaturated fatty acid, a second C₁₀-C₂₄ polyunsaturated fatty acid, and a third C₁₀-C₂₄ polyunsaturated fatty acid, wherein a concentration of the first polyunsaturated fatty acid is about 0.5 times to about 2 times more than the second polyunsaturated fatty acid, wherein a concentration of the first polyunsaturated fatty acid is about 0.5 times to about 10 times more than the third polyunsaturated fatty acid, and wherein a concentration of the second polyunsaturated fatty acid is about 0.1 times to about 2 times more than the third polyunsaturated fatty acid. In some embodiments, the polyunsaturated fatty acids comprise a C₁₆ polyunsaturated fatty acid, a C₁₈ polyunsaturated fatty acid, and a C₂₀ polyunsaturated fatty acid, wherein a concentration of the of the C₁₈ polyunsaturated fatty acid is about 1 time to about 2 times more than the C₁₆ polyunsaturated fatty acid, wherein a concentration of the C₁₈ polyunsaturated fatty acid is about 20 times to about 25 times more than the C₁₄ polyunsaturated fatty acid, and wherein a concentration of the C₁₆ polyunsaturated fatty acid is about 8 times to about 12 times more than the C₁₄ polyunsaturated fatty acid.

The lipid composition may be used as a beef fat additive or beef meat flavour additive. In some embodiments, the polyunsaturated fatty acids comprise a first C₁₀-C₂₄ polyunsaturated fatty acid and a second C₁₀-C₂₄ polyunsaturated fatty acid, wherein a concentration of the first polyunsaturated fatty acid is about 0.5 times to about 5 times more than the second polyunsaturated fatty acid. The first polyunsaturated fatty acid may be a C₁₈ polyunsaturated fatty acid. The second polyunsaturated fatty acid may be a C₁₆ polyunsaturated fatty acid. In some embodiments, the polyunsaturated fatty acids comprise a C₁₈ polyunsaturated fatty acid and a C₁₆ polyunsaturated fatty acid, wherein a concentration of the C₁₈ polyunsaturated fatty acid is about 1.5 times to about 3 times more than the C₁₆ polyunsaturated fatty acid.

In some embodiments, the polyunsaturated fatty acids comprise a first C₁₀-C₂₄ polyunsaturated fatty acid and a third C₁₀-C₂₄ polyunsaturated fatty acid, wherein a concentration of the first polyunsaturated fatty acid is about 10 times to about 40 times more than the third C₁₀-C₂₄ polyunsaturated fatty acid. The third polyunsaturated fatty acid may be a C₁₄ polyunsaturated fatty acid. In some embodiments, the polyunsaturated fatty acids comprise a C₁₈ polyunsaturated fatty acid and a C₁₄ polyunsaturated fatty acid, wherein a concentration of the C₁₈ polyunsaturated fatty acid is about 15 times to about 35 times more than the C₁₄ polyunsaturated fatty acid.

In some embodiments, the polyunsaturated fatty acids comprise a second C₁₀-C₂₄ polyunsaturated fatty acid and a third C₁₀-C₂₄ polyunsaturated fatty acid, wherein a concentration of the second polyunsaturated fatty acid is about 1 time to about 20 times more than the third C₁₀-C₂₄ polyunsaturated fatty acid. In some embodiments, the polyunsaturated fatty acids comprise a C₁₆ polyunsaturated fatty acid and a C₁₄ polyunsaturated fatty acid, wherein a concentration of the C₁₆ polyunsaturated fatty acid is about 3 times to about 15 times more than the C₁₄ polyunsaturated fatty acid.

In some embodiments, the polyunsaturated fatty acids comprise a first C₁₀-C₂₄ polyunsaturated fatty acid, a second C₁₀-C₂₄ polyunsaturated fatty acid, and a third C₁₀-C₂₄ polyunsaturated fatty acid, wherein a concentration of the of the first polyunsaturated fatty acid is about 0.5 times to about 5 times more than the second polyunsaturated fatty acid, wherein a concentration of the first polyunsaturated fatty acid is about 10 times to about 40 times more than the third polyunsaturated fatty acid, and wherein a concentration of the second polyunsaturated fatty acid is about 1 time to about 20 times more than the third polyunsaturated fatty acid. In some embodiments, the polyunsaturated fatty acids comprise a C₁₈ polyunsaturated fatty acid, a C₁₆ polyunsaturated fatty acid, and a C₁₄ polyunsaturated fatty acid, wherein a concentration of the of the C₁₈ polyunsaturated fatty acid is about 1.5 times to about 3 times more than the C₁₆ polyunsaturated fatty acid, wherein a concentration of the C₁₈ polyunsaturated fatty acid is about 15 times to about 35 times more than the C₁₄ polyunsaturated fatty acid, and wherein a concentration of the C₁₆ polyunsaturated fatty acid is about 3 times to about 15 times more than the C₁₄ polyunsaturated fatty acid.

The lipid composition may be used as a mutton fat additive or mutton meat flavour additive.

In some embodiments, the polyunsaturated fatty acids comprise a first C₁₀-C₂₄ polyunsaturated fatty acid and a second C₁₀-C₂₄ polyunsaturated fatty acid, wherein a concentration of the first polyunsaturated fatty acid is about 0.5 times to about 5 times more than the second polyunsaturated fatty acid. The first polyunsaturated fatty acid may be a C₁₈ polyunsaturated fatty acid. The second polyunsaturated fatty acid may be a C₁₆ polyunsaturated fatty acid. In some embodiments, the polyunsaturated fatty acids comprise a C₁₈ polyunsaturated fatty acid and a C₁₆ polyunsaturated fatty acid, wherein a concentration of the C₁₈ polyunsaturated fatty acid is about 1 time to about 2.5 times more than the C₁₆ polyunsaturated fatty acid.

In some embodiments, the polyunsaturated fatty acids comprise a first C₁₀-C₂₄ polyunsaturated fatty acid and a third C₁₀-C₂₄ polyunsaturated fatty acid, wherein a concentration of the first polyunsaturated fatty acid is about 10 times to about 40 times more than the third C₁₀-C₂₄ polyunsaturated fatty acid. The third polyunsaturated fatty acid may be a C₂₀ polyunsaturated fatty acid. In some embodiments, the polyunsaturated fatty acids comprise a C₁₈ polyunsaturated fatty acid and a C₂₀ polyunsaturated fatty acid, wherein a concentration of the C₁₈ polyunsaturated fatty acid is about 12 times to about 35 times more than the C₂₀ polyunsaturated fatty acid.

In some embodiments, the polyunsaturated fatty acids comprise a second C₁₀-C₂₄ polyunsaturated fatty acid and a third C₁₀-C₂₄ polyunsaturated fatty acid, wherein a concentration of the second polyunsaturated fatty acid is about 10 times to about 20 times more than the third C₁₀-C₂₄ polyunsaturated fatty acid. In some embodiments, the polyunsaturated fatty acids comprise a C₁₆ polyunsaturated fatty acid and a C₂₀ polyunsaturated fatty acid, wherein a concentration of the C₁₆ polyunsaturated fatty acid is about 3 times to about 15 times more than the C₂₀ polyunsaturated fatty acid.

In some embodiments, the polyunsaturated fatty acids comprise a first C₁₀-C₂₄ polyunsaturated fatty acid, a second C₁₀-C₂₄ polyunsaturated fatty acid, and a third C₁₀-C₂₄ polyunsaturated fatty acid, wherein a concentration of the first polyunsaturated fatty acid is about 0.5 times to about 5 times more than the second polyunsaturated fatty acid, wherein a concentration of the first polyunsaturated fatty acid is about 10 times to about 40 times more than the third polyunsaturated fatty acid, and wherein a concentration of the second polyunsaturated fatty acid is about 1 time to about 20 times more than the third polyunsaturated fatty acid. In some embodiments, the polyunsaturated fatty acids comprise a C₁₈ polyunsaturated fatty acid, a C₁₆ polyunsaturated fatty acid, and a C₂₀ polyunsaturated fatty acid, wherein a concentration of the of the C₁₈ polyunsaturated fatty acid is about 1 time to about 2.5 times more than the C₁₆ polyunsaturated fatty acid, wherein a concentration of the C₁₈ polyunsaturated fatty acid is about 12 times to about 35 times more than the C₂₀ polyunsaturated fatty acid, and wherein a concentration of the C₁₆ polyunsaturated fatty acid is about 3 times to about 15 times more than the C₂₀ polyunsaturated fatty acid.

In some embodiments, the polyunsaturated fatty acids comprise at least three polyunsaturated fatty acids, wherein each polyunsaturated fatty acid independently comprises C₁₀-C₂₄ alkyl. In some embodiments, the polyunsaturated fatty acids comprise at least four, at least five, or at least six polyunsaturated fatty acids, wherein each polyunsaturated fatty acid independently comprises C₁₀-C₂₄ alkyl.

In some embodiments, the polyunsaturated fatty acids comprise at least three polyunsaturated fatty acids, wherein each polyunsaturated fatty acid independently comprises even-numbered C₁₀-C₂₄ alkyl. In some embodiments, each polyunsaturated fatty acid independently comprises C₁₀ alkyl, C₁₂ alkyl, C₁₄ alkyl, C₁₆ alkyl, C₁₈ alkyl, C₂₀ alkyl, C₂₂ alkyl, or C₂₄ alkyl.

In some embodiments, the lipid composition comprises C₅-C₃₀ monounsaturated fatty acids and C₅-C₃₀ polyunsaturated fatty acids. In some embodiments, the lipid composition comprises C₆-C₂₀ monounsaturated fatty acids and C₆-C₂₀ polyunsaturated fatty acids. In some embodiments, the lipid composition comprises C₁₂-C₂₄ monounsaturated fatty acids and C₁₂-C₂₄ polyunsaturated fatty acids. In some embodiments, the lipid composition comprises C₁₂-C₂₄ monounsaturated fatty acids and C₁₀-C₂₄ polyunsaturated fatty acids. The monounsaturated fatty acids may comprise C₁₀ monounsaturated fatty acids, C₁₂ monounsaturated fatty acids, C₁₄ monounsaturated fatty acids, C₁₆ monounsaturated fatty acids, C₁₈ monounsaturated fatty acids, C₂₀ monounsaturated fatty acids, C₂₂ monounsaturated fatty acids, or a combination thereof. The polyunsaturated fatty acids may comprise C₁₀ polyunsaturated fatty acids, C₁₂ polyunsaturated fatty acids, C₁₄ polyunsaturated fatty acids, C₁₆ polyunsaturated fatty acids, C₁₈ polyunsaturated fatty acids, C₂₀ polyunsaturated fatty acids, C₂₂ polyunsaturated fatty acids, or a combination thereof.

In some embodiments, the lipid composition comprises:
a) a first C₁₀-C₂₄ monounsaturated fatty acid and a second C₁₀-C₂₄ monounsaturated fatty acid, wherein a concentration of the first monounsaturated fatty acid is about 0.5 times to about 5 times more than the second monounsaturated fatty acid; and
b) a first C₁₀-C₂₄ polyunsaturated fatty acid and a second C₁₀-C₂₄ polyunsaturated fatty acid, wherein a concentration of the first polyunsaturated fatty acid is about 0.5 times to about 5 times more than the second polyunsaturated fatty acid.

In some embodiments, the lipid composition comprises:
a) a first C₁₀-C₂₄ monounsaturated fatty acid and a third C₁₀-C₂₄ monounsaturated fatty acid, wherein a concentration of the first monounsaturated fatty acid is about 0.5 times to about 40 times more than the third monounsaturated fatty acid; and
b) a first C₁₀-C₂₄ polyunsaturated fatty acid and a third C₁₀-C₂₄ polyunsaturated fatty acid, wherein a concentration of the first polyunsaturated fatty acid is about 0.5 times to about 40 times more than the third polyunsaturated fatty acid.

In some embodiments, the lipid composition comprises:
a) a second C₁₀-C₂₄ monounsaturated fatty acid and a third C₁₀-C₂₄ monounsaturated fatty acid, wherein a concentration of the second monounsaturated fatty acid is about 0.1 times to about 20 times more than the third monounsaturated fatty acid; and
b) a second C₁₀-C₂₄ polyunsaturated fatty acid and a third C₁₀-C₂₄ polyunsaturated fatty acid, wherein a concentration of the second polyunsaturated fatty acid is about 0.1 times to about 20 times more than the third polyunsaturated fatty acid.

In some embodiments, the lipid composition comprises:
a) a first C₁₀-C₂₄ monounsaturated fatty acid, a second C₁₀-C₂₄ monounsaturated fatty acid, and a third C₁₀-C₂₄ monounsaturated fatty acid, wherein a concentration of the first monounsaturated fatty acid is about 0.5 times to about 5 times more than the second monounsaturated fatty acid, wherein a concentration of the first monounsaturated fatty acid is about 0.5 times to about 40 times more than the third monounsaturated fatty acid, and wherein a concentration of the second monounsaturated fatty acid is about 0.1 times to about times more than the third monounsaturated fatty acid; and
b) a first C₁₀-C₂₄ polyunsaturated fatty acid, a second C₁₀-C₂₄ polyunsaturated fatty acid, and a third C₁₀-C₂₄ polyunsaturated fatty acid, wherein a concentration of the first polyunsaturated fatty acid is about 0.5 times to about 5 times more than the second polyunsaturated fatty acid, wherein a concentration of the first polyunsaturated fatty acid is about 0.5 times to about 40 times more than the third polyunsaturated fatty acid, and wherein a concentration of the second polyunsaturated fatty acid is about 0.1 times to about 20 times more than the third polyunsaturated fatty acid.

The lipid composition may be used as a pork fat additive or pork meat flavour additive. In some embodiments, the lipid composition comprises:
a) a C₁₈ monounsaturated fatty acid and a C₁₆ monounsaturated fatty acid, wherein a concentration of the C₁₈ monounsaturated fatty acid is about 1 time to about 2 times more than the C₁₆ monounsaturated fatty acid; and
b) a C₁₈ polyunsaturated fatty acid and a C₁₆ polyunsaturated fatty acid, wherein a concentration of the C₁₈ polyunsaturated fatty acid is about 1 time to about 2 times more than the C₁₆ polyunsaturated fatty acid.

In some embodiments, the lipid composition comprises:
a) a C₁₈ monounsaturated fatty acid and a C₁₄ monounsaturated fatty acid, wherein a concentration of the C₁₈ monounsaturated fatty acid is about 20 times to about 25 times more than the C₁₄ monounsaturated fatty acid; and
b) a C₁₈ polyunsaturated fatty acid and a C₁₄ polyunsaturated fatty acid, wherein a concentration of the C₁₈ polyunsaturated fatty acid is about 20 times to about 25 times more than the C₁₄ polyunsaturated fatty acid.

In some embodiments, the lipid composition comprises:
a) a C₁₆ monounsaturated fatty acid and a C₁₄ monounsaturated fatty acid, wherein a concentration of the C₁₆ monounsaturated fatty acid is about 8 times to about 12 times more than the C₁₄ monounsaturated fatty acid; and
b) a C₁₆ polyunsaturated fatty acid and a C₁₄ polyunsaturated fatty acid, wherein a concentration of the C₁₆ polyunsaturated fatty acid is about 8 times to about 12 times more than the C₁₄ polyunsaturated fatty acid.

In some embodiments, the lipid composition comprises:
a) a C₁₈ monounsaturated fatty acid, a C₁₆ monounsaturated fatty acid, and a C₁₄ monounsaturated fatty acid, wherein a concentration of the C₁₈ monounsaturated fatty acid is about 1 time to about 2 times more than the C₁₆ monounsaturated fatty acid, wherein a concentration of the C₁₈ monounsaturated fatty acid is about 20 times to about 25 times more than the C₁₄ monounsaturated fatty acid, and wherein a concentration of the C₁₆ monounsaturated fatty acid is about 8 times to about 12 times more than the C₁₄ monounsaturated fatty acid; and
b) a C₁₈ polyunsaturated fatty acid, a C₁₆ polyunsaturated fatty acid, and a C₁₄ polyunsaturated fatty acid, wherein a concentration of the C₁₈ polyunsaturated fatty acid is about 1 time to about 2 times more than the C₁₆ polyunsaturated fatty acid, wherein a concentration of the C₁₈ polyunsaturated fatty acid is about 20 times to about 25 times more than the C₁₄ polyunsaturated fatty acid, and wherein a concentration of the C₁₆ polyunsaturated fatty acid is about 8 times to about 12 times more than the C₁₄ polyunsaturated fatty acid.

The lipid composition may be used as a fish fat additive or fish meat flavour additive. In some embodiments, the lipid composition comprises:
a) a C₁₆ monounsaturated fatty acid and a C₁₈ monounsaturated fatty acid, wherein a concentration of the C₁₆ monounsaturated fatty acid is about 0.5 times to about 1 time more than the C₁₈ monounsaturated fatty acid; and
b) a C₁₆ polyunsaturated fatty acid and a C₁₈ polyunsaturated fatty acid, wherein a concentration of the C₁₆ polyunsaturated fatty acid is about 0.5 times to about 1 time more than the C₁₈ polyunsaturated fatty acid.

In some embodiments, the lipid composition comprises:
a) a C₁₆ monounsaturated fatty acid and a C₂₀ monounsaturated fatty acid, wherein a concentration of the C₁₆ monounsaturated fatty acid is about 0.5 times to about 2 times more than the C₂₀ monounsaturated fatty acid; and
b) a C₁₆ polyunsaturated fatty acid and a C₂₀ polyunsaturated fatty acid, wherein a concentration of the C₁₆ polyunsaturated fatty acid is 0.5 times to about 2 times more than the C₂₀ polyunsaturated fatty acid.

In some embodiments, the lipid composition comprises:
a) a C₁₈ monounsaturated fatty acid and a C₂₀ monounsaturated fatty acid, wherein a concentration of the C₁₈ monounsaturated fatty acid is about 0.1 times to about 0.5 times more than the C₂₀ monounsaturated fatty acid; and
b) a C₁₈ polyunsaturated fatty acid and a C₂₀ polyunsaturated fatty acid, wherein a concentration of the C₁₈ polyunsaturated fatty acid is about 0.1 times to about 0.5 times more than the C₂₀ polyunsaturated fatty acid.

In some embodiments, the lipid composition comprises:
a) a C₁₆ monounsaturated fatty acid, a C₁₈ monounsaturated fatty acid, and a C₂₀ monounsaturated fatty acid, wherein a concentration of the C₁₆ monounsaturated fatty acid is 0.5 times to about 1 time more than the C₁₈ monounsaturated fatty acid, wherein a concentration of the C₁₆ monounsaturated fatty acid is 0.5 times to about 2 times more than the C₂₀ monounsaturated fatty acid, and wherein a concentration of the C₁₈ monounsaturated fatty acid is about 0.1 times to about 0.5 times more than the C₂₀ monounsaturated fatty acid; and
b) a C₁₆ polyunsaturated fatty acid, a C₁₈ polyunsaturated fatty acid, and a C₂₀ polyunsaturated fatty acid, wherein a concentration of the C₁₆ polyunsaturated fatty acid is 0.5 times to about 1 time more than the C₁₈ polyunsaturated fatty acid, wherein a concentration of the C₁₆ polyunsaturated fatty acid is 0.5 times to about 2 times more than the C₂₀ polyunsaturated fatty acid, and wherein a concentration of the C₁₈ polyunsaturated fatty acid is about 0.1 times to about 0.5 times more than the C₂₀ polyunsaturated fatty acid.

The lipid composition may be used as a beef fat additive or beef meat flavour additive. In some embodiments, the lipid composition comprises:
a) a C₁₈ monounsaturated fatty acid and a C₁₆ monounsaturated fatty acid, wherein a concentration of the C₁₈ monounsaturated fatty acid is about 1.5 times to about 3 times more than the C₁₆ monounsaturated fatty acid; and
b) a C₁₈ polyunsaturated fatty acid and a C₁₆ polyunsaturated fatty acid, wherein a concentration of the C₁₈ polyunsaturated fatty acid is about 1.5 times to about 3 times more than the C₁₆ polyunsaturated fatty acid.

In some embodiments, the lipid composition comprises:
a) a C₁₈ monounsaturated fatty acid and a C₁₄ monounsaturated fatty acid, wherein a concentration of the C₁₈ monounsaturated fatty acid is about 15 times to about 35 times more than the C₁₄ monounsaturated fatty acid; and
b) a C₁₈ polyunsaturated fatty acid and a C₁₄ polyunsaturated fatty acid, wherein a concentration of the C₁₈ polyunsaturated fatty acid is about 15 times to about 35 times more than the C₁₄ polyunsaturated fatty acid.

In some embodiments, the lipid composition comprises:
a) a C₁₆ monounsaturated fatty acid and a C₁₄ monounsaturated fatty acid, wherein a concentration of the C₁₆ monounsaturated fatty acid is about 3 times to about 15 times more than the C₁₄ monounsaturated fatty acid; and
b) a C₁₆ polyunsaturated fatty acid and a C₁₄ polyunsaturated fatty acid, wherein a concentration of the C₁₆ polyunsaturated fatty acid is about 3 times to about 15 times more than the C₁₄ polyunsaturated fatty acid.

In some embodiments, the lipid composition comprises:
a) a C₁₈ monounsaturated fatty acid, a C₁₆ monounsaturated fatty acid, and a C₁₄ monounsaturated fatty acid, wherein a concentration of the C₁₈ monounsaturated fatty acid is about 1.5 times to about 3 times more than the C₁₆ monounsaturated fatty acid, wherein a concentration of the C₁₈ monounsaturated fatty acid is about 15 times to about 35 times more than the C₁₄ monounsaturated fatty acid, and wherein a concentration of the C₁₆ monounsaturated fatty acid is about 3 times to about 15 times more than the C₁₄ monounsaturated fatty acid; and
b) a C₁₈ polyunsaturated fatty acid, a C₁₆ polyunsaturated fatty acid, and a C₁₄ polyunsaturated fatty acid, wherein a concentration of the C₁₈ polyunsaturated fatty acid is about 1.5 times to about 3 times more than the C₁₆ polyunsaturated fatty acid, wherein a concentration of the C₁₈ polyunsaturated fatty acid is about 15 times to about 35 times more than the C₁₄ polyunsaturated fatty acid, and wherein a concentration of the C₁₆ polyunsaturated fatty acid is about 3 times to about 15 times more than the C₁₄ polyunsaturated fatty acid.

The lipid composition may be used as a mutton fat additive or mutton meat flavour additive.

In some embodiments, the lipid composition comprises:
a) a C₁₈ monounsaturated fatty acid and a C₁₆ monounsaturated fatty acid, wherein a concentration of the C₁₈ monounsaturated fatty acid is about 1 time to about 2.5 times more than the C₁₆ monounsaturated fatty acid; and
b) a C₁₈ polyunsaturated fatty acid and a C₁₆ polyunsaturated fatty acid, wherein a concentration of the C₁₈ polyunsaturated fatty acid is about 1 time to about 2.5 times more than the C₁₆ polyunsaturated fatty acid.

In some embodiments, the lipid composition comprises:
a) a C₁₈ monounsaturated fatty acid and a C₁₄ monounsaturated fatty acid, wherein a concentration of the C₁₈ monounsaturated fatty acid is about 12 times to about 35 times more than the C₂₀ monounsaturated fatty acid; and
b) a C₁₈ polyunsaturated fatty acid and a C₁₄ polyunsaturated fatty acid, wherein a concentration of the C₁₈ polyunsaturated fatty acid is about 12 times to about 35 times more than the C₂₀ polyunsaturated fatty acid.

In some embodiments, the lipid composition comprises:
a) a C₁₆ monounsaturated fatty acid and a C₁₄ monounsaturated fatty acid, wherein a concentration of the C₁₆ monounsaturated fatty acid is about 3 times to about 15 times more than the C₂₀ monounsaturated fatty acid; and
b) a C₁₆ polyunsaturated fatty acid and a C₁₄ polyunsaturated fatty acid, wherein a concentration of the C₁₆ polyunsaturated fatty acid is about 3 times to about 15 times more than the C₂₀ polyunsaturated fatty acid.

In some embodiments, the lipid composition comprises:
a) a C₁₈ monounsaturated fatty acid, a C₁₆ monounsaturated fatty acid, and a C₂₀ monounsaturated fatty acid, wherein a concentration of the C₁₈ monounsaturated fatty acid is about 1 time to about 2.5 times more than the C₁₆ monounsaturated fatty acid, wherein a concentration of the C₁₈ monounsaturated fatty acid is about 12 times to about 35 times more than the C₂₀ monounsaturated fatty acid, and wherein a concentration of the C₁₆ monounsaturated fatty acid is about 3 times to about 15 times more than the C₂₀ monounsaturated fatty acid; and
b) a C₁₈ polyunsaturated fatty acid, a C₁₆ polyunsaturated fatty acid, and a C₂₀ polyunsaturated fatty acid, wherein a concentration of the C₁₈ polyunsaturated fatty acid is about 1 time to about 2.5 times more than the C₁₆ polyunsaturated fatty acid, wherein a concentration of the C₁₈ polyunsaturated fatty acid is about 12 times to about 35 times more than the C₂₀ polyunsaturated fatty acid, and wherein a concentration of the C₁₆ polyunsaturated fatty acid is about 3 times to about 15 times more than the C₂₀ polyunsaturated fatty acid.

In some embodiments, the lipid composition comprises at least three monounsaturated fatty acids, wherein each monounsaturated fatty acid independently comprises C₁₀-C₂₄ alkyl and at least three polyunsaturated fatty acids, wherein each polyunsaturated fatty acid independently comprises C₁₀-C₂₄ alkyl. In some embodiments, each monounsaturated fatty acid independently comprises C₁₀ alkyl, C₁₂ alkyl, C₁₄ alkyl, C₁₆ alkyl, C₁₈ alkyl, C₂₀ alkyl, C₂₂ alkyl, or C₂₄ alkyl. In some embodiments, each polyunsaturated fatty acid independently comprises C₁₀ alkyl, C₁₂ alkyl, C₁₄ alkyl, C₁₆ alkyl, C₁₈ alkyl, C₂₀ alkyl, C₂₂ alkyl, or C₂₄ alkyl.

In some embodiments, the lipid composition comprises:
a) C₅-C₃₀ monounsaturated fatty acids at about 10% w/w to about 50% w/w relative to the lipid composition;
b) C₅-C₃₀ polyunsaturated fatty acids at about 5% w/w to about 40% w/w relative to the lipid composition;
c) glycerides at about 30% w/w to about 70% w/w relative to the lipid composition; and
d) a catalyst for breaking down the fatty acids and glycerides into volatiles in the presence of heat, the catalyst at about 0.05% w/w to about 2% w/w relative to the lipid composition.

In some embodiments, the lipid composition comprises:
a) C₅-C₃₀ monounsaturated fatty acids at about 20% w/w to about 40% w/w relative to the lipid composition;
b) C₅-C₃₀ polyunsaturated fatty acids at about 20% w/w to about 30% w/w relative to the lipid composition;
c) glycerides at about 40% w/w to about 60% w/w relative to the lipid composition; and
d) a catalyst for breaking down the fatty acids and glycerides into volatiles in the presence of heat, the catalyst at about 0.05% w/w to about 2% w/w relative to the lipid composition.

In some embodiments, the lipid composition comprises:
a) C₅-C₃₀ monounsaturated fatty acids at about 20% w/w to about 40% w/w relative to the lipid composition;
b) C₅-C₃₀ polyunsaturated fatty acids at about 5% w/w to about 40% w/w relative to the lipid composition;
c) triglycerides at about 40% w/w to about 60% w/w relative to the lipid composition; and
d) a catalyst for breaking down the fatty acids and triglycerides into volatiles in the presence of heat, the catalyst at about 0.05% w/w to about 2% w/w relative to the lipid composition.

In some embodiments, the lipid composition comprises:
a) C₅-C₃₀ monounsaturated fatty acids at about 20% w/w to about 40% w/w relative to the lipid composition;
b) C₅-C₃₀ polyunsaturated fatty acids at about 20% w/w to about 30% w/w relative to the lipid composition;
c) triglycerides at about 40% w/w to about 60% w/w relative to the lipid composition; and
d) a catalyst for breaking down the fatty acids and triglycerides into volatiles in the presence of heat, the catalyst at about 0.05% w/w to about 2% w/w relative to the lipid composition.

In some embodiments, the lipid composition comprises:
a) C₁₀-C₂₄ monounsaturated fatty acids at about 10% w/w to about 50% w/w relative to the lipid composition;
b) C₁₀-C₂₄ polyunsaturated fatty acids at about 5% w/w to about 40% w/w relative to the lipid composition;
c) glycerides at about 30% w/w to about 70% w/w relative to the lipid composition; and
d) a catalyst for breaking down the fatty acids and glycerides into volatiles in the presence of heat, the catalyst at about 0.05% w/w to about 2% w/w relative to the lipid composition.

In some embodiments, the lipid composition comprises:
a) C₁₀-C₂₄ monounsaturated fatty acids at about 20% w/w to about 40% w/w relative to the lipid composition;
b) C₁₀-C₂₄ polyunsaturated fatty acids at about 20% w/w to about 30% w/w relative to the lipid composition;
c) glycerides at about 40% w/w to about 60% w/w relative to the lipid composition; and
d) a catalyst for breaking down the fatty acids and glycerides into volatiles in the presence of heat, the catalyst at about 0.05% w/w to about 2% w/w relative to the lipid composition.

In some embodiments, the lipid composition comprises:
a) C₁₀-C₂₄ monounsaturated fatty acids at about 20% w/w to about 40% w/w relative to the lipid composition;
b) C₁₀-C₂₄ polyunsaturated fatty acids at about 5% w/w to about 40% w/w relative to the lipid composition;
c) triglycerides at about 40% w/w to about 60% w/w relative to the lipid composition; and
d) a catalyst for breaking down the fatty acids and triglycerides into volatiles in the presence of heat, the catalyst at about 0.05% w/w to about 2% w/w relative to the lipid composition.

In some embodiments, the lipid composition comprises:
a) C₁₀-C₂₄ monounsaturated fatty acids at about 20% w/w to about 40% w/w relative to the lipid composition;
b) C₁₀-C₂₄ polyunsaturated fatty acids at about 20% w/w to about 30% w/w relative to the lipid composition;
c) triglycerides at about 40% w/w to about 60% w/w relative to the lipid composition; and
d) a catalyst for breaking down the fatty acids and triglycerides into volatiles in the presence of heat, the catalyst at about 0.05% w/w to about 2% w/w relative to the lipid composition.

In some embodiments, the lipid composition comprises:
a) C₁₀-C₂₄ monounsaturated fatty acids at about 10% w/w to about 50% w/w relative to the lipid composition, the monounsaturated fatty acids comprising a first C₁₀-C₂₄ monounsaturated fatty acid and a second C₁₀-C₂₄ monounsaturated fatty acid, wherein a concentration of the first monounsaturated fatty acid is about 0.5 times to about 5 times more than the second monounsaturated fatty acid;
b) C₁₀-C₂₄ polyunsaturated fatty acids at about 5% w/w to about 40% w/w relative to the lipid composition, the polyunsaturated fatty acids comprising a first C₁₀-C₂₄ polyunsaturated fatty acid and a second C₁₀-C₂₄ polyunsaturated fatty acid, wherein a concentration of the first polyunsaturated fatty acid is about 0.5 times to about 5 times more than the second polyunsaturated fatty acid;
c) glycerides at about 30% w/w to about 70% w/w relative to the lipid composition; and
d) a catalyst for breaking down the fatty acids and glycerides into volatiles in the presence of heat, the catalyst at about 0.05% w/w to about 2% w/w relative to the lipid composition.

In some embodiments, the lipid composition comprises:
a) C₁₀-C₂₄ monounsaturated fatty acids at about 20% w/w to about 40% w/w relative to the lipid composition, the monounsaturated fatty acids comprising a first C₁₀-C₂₄ monounsaturated fatty acid and a second C₁₀-C₂₄ monounsaturated fatty acid, wherein a concentration of the first monounsaturated fatty acid is about 0.5 times to about 5 times more than the second monounsaturated fatty acid;
b) C₁₀-C₂₄ polyunsaturated fatty acids at about 20% w/w to about 30% w/w relative to the lipid composition, the polyunsaturated fatty acids comprising a first C₁₀-C₂₄ polyunsaturated fatty acid and a second C₁₀-C₂₄ polyunsaturated fatty acid, wherein a concentration of the first polyunsaturated fatty acid is about 0.5 times to about 5 times more than the second polyunsaturated fatty acid;
c) glycerides at about 40% w/w to about 60% w/w relative to the lipid composition; and
d) a catalyst for breaking down the fatty acids and glycerides into volatiles in the presence of heat, the catalyst at about 0.05% w/w to about 2% w/w relative to the lipid composition.

In some embodiments, the lipid composition comprises:
a) C₁₀-C₂₄ monounsaturated fatty acids at about 20% w/w to about 40% w/w relative to the lipid composition, the monounsaturated fatty acids comprising a first C₁₀-C₂₄ monounsaturated fatty acid and a second C₁₀-C₂₄ monounsaturated fatty acid, wherein a concentration of the first monounsaturated fatty acid is about 0.5 times to about 5 times more than the second monounsaturated fatty acid;
b) C₁₀-C₂₄ polyunsaturated fatty acids at about 5% w/w to about 40% w/w relative to the lipid composition, the polyunsaturated fatty acids comprising a first C₁₀-C₂₄ polyunsaturated fatty acid and a second C₁₀-C₂₄ polyunsaturated fatty acid, wherein a concentration of the first polyunsaturated fatty acid is about 0.5 times to about 5 times more than the second polyunsaturated fatty acid;
c) triglycerides at about 40% w/w to about 60% w/w relative to the lipid composition; and
d) a catalyst for breaking down the fatty acids and triglycerides into volatiles in the presence of heat, the catalyst at about 0.05% w/w to about 2% w/w relative to the lipid composition.

In some embodiments, the lipid composition comprises:
a) C₁₀-C₂₄ monounsaturated fatty acids at about 20% w/w to about 40% w/w relative to the lipid composition, the monounsaturated fatty acids comprising a first C₁₀-C₂₄ monounsaturated fatty acid and a second C₁₀-C₂₄ monounsaturated fatty acid, wherein a concentration of the first monounsaturated fatty acid is about 0.5 times to about 5 times more than the second monounsaturated fatty acid;
b) C₁₀-C₂₄ polyunsaturated fatty acids at about 20% w/w to about 30% w/w relative to the lipid composition, the polyunsaturated fatty acids comprising a first C₁₀-C₂₄ polyunsaturated fatty acid and a second C₁₀-C₂₄ polyunsaturated fatty acid, wherein a concentration of the first polyunsaturated fatty acid is about 0.5 times to about 5 times more than the second polyunsaturated fatty acid;
c) triglycerides at about 40% w/w to about 60% w/w relative to the lipid composition; and
d) a catalyst for breaking down the fatty acids and triglycerides into volatiles in the presence of heat, the catalyst at about 0.05% w/w to about 2% w/w relative to the lipid composition.

In some embodiments, the lipid composition comprises:
a) C₁₀-C₂₄ monounsaturated fatty acids at about 10% w/w to about 50% w/w relative to the lipid composition, the monounsaturated fatty acids comprising a first C₁₀-C₂₄ monounsaturated fatty acid, a second C₁₀-C₂₄ monounsaturated fatty acid, and a third C₁₀-C₂₄ monounsaturated fatty acid, wherein a concentration of the first monounsaturated fatty acid is about 0.5 times to about 5 times more than the second monounsaturated fatty acid, wherein a concentration of the first monounsaturated fatty acid is about 0.5 times to about times more than the third monounsaturated fatty acid, and wherein a concentration of the second monounsaturated fatty acid is about 0.1 times to about 20 times more than the third monounsaturated fatty acid;
b) C₁₀-C₂₄ polyunsaturated fatty acids at about 5% w/w to about 40% w/w relative to the lipid composition, the polyunsaturated fatty acids comprising a first C₁₀-C₂₄ polyunsaturated fatty acid, a second C₁₀-C₂₄ polyunsaturated fatty acid, and a third C₁₀-C₂₄ polyunsaturated fatty acid, wherein a concentration of the first polyunsaturated fatty acid is about 0.5 times to about 5 times more than the second polyunsaturated fatty acid, wherein a concentration of the first polyunsaturated fatty acid is about 0.5 times to about 40 times more than the third polyunsaturated fatty acid, and wherein a concentration of the second polyunsaturated fatty acid is about 0.1 times to about 20 times more than the third polyunsaturated fatty acid;
c) glycerides at about 30% w/w to about 70% w/w relative to the lipid composition; and
d) a catalyst for breaking down the fatty acids and glycerides into volatiles in the presence of heat, the catalyst at about 0.05% w/w to about 2% w/w relative to the lipid composition.

In some embodiments, the lipid composition comprises:
a) C₁₀-C₂₄ monounsaturated fatty acids at about 20% w/w to about 40% w/w relative to the lipid composition, the monounsaturated fatty acids comprising a first C₁₀-C₂₄ monounsaturated fatty acid, a second C₁₀-C₂₄ monounsaturated fatty acid, and a third C₁₀-C₂₄ monounsaturated fatty acid, wherein a concentration of the first monounsaturated fatty acid is about 0.5 times to about 5 times more than the second monounsaturated fatty acid, wherein a concentration of the first monounsaturated fatty acid is about 0.5 times to about times more than the third monounsaturated fatty acid, and wherein a concentration of the second monounsaturated fatty acid is about 0.1 times to about 20 times more than the third monounsaturated fatty acid;
b) C₁₀-C₂₄ polyunsaturated fatty acids at about 20% w/w to about 30% w/w relative to the lipid composition, the polyunsaturated fatty acids comprising a first C₁₀-C₂₄ polyunsaturated fatty acid, a second C₁₀-C₂₄ polyunsaturated fatty acid, and a third C₁₀-C₂₄ polyunsaturated fatty acid, wherein a concentration of the first polyunsaturated fatty acid is about 0.5 times to about 5 times more than the second polyunsaturated fatty acid, wherein a concentration of the first polyunsaturated fatty acid is about 0.5 times to about 40 times more than the third polyunsaturated fatty acid, and wherein a concentration of the second polyunsaturated fatty acid is about 0.1 times to about 20 times more than the third polyunsaturated fatty acid;
c) glycerides at about 40% w/w to about 60% w/w relative to the lipid composition; and
d) a catalyst for breaking down the fatty acids and glycerides into volatiles in the presence of heat, the catalyst at about 0.05% w/w to about 2% w/w relative to the lipid composition.

In some embodiments, the lipid composition comprises:
a) C₁₀-C₂₄ monounsaturated fatty acids at about 20% w/w to about 40% w/w relative to the lipid composition, the monounsaturated fatty acids comprising a first C₁₀-C₂₄ monounsaturated fatty acid, a second C₁₀-C₂₄ monounsaturated fatty acid, and a third C₁₀-C₂₄ monounsaturated fatty acid, wherein a concentration of the first monounsaturated fatty acid is about 0.5 times to about 5 times more than the second monounsaturated fatty acid, wherein a concentration of the first monounsaturated fatty acid is about 0.5 times to about times more than the third monounsaturated fatty acid, and wherein a concentration of the second monounsaturated fatty acid is about 0.1 times to about 20 times more than the third monounsaturated fatty acid;
b) C₁₀-C₂₄ polyunsaturated fatty acids at about 5% w/w to about 40% w/w relative to the lipid composition, the polyunsaturated fatty acids comprising a first C₁₀-C₂₄ polyunsaturated fatty acid, a second C₁₀-C₂₄ polyunsaturated fatty acid, and a third C₁₀-C₂₄ polyunsaturated fatty acid, wherein a concentration of the first polyunsaturated fatty acid is about 0.5 times to about 5 times more than the second polyunsaturated fatty acid, wherein a concentration of the first polyunsaturated fatty acid is about 0.5 times to about 40 times more than the third polyunsaturated fatty acid, and wherein a concentration of the second polyunsaturated fatty acid is about 0.1 times to about 20 times more than the third polyunsaturated fatty acid;
c) triglycerides at about 40% w/w to about 60% w/w relative to the lipid composition; and
d) a catalyst for breaking down the fatty acids and triglycerides into volatiles in the presence of heat, the catalyst at about 0.05% w/w to about 2% w/w relative to the lipid composition.

In some embodiments, the lipid composition comprises:
a) C₁₀-C₂₄ monounsaturated fatty acids at about 20% w/w to about 40% w/w relative to the lipid composition, the monounsaturated fatty acids comprising a first C₁₀-C₂₄ monounsaturated fatty acid, a second C₁₀-C₂₄ monounsaturated fatty acid, and a third C₁₀-C₂₄ monounsaturated fatty acid, wherein a concentration of the first monounsaturated fatty acid is about 0.5 times to about 5 times more than the second monounsaturated fatty acid, wherein a concentration of the first monounsaturated fatty acid is about 0.5 times to about times more than the third monounsaturated fatty acid, and wherein a concentration of the second monounsaturated fatty acid is about 0.1 times to about 20 times more than the third monounsaturated fatty acid;
b) C₁₀-C₂₄ polyunsaturated fatty acids at about 20% w/w to about 30% w/w relative to the lipid composition, the polyunsaturated fatty acids comprising a first C₁₀-C₂₄ polyunsaturated fatty acid, a second C₁₀-C₂₄ polyunsaturated fatty acid, and a third C₁₀-C₂₄ polyunsaturated fatty acid, wherein a concentration of the first polyunsaturated fatty acid is about 0.5 times to about 5 times more than the second polyunsaturated fatty acid, wherein a concentration of the first polyunsaturated fatty acid is about 0.5 times to about 40 times more than the third polyunsaturated fatty acid, and wherein a concentration of the second polyunsaturated fatty acid is about 0.1 times to about 20 times more than the third polyunsaturated fatty acid;
c) triglycerides at about 40% w/w to about 60% w/w relative to the lipid composition; and
d) a catalyst for breaking down the fatty acids and triglycerides into volatiles in the presence of heat, the catalyst at about 0.05% w/w to about 2% w/w relative to the lipid composition.

In some embodiments, the lipid composition comprises:
a) C₁₀-C₂₄ monounsaturated fatty acids at about 10% w/w to about 50% w/w relative to the lipid composition, the monounsaturated fatty acids comprising at least three monounsaturated fatty acids, wherein each monounsaturated fatty acid independently comprises C₁₀-C₂₄ alkyl;
b) C₁₀-C₂₄ polyunsaturated fatty acids at about 5% w/w to about 40% w/w relative to the lipid composition, the polyunsaturated fatty acids comprising at least three polyunsaturated fatty acids, wherein each polyunsaturated fatty acid independently comprises C₁₀-C₂₄ alkyl;
c) glycerides at about 30% w/w to about 70% w/w relative to the lipid composition; and
d) a catalyst for breaking down the fatty acids and glycerides into volatiles in the presence of heat, the catalyst at about 0.05% w/w to about 2% w/w relative to the lipid composition.

In some embodiments, the lipid composition comprises:
a) C₁₀-C₂₄ monounsaturated fatty acids at about 20% w/w to about 40% w/w relative to the lipid composition, the monounsaturated fatty acids comprising at least three monounsaturated fatty acids, wherein each monounsaturated fatty acid independently comprises C₁₀-C₂₄ alkyl;
b) C₁₀-C₂₄ polyunsaturated fatty acids at about 20% w/w to about 30% w/w relative to the lipid composition, the polyunsaturated fatty acids comprising at least three polyunsaturated fatty acids, wherein each polyunsaturated fatty acid independently comprises C₁₀-C₂₄ alkyl;
c) glycerides at about 40% w/w to about 60% w/w relative to the lipid composition; and
d) a catalyst for breaking down the fatty acids and glycerides into volatiles in the presence of heat, the catalyst at about 0.05% w/w to about 2% w/w relative to the lipid composition.

In some embodiments, the lipid composition comprises:
a) C₁₀-C₂₄ monounsaturated fatty acids at about 20% w/w to about 40% w/w relative to the lipid composition, the monounsaturated fatty acids comprising at least three monounsaturated fatty acids, wherein each monounsaturated fatty acid independently comprises C₁₀-C₂₄ alkyl;
b) C₁₀-C₂₄ polyunsaturated fatty acids at about 5% w/w to about 40% w/w relative to the lipid composition, the polyunsaturated fatty acids comprising at least three polyunsaturated fatty acids, wherein each polyunsaturated fatty acid independently comprises C₁₀-C₂₄ alkyl;
c) triglycerides at about 40% w/w to about 60% w/w relative to the lipid composition; and
d) a catalyst for breaking down the fatty acids and triglycerides into volatiles in the presence of heat, the catalyst at about 0.05% w/w to about 2% w/w relative to the lipid composition.

In some embodiments, the lipid composition comprises:
a) C₁₀-C₂₄ monounsaturated fatty acids at about 20% w/w to about 40% w/w relative to the lipid composition, the monounsaturated fatty acids comprising at least three monounsaturated fatty acids, wherein each monounsaturated fatty acid independently comprises C₁₀-C₂₄ alkyl;
b) C₁₀-C₂₄ polyunsaturated fatty acids at about 20% w/w to about 30% w/w relative to the lipid composition, the polyunsaturated fatty acids comprising at least three polyunsaturated fatty acids, wherein each polyunsaturated fatty acid independently comprises C₁₀-C₂₄ alkyl;
c) triglycerides at about 40% w/w to about 60% w/w relative to the lipid composition; and
d) a catalyst for breaking down the fatty acids and triglycerides into volatiles in the presence of heat, the catalyst at about 0.05% w/w to about 2% w/w relative to the lipid composition.

In some embodiments, the lipid composition further comprises a saturated fatty acid. A saturated fatty acid has no double bonds and are straight chained. Saturated fatty acids are primarily found in animal-based foods, such as meat, dairy products, and eggs. They are also present in some plant-based oils, such as coconut oil, palm oil, and palm kernel oil. Saturated fatty acids may enhance the perception of certain flavours such as sweetness or saltiness. They may be more resistant to oxidation compared to unsaturated fatty acids and may help in maintaining a consistent sensory experience of the food over time. The saturated fatty acid may be lauric acid, myristic acid, palmitic acid and stearic acid.

In some embodiments, the lipid composition further comprises saturated fatty acids at about 20% w/w to about 60% w/w relative to the lipid composition. In other embodiments, the % w/w is about 20% w/w to about 55% w/w, about 20% w/w to about 50% w/w, about 20% w/w to about 45% w/w, about 20% w/w to about 40% w/w, about 20% w/w to about 35% w/w, about 20% w/w to about 30% w/w, about 30% w/w to about 60% w/w, about 30% w/w to about 55% w/w, about 30% w/w to about 50% w/w, about 30% w/w to about 45% w/w, about 30% w/w to about 40% w/w, about 30% w/w to about 35% w/w, about 35% w/w to about 60% w/w, about 35% w/w to about 55% w/w, about 35% w/w to about 50% w/w, or about 35% w/w to about 40% w/w relative to the lipid composition.

The lipid composition may be heated in order to release various volatiles, contributing to the flavour profile of the heated lipid composition. The volatiles generated during the heating of the lipid composition may have a sensory impact on consumers as the volatiles interact with the olfactory and gustatory senses, contributing to the overall flavour perception. Volatiles are the primary contributors to the aroma of heated lipid-containing food. When the volatiles are released into the air and reach the olfactory receptors in the noise, they may elicit specific odour perceptions. Some volatiles may also interact with the taste receptors on the tongue and the interplay between aroma and taste may affect the perceived flavour. Higher molecular weight volatiles may contribute to the texture perception of the food.

The volatiles may be organic in nature and may be pyrazines, aldehydes, acids, ketones, hydrocarbons, esters, alcohols, nitrogen-containing compounds and sulfur-containing compounds. Different volatiles may impart different flavours. For example, pyrazines may impart nutty, roasted or savoury flavours; aldehydes may impart grassy or fatty flavours; ketones may impart nutty, fruity or buttery flavours; alcohols may impart earthy flavours; furans may impart roasted or burnt flavours. In some embodiments, the volatiles comprise alkane, aldehyde, epoxide, thiol, salt, ester, ketone, alcohol, heterocycle, carboxylic acid, hydrazine, or a combination thereof. The relative concentrations and interactions of different volatiles may influence the overall flavour intensity and balance of the flavour. Varying levels of the volatiles may result in different flavour profiles. For example, a high concentration of 2-methyl-3-furanthiol, 4-hydroxy-2,5-dimethyl-3-(2H)-furanone, and 2-furfurylthiol may be associated with the meaty-caramel odour in cooked beef. In contrast, a lower concentration of 4-hydroxy-2,5-dimethyl-3-(2H)-furanone is enough to provide the odour of pork meat, and similarly, a lower level of carbonyls (e.g., hexanal and nonanal) may be associated for the greasy odour in pork than in beef meat. The fresh fish aromas may be linked with alcohols (I-penten-3-ol, cis-3-hexen-I-ol, I-octen-3-ol, trans-2-octen-1-ol, 1,5-octadien-3-ol, 2,5-octadien-I-ol, trans-2-nonen-I-ol, cis-6-nonen-I-ol, cis-3-nonen-I-ol, and 3,6-nonadien-I-ol) and carbonyls (trans-2-penten-I-al, hexan-I-al, trans-2-hexen-I-al, trans-octen-I-al, trans-2-nonen-I-al, I-octen-3-one, 2,3-octadien-I-one, and 1,5-octadien-3-one).

A pork flavour profile may comprise hexanal, nonanal, octananl, 2-heptanone, 2-octanone, 1-octen-3-ol, 2-ethyl-1-hexanol, ethyl hexanoate, ethyl octanoate, dimethyl disulphide, methanethiol, toluene and styrene.

A beef flavour profile may comprise hexanal, nonanal, 2-nonenal, 2-heptanone, 2-octanone, 1-octen-3-ol, 2-ethyl-1-hexanol, ethyl hexanoate, ethyl octanoate, dimethyl disulphide, methanethiol, toluene, styrene and 2-ethyl-3,5-dimethylpyrazine.

A chicken flavour profile may comprise hexanal, nonanal, 2-nonenal, 2-heptanone, 2-octanone, 1-octen-3-ol, 2-ethyl-1-hexanol, ethyl hexanoate, ethyl octanoate, dimethyl disulphide, methanethiol, 2-ethyl-3,5-dimethylpyrazine and 2-pentylfuran.

A fish flavour profile may comprise hexanal, nonanal, 2-nonenal, 2-heptanone, 2-octanone, 1-octen-3-ol, 2-ethyl-1-hexanol, ethyl hexanoate, ethyl octanoate, dimethyl disulphide, methanethiol, trimethylamine, indole, 2,4,7-decatrienal and 2,4-heptadienal.

An unagi flavour profile may comprise hexanal, nonanal, 2-nonenal, 2-heptanone, 2-octanone, 1-octen-3-ol, 2-ethyl-1-hexanol, ethyl hexanoate, ethyl octanoate, dimethyl disulphide, methanethiol, trimethylamine, 2-ethyl-3,5-dimethylpyrazine, 2,3-dimethylpryazine, 2,3,5-trimethylpyrazine, 2,4,7-decatrienal and 2,4-heptadienal.

A mutton flavour profile may comprise hexanal, nonanal, octananl, 2-heptanone, 2-octanone, 1-octen-3-ol, 2-ethyl-1-hexanol, ethyl hexanoate, ethyl octanoate, dimethyl disulphide, dimethyl trisulfide, toluene and styrene.

A duck flavour profile may comprise hexanal, nonanal, octananl, 2-heptanone, 2-octanone, 1-octen-3-ol, 2-ethyl-1-hexanol, ethyl hexanoate, ethyl octanoate, dimethyl disulphide, dimethyl trisulfide, toluene, styrene, 2-methyl-3-furanthiol and 2,3-dimethylpryazine.

In some embodiments, when heated, the lipid composition is characterised by a volatile profile comprising C₁ to C₁₅ acyl compound. When the lipid composition is heated to temperatures of about 150° C. to about 300° C., the lipid composition may be oxidised into volatiles comprising C₁ to C₁₅ acyl compound. This may occur when the lipid composition is added to food where the food is grilled, roasted, fried or baked.

In some embodiments, the volatile profile comprises C₁ to C₁₅ aldehyde, C₁ to C₁₅ aldehyde, or a combination thereof. In some embodiments, the volatile profile comprises C₁ to C₁₅ aldehyde. The aldehyde may be acetaldehyde, propanal, 2-methly-propanal, 2-propenal, butanal, 2-methly-butanal, 3-methyl-butanal, pentanal, 2-butenal, hexanal, (E)-2-pentenal, heptanal, octanal, (Z)-2-heptenal, nonanal, (E)-2-octenal, (E,E)-2,4-heptadienal, benzaldehyde, (E)-2-nonenal, (E)-2-decenal, (E)-2-tridecenal, (E,E)-2,4-nonadienal, 2-undecenal, (E,E)-2,4-decadienal and 2,4-decadienal. In some embodiments, the volatile profile comprises C₃ to C₁₅ ketone. The ketone may be 2,3-pentanedione, trans-3-Nonen-2-one, and 4,5-dimethyl-1,3-Dioxol-2-one.

In some embodiments, the lipid composition is characterised by a wt % of about 0.5 wt % to about 90 wt % of C₁ to C₁₅ acyl compound relative to the volatile profile. In other embodiments, the wt % is about 0.5 wt % to about 90 wt %, about 0.5 wt % to about 80 wt %, about 0.5 wt % to about 70 wt %, about 0.5 wt % to about 60 wt %, about 0.5 wt % to about 50 wt %, about 0.5 wt % to about 40 wt %, about 0.5 wt % to about 30 wt %, about 0.5 wt % to about 20 wt %, about 0.5 wt % to about 10 wt %, about 10 wt % to about 90 wt %, about 10 wt % to about 80 wt %, about 10 wt % to about 70 wt %, about 10 wt % to about 60 wt %, about 10 wt % to about 50 wt %, about 10 wt % to about 40 wt %, about 10 wt % to about 30 wt %, about 10 wt % to about 20 wt %, about 40 wt % to about 90 wt %, about 40 wt % to about 80 wt %, about 40 wt % to about 70 wt %, about 45 wt % to about 60 wt %, about 45 wt % to about 50 wt %, about 50 wt % to about 90 wt %, about 50 wt % to about 80 wt %, about 50 wt % to about 70 wt %, about 50 wt % to about 60 wt %, about 60 wt % to about 90 wt %, about 60 wt % to about 80 wt %, or about 60 wt % to about 70 wt % relative to the volatile profile.

In some embodiments, the lipid composition is characterised by a % increase of C₁ to C₁₅ acyl compound of about 150% to about 2500% in the volatile profile relative to the volatile profile of a control, the control being a lipid composition without a catalyst. In other embodiments, the % increase is about 150% to about 2000%, about 150% to about 1500%, about 150% to about 1000%, about 150% to about 500%, about 500% to about 2500%, about 500% to about 2000%, about 500% to about 1500%, about 500% to about 1000%, about 1000% to about 2500%, about 1000% to about 2000%, about 1000% to about 1500%, about 1500% to about 2500%, or about 1500% to about 2000% relative to the control.

In some embodiments, the lipid composition is characterised by a wt % of about 45 wt % to about 90 wt % of C₁ to C₁₅ aldehyde relative to the volatile profile. In other embodiments, the wt % is about 45 wt % to about 85 wt %, about 45 wt % to about 80 wt %, about 45 wt % to about 75 wt %, about 45 wt % to about 70 wt %, about 45 wt % to about 65 wt %, about 45 wt % to about 60 wt %, about 45 wt % to about 55 wt %, about 45 wt % to about 50 wt %, about 50 wt % to about 90 wt %, about 50 wt % to about 85 wt %, about 50 wt % to about 80 wt %, about 50 wt % to about 75 wt %, about 50 wt % to about 70 wt %, about 50 wt % to about 65 wt %, about 50 wt % to about 60 wt %, about 50 wt % to about 55 wt %, about 55 wt % to about 90 wt %, about 55 wt % to about 85 wt %, about 55 wt % to about 80 wt %, about 55 wt % to about 75 wt %, about 55 wt % to about 70 wt %, about 55 wt % to about 65 wt %, or about 55 wt % to about 60 wt % relative to the volatile profile.

In some embodiments, the lipid composition is characterised by a % increase of C₁ to C₁₅ aldehyde of about 150% to about 2500% in the volatile profile relative to the volatile profile of a control, the control being a lipid composition without a catalyst. In other embodiments, the % increase is about 150% to about 2000%, about 150% to about 1500%, about 150% to about 1000%, about 150% to about 500%, about 500% to about 2500%, about 500% to about 2000%, about 500% to about 1500%, about 500% to about 1000%, about 1000% to about 2500%, about 1000% to about 2000%, about 1000% to about 1500%, about 1500% to about 2500%, or about 1500% to about 2000% relative to the control.

In some embodiments, the lipid composition is characterised by a wt % of about 0.5 wt % to about 10 wt % of C₃ to C₁₅ ketone relative to the volatile profile. In other embodiments, the wt % is about 0.5 wt % to about 9 wt %, about 0.5 wt % to about 8 wt %, about 0.5 wt % to about 7 wt %, about 0.5 wt % to about 6 wt %, about 0.5 wt % to about 5 wt %, about 0.5 wt % to about 4 wt %, about 0.5 wt % to about 3 wt %, about 0.5 wt % to about 2 wt %, about 0.5 wt % to about 1 wt %, about 1 wt % to about 10 wt %, about 1 wt % to about 9 wt %, about 1 wt % to about 8 wt %, about 1 wt % to about 7 wt %, about 1 wt % to about 6 wt %, about 1 wt % to about 5 wt %, about 1 wt % to about 4 wt %, about 1 wt % to about 3 wt %, or about 1 wt % to about 2 wt % relative to the volatile profile.

In some embodiments, the lipid composition is characterised by a presence of C₃ to C₁₅ ketone in the volatile profile relative to the absence of C₃ to C₁₅ ketone in the volatile profile of a control, the control being a lipid composition without a catalyst.

In some embodiments, the lipid composition is characterised by a % increase of 3-methly-butanal of about 100% to about 750% in the volatile profile relative to the volatile profile of a control, the control being a lipid composition without a catalyst. In other embodiments, the % increase is about 100% to about 700%, about 100% to about 600%, about 100% to about 500%, about 100% to about 400%, about 100% to about 300%, about 100% to about 200%, about 400% to about 750%, about 400% to about 700%, about 400% to about 600%, or about 400% to about 500% relative to the control.

In some embodiments, the lipid composition is characterised by a % increase of 2,4-decadienal of about 100% to about 750% in the volatile profile relative to the volatile profile of a control, the control being a lipid composition without a catalyst. In other embodiments, the % increase is about 100% to about 700%, about 100% to about 600%, about 100% to about 500%, about 100% to about 400%, about 100% to about 300%, about 100% to about 200, about 400% to about 750%, about 400% to about 700%, about 400% to about 600%, or about 400% to about 500% relative to the control.

In some embodiments, the lipid composition is characterised by a % increase of 2-decadienal of about 100% to about 500% in the volatile profile relative to the volatile profile of a control, the control being a lipid composition without a catalyst. In other embodiments, the % increase is about 100% to about 400%, about 100% to about 300%, about 100% to about 200, about 200% to about 500%, about 200% to about 400%, about 200% to about 300%, or about 400% to about 500% relative to the control.

In some embodiments, the lipid composition is characterised by a % increase of (E)-2-tridecenal of about 100% to about 500% in the volatile profile relative to the volatile profile of a control, the control being a lipid composition without a catalyst. In other embodiments, the % increase is about 100% to about 400%, about 100% to about 300%, about 100% to about 200, about 200% to about 500%, about 200% to about 400%, about 200% to about 300%, or about 400% to about 500% relative to the control.

In some embodiments, the lipid composition is characterised by a % increase of 2-undecenal of about 100% to about 500% in the volatile profile relative to the volatile profile of a control, the control being a lipid composition without a catalyst. In other embodiments, the % increase is about 100% to about 400%, about 100% to about 300%, about 100% to about 200%, about 200% to about 500%, about 200% to about 400%, about 200% to about 300%, or about 400% to about 500% relative to the control.

In some embodiments, when heated, the lipid composition is characterised by a volatile profile further comprising C₁ to C₁₅ alcohol. The alcohol may be propanol, butanol, pentanol, 1-penten-3-ol, hexanol, heptanol, octanol, nonanol, decanol, dodecanol, tetradecanol, 2-ethyl-2-hexen-1-ol, and glycerol. When the lipid composition is heated to temperatures of about 80° C. to about 250° C., the lipid composition may be oxidised into volatiles comprising C₁ to C₁₅ alcohol. This may occur when the lipid composition is added to food where the food is grilled, roasted, fried or baked. The food may also be cooked as a soup or sauce.

In some embodiments, the lipid composition is characterised by a wt % of about 5 wt % to about 20 wt % of C₁ to C₁₅ alcohol relative to the volatile profile. In other embodiments, the wt % is about 5 wt % to about 15 wt %, about 5 wt % to about 10 wt %, about 10 wt % to about 20 wt %, about 10 wt % to about 15 wt %, or about 15 wt % to about 20 wt % relative to the volatile profile.

In some embodiments, the lipid composition is characterised by a % increase of C to C₁₅ alcohol of about 100% to about 300% in the volatile profile relative to the volatile profile of a control, the control being a lipid composition without a catalyst. In other embodiments, the % increase is about 100% to about 250%, about 100% to about 200%, about 100% to about 150%, about 150% to about 300%, about 150% to about 250%, about 150% to about 200%, about 200% to about 300%, about 200% to about 250%, or about 250% to about 300% relative to the control.

In some embodiments, when heated, the lipid composition is characterised by a volatile profile further comprising C₁ to C₁₅ carboxyl compound (—C(═O)—OH). The carboxyl may be formic acid, acetic acid heptanoic acid, octanoic acid, nonanoic acid, decanoic acid, valeric acid, caproic acid, enanthic acid, caprylic acid, pelargonic acid, capric acid, undecanoic acid, lauric acid, tridecanoic acid, and myristic acid. When the lipid composition is heated to temperatures of about 100° C. to about 300° C., the lipid composition may be oxidised into volatiles comprising C₁ to C₁₅ carboxyl compound. This may occur when the lipid composition is added to food where the food is grilled, roasted, fried or baked. The food may also be cooked as a soup or sauce.

In some embodiments, the lipid composition is characterised by a wt % of about 0.5 wt % to about 20 wt % of C₁ to C₁₅ carboxyl compound relative to the volatile profile. In other embodiments, the wt % is 0.5 wt % to about 15 wt %, about 0.5 wt % to about 8 wt %, about 0.5 wt % to about 10 wt %, about 0.5 wt % to about 5 wt %, about 0.5 wt % to about 1 wt %, about 1 wt % to about 20 wt %, about 1 wt % to about 15 wt %, about 1 wt % to about 10 wt %, about 1 wt % to about 5 wt %, about 5 wt % to about 20 wt %, about 5 wt % to about 15 wt %, about 5 wt % to about 10 wt %, about 10 wt % to about 20 wt %, about 10 wt % to about 15 wt %, or about 15 wt % to about 20 wt % relative to the volatile profile.

In some embodiments, the lipid composition is characterised by a % increase of C₁ to C₁₅ carboxyl compound of about 5% to about 200% in the volatile profile relative to the volatile profile of a control, the control being a lipid composition without a catalyst. In other embodiments, the % increase is about 5% to about 150%, about 5% to about 100%, about 5% to about 50%, about 5% to about 10%, about 10% to about 200%, about 10% to about 150%, about 10% to about 100%, about 10% to about 50%, about 50% to about 200%, about 50% to about 150%, about 50% to about 100%, about 100% to about 200%, or about 100% to about 150% relative to the control.

In some embodiments, the lipid composition is characterised by a % increase of octanoic acid of about 20% to about 400% in the volatile profile relative to the volatile profile of a control, the control being a lipid composition without a catalyst. In other embodiments, the % increase is about 20% to about 300%, about 20% to about 200%, about 20% to about 100%, about 50% to about 400%, about 50% to about 300%, about 50% to about 200%, about 50% to about 100%, about 100% to about 400%, about 100% to about 300%, or about 100% to about 200% relative to the control.

In some embodiments, when heated, the lipid composition is characterised by a volatile profile further comprising C₅ to C₁₅ alkane. The alkane may be pentane, hexane, heptane, octane, nonane, decane, undecane, dodecane, tridecane, tetradecane and pentadecane. When the lipid composition is heated to temperatures of about 200° C. to about 350° C., the lipid composition may be oxidised into volatiles comprising C₁ to C₁₅ alkane. This may occur when the lipid composition is added to food where the food is grilled, roasted, fried or baked.

In some embodiments, the lipid composition is characterised by a wt % of about 0.5 wt % to about 20 wt % of C₅ to C₁₅ alkane relative to the volatile profile. In other embodiments, the wt % is about 0.5 wt % to about 20 wt %, about 0.5 wt % to about 15 wt %, about 0.5 wt % to about 10 wt %, about 0.5 wt % to about 5 wt %, about 5 wt % to about 20 wt %, about 5 wt % to about 15 wt %, about 5 wt % to about 10 wt %, about 10 wt % to about 20 wt %, about 10 wt % to about 15 wt %, or about 15 wt % to about 20 wt % relative to the volatile profile.

In some embodiments, the lipid composition is characterised by a presence of C₅ to C₁₅ alkane in the volatile profile relative to the absence of C₅ to C₁₅ alkane in the volatile profile of a control, the control being a lipid composition without a catalyst.

In some embodiments, when heated, the lipid composition is characterised by a volatile profile further comprising C₄ to C₁₀ furan. The furan may be furan, 2-methy-furan, 2-ethyl-furan, 2-pentyl-furan, 2-heptyl-furan and 2-acetyl-furan. When the lipid composition is heated to temperatures of about 150° C. to about 250° C., the lipid composition may be oxidised into volatiles comprising C₁ to C₁₅ furan. This may occur when the lipid composition is added to food where the food is grilled, roasted, fried or baked.

In some embodiments, the lipid composition is characterised by a wt % of about 1 wt % to about 35 wt % of C₄ to C₁₀ furan relative to the volatile profile. In other embodiments, the wt % is about 1 wt % to about 30 wt %, about 1 wt % to about 25 wt %, about 1 wt % to about 20 wt %, about 1 wt % to about 15 wt %, about 1 wt %, to about 10 wt %, about 1 wt % to about 5 wt %, about 5 wt % to about 35 wt %, about 5 wt % to about 30 wt %, about 5 to about 25 wt %, about 5 wt % to about 20 wt %, about 5 wt % to about 15 wt %, about 5 wt % to about 10 wt %, about 10 wt % to about 35 wt %, about 10 wt % to about 30 wt %, about 10 to about 25 wt %, about 10 wt % to about 20 wt %, about 10 wt % to about 15 wt %, about 15 wt % to about 35 wt %, about 15 wt % to about 30 wt %, about 15 wt % to about 25 wt %, about 15 wt % to about 20 wt %, about 20 wt % to about 35 wt %, about 20 wt % to about 30 wt %, or about 20 wt % to about 25 wt % relative to the volatile profile.

In some embodiments, the lipid composition is characterised by a presence of C₄ to C₁₀ furan in the volatile profile relative to the absence of C₄ to C₁₀ furan in the volatile profile of a control, the control being a lipid composition without a catalyst.

In some embodiments, when heated, the lipid composition is characterised by a volatile profile further comprising C₁ to C₁₅ sulfur-containing compound. The sulfur-containing compound may be methanethiol, dimethyl sulphide, dimethyl disulphide, dimethyl trisulfide, 1-hexenyl isothiocyanate, 3-methylthiopropanal, Bis(1-methylpropyl)disulphide, dially disulphide, diallyl trisulfide, dipropy disulphide, and [3S-(3.alpha.,4.beta.,5.alpha.)]-2H-Thiopyran-3,5-diol tetrahydro-4-nitro-monoacetate (ester). When the lipid composition is heated to temperatures of about 120° C. to about 300° C., the lipid composition may be oxidised into volatiles comprising C₁ to C₁₅ sulfur-containing compound. This may occur when the lipid composition is added to food where the food is grilled, roasted, fried or baked. The food may also be cooked as a soup or sauce.

In some embodiments, the lipid composition is characterised by a wt % of 0 wt % to about 20 wt % of C₁ to C₁₅ sulfur-containing compound relative to the volatile profile. In other embodiments, the wt % is 0 wt % toa bout 15 wt %, 0 wt % to about 10 wt %, 0 wt % to about 5 wt %, about 5 wt % to about 20 wt %, about 5 wt % to about 15 wt %, about 5 wt % to about 10 wt %, about 10 wt % to about 20 wt %, or about 10 wt % to about 15 wt % relative to the volatile profile.

In some embodiments, the lipid composition is characterised by a % increase of C₁ to C₁₅ sulfur-containing compound of about 5% to about 200% in the volatile profile relative to the volatile profile of a control, the control being a lipid composition without a catalyst. In other embodiments, the % increase is about 5% to about 150%, about 5% to about 100%, about 5% to about 50%, about 5% to about 10%, about 10% to about 200%, about 10% to about 150%, about 10% to about 100%, about 10% to about 50%, about 50% to about 200%, about 50% to about 150%, about 50% to about 100%, about 100% to about 200%, or about 100% to about 150% relative to the control.

Different volatile profiles may result in different flavour profiles, such as a beef flavour profile, a pork flavour profile, a mutton flavour profile, a duck flavour profile, a chicken flavour profile and an unagi flavour profile.

The lipid composition may be used as an animal fat additive or animal flavour additive.

In some embodiments, when heated, the lipid composition is characterised by a volatile profile comprising:
a) about 45 wt % to about 90 wt % of aldehyde relative to the volatile profile;
b) about 0.5 wt % to about 20 wt % of alkane relative to the volatile profile;
c) about 0.5 wt % to about 20 wt % of carboxyl relative to the volatile profile;
d) about 1 wt % to about 35 wt % of furan relative to the volatile profile;
e) about 0.5 wt % to about 10 wt % of ketone relative to the volatile profile; and
f) 0 wt % to about 20 wt % of sulfur-containing compound relative to the volatile profile.

The lipid composition may be used as a pork fat or pork meat flavour additive. In some embodiments, when heated, the lipid composition is characterised by a volatile profile comprising:
a) about 50 wt % to about 70 wt % of aldehyde relative to the volatile profile;
b) about 1 wt % to about 10 wt % of alkane relative to the volatile profile;
c) about 1 wt % to about 10 wt % of carboxyl relative to the volatile profile;
d) about 20 wt % to about 35 wt % of furan relative to the volatile profile; and
e) about 0.5 wt % to about 10 wt % of ketone relative to the volatile profile.

The lipid composition may be used as a pork fat additive or pork meat flavour additive. In some embodiments, when heated, the lipid composition is characterised by a volatile profile comprising:
a) about 65 wt % of aldehyde relative to the volatile profile;
b) about 3 wt % of alkane relative to the volatile profile;
c) about 4 wt % of carboxyl relative to the volatile profile;
d) about 27 wt % of furan relative to the volatile profile; and
e) about 1 wt % of ketone relative to the volatile profile.

The lipid composition may be used as a duck fat additive or duck meat flavour additive. In some embodiments, when heated, the lipid composition is characterised by a volatile profile comprising:
a) about 45 wt % to about 65 wt % of aldehyde relative to the volatile profile;
b) about 0.5 wt % to about 5 wt % of alkane relative to the volatile profile;
c) about 0.5 wt % to about 5 wt % of carboxyl relative to the volatile profile;
d) about 20 wt % to about 35 wt % of furan relative to the volatile profile;
e) about 0.5 wt % to about 10 wt % of ketone relative to the volatile profile; and
f) about 5 wt % to about 20 wt % of sulfur-containing compounds relative to the volatile profile.

The lipid composition may be used as a duck fat additive or duck meat flavour additive. In some embodiments, when heated, the lipid composition is characterised by a volatile profile comprising:
a) about 56 wt % of aldehyde relative to the volatile profile;
b) about 1 wt % of alkane relative to the volatile profile;
c) about 1 wt % of carboxyl relative to the volatile profile;
d) about 29 wt % of furan relative to the volatile profile;
e) about 1 wt % of ketone relative to the volatile profile; and
f) about 11 wt % of sulfur-containing compounds relative to the volatile profile.

The lipid composition may be used as a beef fat additive or beef meat flavour additive. In some embodiments, when heated, the lipid composition is characterised by a volatile profile comprising:
a) about 50 wt % to about 70 wt % of aldehyde relative to the volatile profile;
b) about 1 wt % to about 10 wt % of alkane relative to the volatile profile;
c) about 3 wt % to about 15 wt % of carboxyl relative to the volatile profile;
d) about 5 wt % to about 20 wt % of furan relative to the volatile profile;
e) about 0.5 wt % to about 10 wt % of ketone relative to the volatile profile; and
f) about 5 wt % to about 20 wt % of sulfur-containing compounds relative to the volatile profile.

The lipid composition may be used as a beef fat additive or beef meat flavour additive. In some embodiments, when heated, the lipid composition is characterised by a volatile profile comprising:
a) about 65 wt % of aldehyde relative to the volatile profile;
b) about 4 wt % of alkane relative to the volatile profile;
c) about 7 wt % of carboxyl relative to the volatile profile;
d) about 11 wt % of furan relative to the volatile profile;
e) about 1 wt % of ketone relative to the volatile profile; and
f) about 11 wt % of sulfur-containing compounds relative to the volatile profile.

The lipid composition may be used as a mutton fat additive or mutton meat flavour additive. In some embodiments, when heated, the lipid composition is characterised by a volatile profile comprising:
a) about 70 wt % to about 90 wt % of aldehyde relative to the volatile profile;
b) about 1 wt % to about 10 wt % of alkane relative to the volatile profile;
c) about 1 wt % to about 10 wt % of carboxyl relative to the volatile profile;
d) about 5 wt % to about 20 wt % of furan relative to the volatile profile; and
e) about 0.5 wt % to about 10 wt % of ketone relative to the volatile profile.

The lipid composition may be used as a mutton fat additive or mutton meat flavour additive. In some embodiments, when heated, the lipid composition is characterised by a volatile profile comprising:
a) about 83 wt % of aldehyde relative to the volatile profile;
b) about 2 wt % of alkane relative to the volatile profile;
c) about 2 wt % of carboxyl relative to the volatile profile;
d) about 11 wt % of furan relative to the volatile profile; and
e) about 1 wt % of ketone relative to the volatile profile.

In some embodiments, the volatile profile is characterised using solid-phase microextraction gas chromatography. Solid-Phase microextraction (SPME) coupled with gas chromatography (GC) is an analytical technique used for the extraction, concentration, and analysis of volatile and semi-volatile organic compounds from various sample matrices. SPME allows direct extraction from the sample, reducing the need for complex sample preparation steps. SPME may be used to extract a wide range of volatile and semi-volatile organic compounds from various sample matrices, such as food, environmental, and biological samples.

In some embodiments, the lipid composition is encapsulated into a semisolid or solid form. The high level of unsaturation in the lipid composition may result in the lipid composition in its oil form to be unstable and highly sensitive to oxidative degradation. Encapsulation involves the isolation of a compound from its external environment by surrounding it with a secondary material. Encapsulation techniques may include emulsion and emulsion-based systems, liposome encapsulation molecular encapsulation using cyclodextrins, coacervation, co-extrusion, and centrifugal extrusion techniques. The lipid composition may be emulsified in an aqueous phase in the presence of surface-active molecules and other additives such as thickening agents or gelling agents. The lipid composition may be emulsified into a physical form resembling animal fat. In some embodiments, the lipid composition is emulsified to form a semisolid or solid form.

The present disclosure also concerns a method of generating a flavour profile, comprising heating monounsaturated fatty acids, polyunsaturated fatty acids and glycerides in the presence of a catalyst;
wherein the monounsaturated fatty acids is about 10% w/w to about 50% w/w relative to a total composition;
wherein the polyunsaturated fatty acids is about 5% w/w to about 40% w/w relative to the total composition; and
wherein the glycerides is about 30% w/w to about 70% w/w relative to the total composition.

In some embodiments, the method of generating a flavour profile comprises heating monounsaturated fatty acids, polyunsaturated fatty acids and triglycerides in the presence of a catalyst;
wherein the monounsaturated fatty acids is about 20% w/w to about 40% w/w relative to a total composition;
wherein the polyunsaturated fatty acids is about 20% w/w to about 30% w/w relative to the total composition; and
wherein the glycerides is about 40% w/w to about 60% w/w relative to the total composition.

In some embodiments, the method of generating a flavour profile comprises heating monounsaturated fatty acids, polyunsaturated fatty acids and triglycerides in the presence of a catalyst;
wherein the monounsaturated fatty acids is about 10% w/w to about 50% w/w relative to a total composition;
wherein the polyunsaturated fatty acids is about 5% w/w to about 40% w/w relative to the total composition; and
wherein the triglycerides is about 30% w/w to about 70% w/w relative to the total composition.

In some embodiments, the method of generating a flavour profile comprises heating monounsaturated fatty acids, polyunsaturated fatty acids and triglycerides in the presence of a catalyst;
wherein the monounsaturated fatty acids is about 20% w/w to about 40% w/w relative to a total composition;
wherein the polyunsaturated fatty acids is about 5% w/w to about 40% w/w relative to the total composition; and
wherein the triglycerides is about 40% w/w to about 60% w/w relative to the total composition.

In some embodiments, the method of generating a flavour profile comprises heating monounsaturated fatty acids, polyunsaturated fatty acids and triglycerides in the presence of a catalyst;
wherein the monounsaturated fatty acids is about 20% w/w to about 40% w/w relative to a total composition;
wherein the polyunsaturated fatty acids is about 20% w/w to about 30% w/w relative to the total composition; and
wherein the triglycerides is about 40% w/w to about 60% w/w relative to the total composition.

The present disclosure also concerns a method of generating a flavour profile, comprising heating a lipid composition as disclosed herein. The lipid composition may be contained in a mixture. The mixture may be a food composition, a flavour agent added to processed food, such as canned food, packaged soups, frozen meals, chips, crackers, and processed meats such as sausages, hot dogs, ham and salami, and baked goods such as breads, pastries, cakes and cookies.

The present disclosure also concerns a method of generating a flavour profile, comprising heating a mixture, the mixture comprising a lipid composition as disclosed herein.

In some embodiments, the mixture comprises at least one flavour precursor. A flavour precursor is a product which may not necessarily have flavouring properties and may be added to food to produce flavour by breaking down or reacting with other components during food processing. They may contribute to the basic tastes of sweet, salty, bitter and sour of food. A flavour precursor may also be known as a process flavour. A process flavour is a type of flavouring ingredient that is created through various chemical and physical processes. The process flavour may be produced by subjecting a mixture of precursor compounds (e.g. sugars and amino acids) to high temperatures, such as from heating, roasting or frying. Flavour precursors may be sugars, amino acids, inorganic salts, organic acids, peptides, vitamins, and flavour enhancers.

Heating lipids in the presence of amino acids may trigger Maillard reactions, which produce a complex mixture of flavour compounds. Maillard reactions involve the interaction between reducing sugars and amino groups when the lipid composition or food is heated at high temperatures (e.g. baking, roasting or frying), leading to the formation of hundreds of different flavour molecules. When the lipid composition is heated in the presence of proteins, the interactions between the two may generate additional flavour compounds. Amino acids from the proteins may also undergo Maillard reactions with the lipids, further enhancing the flavour profile. Strecker degradation of amino acids by Maillard reaction-derived dicarbonyl compounds may result in an aldehyde forming to the decarboxylation and deamination of an amino acid. An α-aminoketone or amino alcohol may result from the dicarbonyl compound as well. Hydrogen sulfide, ammonia and acetaldehyde are also formed by Strecker degradation when cysteine is used as the amino acid. Maillard reaction-derived carbonyl compounds may react with these compounds, forming intermediates that further involve in flavour-forming reactions. This eventually produces many important classes of flavour compounds including furans, pyrazines, pyrroles, oxazoles, thiophenes, thiazoles and other heterocyclic compounds. These reactions may be responsible for the rich, savoury, and umami flavours associated with fried or roasted foods. The specific flavour profile generated by heating the mixture depends on factors such as the fatty acid composition, the presence of flavour precursors, and the temperature and duration of heating.

In some embodiments, the at least one flavour precursor is selected from sugar, amino acid, vitamin, flavour enhancer, salt and a combination thereof.

Sugars primarily add sweetness to the food and may also create the browning and caramelisation on baked goods and roasted meats. In some embodiments, the sugar is selected from monosaccharides, disaccharides, oligosaccharides, polysaccharides, their derivatives and a combination thereof.

In some embodiments, the amino acid is L-amino acid. L-amino acids are isomers found in proteins. L-amino acids may contribute to the various flavours in food. For example, branched-chain amino acids (Leucine, Isoleucine, Valine) may be converted into compounds contributing to malty, fruity and sweaty flavours; catabolism of aromatic amino acids (Phenylalanine, Tyrosine, Tryptophan) may produce floral, chemical and faecal flavours; aspartic acid (Aspartate) may be catabolised into buttery flavours and sulphuric amino acids (Methionine, Cysteine) may be transferred into compounds contributing to boiled cabbage, meaty and garlic flavours.

Vitamin degradation may result in the formation of flavour precursors that contribute to the meat flavours or interact with other precursors for the production of cooked meat flavours. In some embodiments, the vitamin is selected from Vitamin A, Vitamin B, Vitamin C, Vitamin D, Vitamin E, Vitamin K and a combination thereof.

Flavour enhancers are compounds that are added to a food in order to supplement or enhance its own natural flavours. They may be added to food to create a more robust sensory experience. They may be salt enhancers, such as glutamic acid salt, glycine salt, guanylic acid salt, inosinic acid salt, and 5′-ribonucleotide salt. In some embodiments, the flavour enhancer is selected from glutamic acid salt (monosodium glutamate), glycine salt, guanylic acid salt, inosinic acid salt, 5′-ribonucleotide salts and a combination thereof.

In some embodiments, the salt is sodium chloride.

In some embodiments, the at least one flavour precursor is selected from sugar, amino acid, vitamin, flavour enhancer, sodium chloride and a combination thereof.

In some embodiments, the mixture is characterised by a % w/w of lipid composition of about 40% w/w to about 80% w/w relative to the mixture. In other embodiments, the % w/w is about 40% w/w to about 75% w/w, about 40% w/w to about 70% w/w, about 40% w/w to about 65% w/w, about 40 to about 60% w/w, about 45% w/w to about 80% w/w, about 45% w/w to about 75% w/w, about 45% w/w to about 70% w/w, about 45% w/w to about 65% w/w, about 45% w/w to about 60% w/w, about 50% w/w to about 80% w/w, about 50% w/w to about 75% w/w, about 50% w/w to about 70% w/w, about 50% w/w to about 65% w/w, about 50% w/w to about 60% w/w, about 55% w/w to about 80% w/w, about 55% w/w to about 75% w/w, about 55% w/w to about 70% w/w, or about 55% w/w to about 60% w/w relative to the mixture. In some embodiments, the % w/w is about 50% w/w to about 70% w/w relative to the mixture.

In some embodiments, the mixture is characterised by a % w/w of sugars of about 1% w/w to about 15% w/w relative to the mixture. In other embodiments, the % w/w is about 1% w/w to about 12% w/w, about 1% w/w to about 10% w/w, about 1% w/w to about 8% w/w, about 1% w/w to about 5% w/w, about 3% w/w to about 15% w/w, about 3% w/w to about 12% w/w, about 3% w/w to about 10% w/w, about 3% w/w to about 8% w/w, about 3% w/w to about 5% w/w, about 5% w/w to about 15% w/w, about 5% w/w to about 12% w/w, about 5% w/w to about 10% w/w, about 5% w/w to about 8% w/w, about 8% w/w to about 15% w/w, about 8% w/w to about 12% w/w, or about 8% w/w to about 10% w/w relative to the mixture. In some embodiments, the % w/w is about 5% w/w to about 10% w/w relative to the mixture.

In some embodiments, the mixture is characterised by a % w/w of amino acid of about 5% w/w to about 40% w/w relative to the mixture. In other embodiments, the % w/w is about 5% w/w to about 35% w/w, about 5% w/w to about 30% w/w, about 5% w/w to about 25% w/w, about 5% w/w to about 20% w/w, about 10% w/w to about 40% w/w, about 10% w/w to about 35% w/w, about 10% w/w to about 40% w/w, about 10% w/w to about 25% w/w, about 10% w/w to about 20% w/w, about 15% w/w to about 40% w/w, about 15% w/w to about 35% w/w, about 15% w/w to about 30% w/w, about 15% w/w to about 25% w/w, or about 15% w/w to about 20% w/w relative to the mixture. In some embodiments, the % w/w is about 10% w/w to about 30% w/w relative to the mixture.

In some embodiments, the mixture is characterised by a % w/w of vitamins of about 0.5% w/w to about 10% w/w relative to the mixture. In other embodiments, the % w/w is about 0.5% w/w to about 8% w/w, about 0.5% w/w to about 5% w/w, about 0.5% w/w to about 2% w/w, about 1% w/w to about 10% w/w, about 1% w/w to about 8% w/w, about 1% w/w to about 5% w/w, about 1% w/w to about 2% w/w, about 2% w/w to about 10% w/w, about 2% w/w to about 8% w/w, or about 2% w/w to about 5% w/w relative to the mixture. In some embodiments, the % w/w is about 1% w/w to about 5% w/w relative to the mixture.

In some embodiments, the mixture is characterised by a % w/w of flavour enhancers of about 0.5% w/w to about 10% w/w relative to the mixture. In other embodiments, the % w/w is about 0.5% w/w to about 8% w/w, about 0.5% w/w to about 5% w/w, about 0.5% w/w to about 2% w/w, about 1% w/w to about 10% w/w, about 1% w/w to about 8% w/w, about 1% w/w to about 5% w/w, about 1% w/w to about 2% w/w, about 2% w/w to about 10% w/w, about 2% w/w to about 8% w/w, or about 2% w/w to about 5% w/w relative to the mixture. In some embodiments, the % w/w is about 1% w/w to about 5% w/w relative to the mixture.

In some embodiments, the mixture is characterised by a % w/w of salt of about 1% w/w to about 12% w/w relative to the mixture. In other embodiments, the % w/w is about 1% w/w to about 10% w/w, about 1% w/w to about 8% w/w, about 1% w/w to about 5% w/w, about 1% w/w to about 3% w/w, about 3% w/w to about 12% w/w, about 3% w/w to about 10% w/w, about 3% w/w to about 8% w/w, about 3% w/w to about 5% w/w, about 5% w/w to about 12% w/w, about 5% w/w to about 10% w/w, or about 5% w/w to about 8% w/w relative to the mixture. In some embodiments, the % w/w is about 3% w/w to about 7% w/w relative to the mixture.

In some embodiments, the mixture comprises:
a) a lipid composition as disclosed herein at about 40% w/w to about 80% w/w relative to the mixture;
b) a sugar at about 1% w/w to about 15% w/w relative to the mixture;
c) an amino acid at about 5% w/w to about 40% w/w relative to the mixture;
d) a vitamin at about 0.5% w/w to about 10% w/w relative to the mixture;
e) a flavour enhancer at about 0.5% w/w to about 10% w/w relative to the mixture; and
f) a salt at about 1% w/w to about 12% w/w relative to the mixture.

In some embodiments, the mixture comprises:
a) a lipid composition as disclosed herein at about 50% w/w to about 70% w/w relative to the mixture;
b) a sugar at about 5% w/w to about 10% w/w relative to the mixture;
c) an amino acid at about 10% w/w to about 30% w/w relative to the mixture;
d) a vitamin at about 1% w/w to about 5% w/w relative to the mixture;
e) a flavour enhancer at about 1% w/w to about 5% w/w relative to the mixture; and
f) a salt at about 3% w/w to about 7% w/w relative to the mixture.

In some embodiments, the mixture is hydrated to form a biphasic solution. The biphasic solution consist of an organic phase and an aqueous phase. The mixture may be hydrated with water.

In some embodiments, the mixture is heated at a temperature of about 70° C. to about 400° C.

The mixture may be added to liquid-based food, such as soups, hotpots, and sauces. In some embodiments, the mixture in a liquid-based food is heated at a temperature of about 70° C. to about 150° C. In other embodiments, the temperature is about 70° C. to about 120° C., about 70° C. to about 110° C., about 70° C. to about 100° C., about 70° C. to about 90° C., about 90° C. to about 150° C., about 90° C. to about 120° C., about 90° C. to about 110° C., about 90° C. to about 100° C., about 100° C. to about 150° C., about 100° C. to about 120° C., about 100° C. to about 110° C., about 110° C. to about 150° C., or about 110° C. to about 120° C. In some embodiments, the temperature is about 110° C.

In some embodiments, the mixture in a liquid-based food is stirred for about 2 minutes to about 15 minutes during heating. In other embodiments, the mixture is stirred for about 2 minutes to about 12 minutes, about 2 minutes to about 10 minutes, about 2 minutes to about 8 minutes, about 2 minutes to about 5 minutes, about 5 minutes to about 15 minutes, about 5 minutes to about 12 minutes, about 5 minutes to about 10 minutes, or about 5 minutes to about 8 minutes. In some embodiments, the mixture is stirred for about 7 minutes.

The mixture may be added to food for grilling, roasting, frying and/or baking. In some embodiments, the mixture in a food for grilling, roasting and/or baking is heated i at a temperature of about 150° C. to about 400° C. In other embodiments, the temperature is about 150° C. to about 350° C., about 150° C. to about 300° C., about 150° C. to about 250° C., about 150° C. to about 200° C., about 200° C. to about 400° C., about 200° C. to about 350° C., about 200° C. to about 300° C., about 200° C. to about 250° C., about 250° C. to about 400° C., about 250° C. to about 350° C., or about 250° C. to about 300° C.

In some embodiments, the mixture is oxidised to form volatiles, generating a flavour profile. The abundance of the lipid oxidation products may be positively correlated with olfactory perceptions of meaty aroma profiles. The higher the amount of lipid oxidation products, the stronger the flavour profile. Accordingly, in some embodiments, the flavour profile is characterised by a positive correlation to the amount of volatiles.

In some embodiments, the volatiles comprise alkane, aldehyde, epoxide, thiol, salt, ester, ketone, alcohol, heterocycle, carboxylic acid, hydrazine, or a combination thereof. The volatiles may be carbon dioxide, pentane, hexane, methanethiol, heptane, glycidol, acetaldehyde, propanal, octane, 2-methyl-propanal, 2-propenal, butanal, ethyl acetate, 2-methyl-butanal, 3-methyl-butanal, methyl ether 2-ethyl-1-butanol, 2-ethyl-furan, pentanal, 2-propenyl ester acetic acid, 2-butenal, 2,3-pentanedione, hexanal, diisooctyl ester diphosphoric acid, (E)-2-pentenal, 1-penten-3-ol, heptanal, 2-pentyl-furan, 1-pentanol, octanal, glycerine, (Z)-2-heptenal, nonanal, ammonium acetate, acetic acid, (E)-2-octenal, furfural, formic acid, (E,E)-2,4-heptadienal, benzaldehyde, 1-decanol, (E)-2-nonenal, (E)-2-decenal, (E,E)-2,4-nonadienal, (E)-2-tridecenal, 2-undecenal, [3S-(3.alpha.,4.beta.,5.alpha.)]-2H-Thiopyran-3,5-diol tetrahydro-4-nitro-monoacetate (ester), 3,7,11,15-tetramethyl-hexadecyl ester acetic acid, (E,E)-2,4-decadienal, 2,4-decadienal, 3-(2-oxo-3-cyclohexen-1-yl)-propanoic acid, octanoic acid, trans-3-Nonen-2-one, 4,5-dimethyl-1,3-Dioxol-2-one, nonanoic acid, 1-tetradecanol, decanohydrazide, n-decanoic acid, 2-ethyl-2-hexen-1-ol.

### Examples

This invention seeks to mature the inventors' comprehension of the interaction between fatty acids and our iron-based flavour catalyst system, with the expressed purpose of developing Vegan Versions of Animal Fats (VVAF) which replicate the flavour profile of any animal species when used in conjunction with the inventors' flavour catalyst technology. The potential benefits include the development of highly affordable flavouring ingredients given their derivation from more abundant sources and the introduction of a higher throughput, more cost-effective method for flavour development.

This present disclosure involves the use of lipid molecules, such as but not limited to free fatty acids, fatty acid esters, monoacyl glycerides, diacyl glycerides, triacyl glycerides and phospholipids and other lipid molecules to replicate particular animal fat systems, via specific formulations of these lipid molecules. These lipid molecules, particularly fatty acid molecules, can be short (5 carbon atoms or less), medium (6 to 12 carbon atoms), long (13 to 21 carbon atoms) and very long-chained (22 carbon atoms or more) saturated and/or unsaturated fatty acids either in their free fatty acid forms and/or contained within a triglyceride or phospholipid molecules. These lipid molecules may be derived from plants, insects, fungal, bacterial, and in vitro origins. Herein, these artificial formulations of lipid molecules that are designed to mimic animal fats shall be referred to as VVAF (Vegan Version of Animal Fat) for simplicity.

In some embodiments, VVAF systems are applied into plant-based meat flavourings with other crucial precursors; VVAF and these precursors function as reactants that are converted by the flavour catalyst technology (i.e. Heme B and/or VEMER)) into a targeted matrix of volatiles, with the intention to provide food products with species-specific meat flavours. When the flavour precursor system is thermally activated, the chemical pre-environment (which mimics that of specific animal meats, would result in a distinct cascade of chemical reactions that result in the formation of a chemical environment that is similar to that of animal meats, thereby producing a distinct flavour profile that resembles that of a particular animal. Hence, replicating animal-identical flavour profiles is possible by recreating the composition of key flavour precursors (of animal meats) using vegan-derived ingredients. This invention is intended to be paired with our previously disclosed flavour catalyst technology (namely WO2023/101604A2 and PCT Number SG 10202400548U), where the flavour catalyst technology will react with the fat technology to form and release a matrix of volatiles that are specific to a particular animal species.

### Applications of VVAF Systems

VVAF can be applied to alternative protein products as an ingredient to alter their flavour (by modulating aroma and taste), textural (by changing mouthfeel and melting temperature) and nutritional properties (providing more nutritious unsaturated lipids). The VVAF ingredient can also be formulated into a vegan simulacrum of animal fat, using existing encapsulation and/or emulsification technologies to convert VVAF into a gel, solid emulsion or any other physical incarnations that physically resemble animal fat. VVAF is intended to be paired with Heme and/or VEMER Flavour Catalyst technologies to most efficiently generate meat-identical flavours.

### Example 1: Formulation of an Artificial Fat System Using Vegetable-Derived Fatty Acids to Produce a Pork Flavour, and Comparisons of it to Beef Fat System

Flavouring mixtures containing the following food grade flavour precursors were prepared according to table 1. Mixtures A and B contain a VVAF system comprising of vegetable-derived fatty acids and triglycerides (see Table 2) and is designed to mimic pork, and will be referred to as VVAF Pork (VVAFP). Mixtures C and D contain a lipid system comprising of beef fat and vegetable-derived glycerides. Mixture A and C function as negative controls for their respective fat systems to demonstrate the integral synergy between the lipid systems and the flavour catalyst technology in bringing about species-specific outcomes.

TABLE 1
Example of composition of Mixtures A, B, C and D

| | Compo- | Mix- | Mix- | Mix- | Mix- |
|---|---|---|---|---|---|
| | sition | ture | ture | ture | ture |
| Chemical | (% w/w) | A | B | C | D |
| Sugars (Monosaccharides, | 5-10 | ✓ | ✓ | ✓ | ✓ |
| disaccharides, | | | | | |
| oligosaccharides, | | | | | |
| polysaccharides and their | | | | | |
| derivatives) | | | | | |
| L-amino acid | 10-30 | ✓ | ✓ | ✓ | ✓ |
| Vitamins | 1-5 | ✓ | ✓ | ✓ | ✓ |
| Permitted flavour enhancers | 1-5 | ✓ | ✓ | ✓ | ✓ |
| Sodium chloride | 3-7 | ✓ | ✓ | ✓ | ✓ |
| Vegan Version of | 50-70 | ✓ | ✓ | | |
| Animal Fat, Pork (VVAF) | | | | | |
| Beef Fat System | 50-70 | | | ✓ | ✓ |
| Flavour catalyst (Heme | 0.1-1 | | ✓ | | ✓ |
| B or VEME ®) | | | | | |

VVAFP portions of mixture A and B were prepared according to the following composition as shown in Table 2 and is comprised entirely of plant-derived fatty acids and triacyl glycerides. The Beef Fat system was constituted by combining Beef Fat with Plant-derived triacyl glycerides.

TABLE 2
Example of composition of VVAFP in Mixture A and
B, and Beef Fat system in Mixtures C and D

| | | Composition |
|---|---|---|
| Mixture | Lipid | (% w/w) |
| Mixture A & B | Plant-derived Free Monounsaturated | 20-40 |
| | Fatty Acid | |
| | Plant-derived Free Polyunsaturated | 20-30 |
| | Fatty Acids | |
| | Plant-derived Triacyl glycerides | 40-60 |
| | (Cooking Oil) | |
| Mixture C & D | Beef Fat | 60-80 |
| | Plant-derived Triacyl glycerides | 20-40 |
| | (Cooking Oil) | |

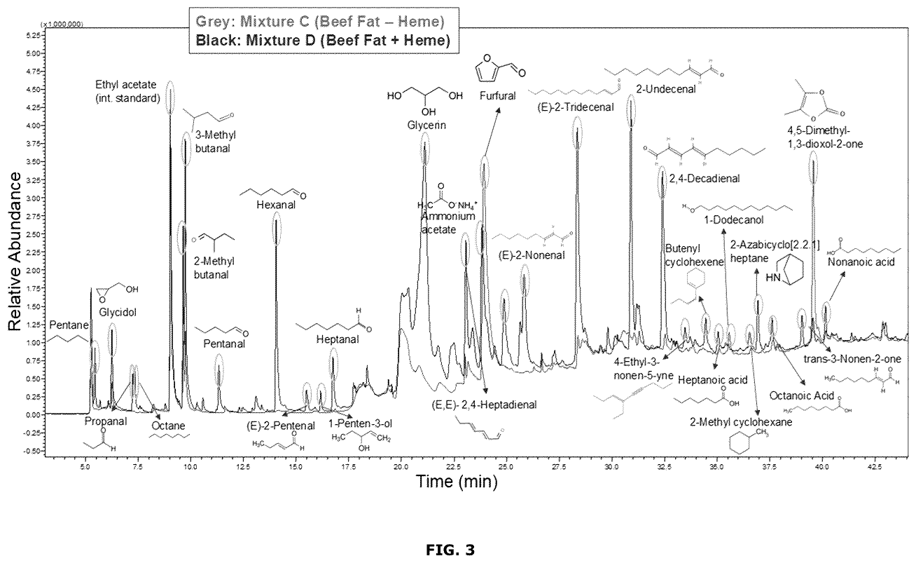

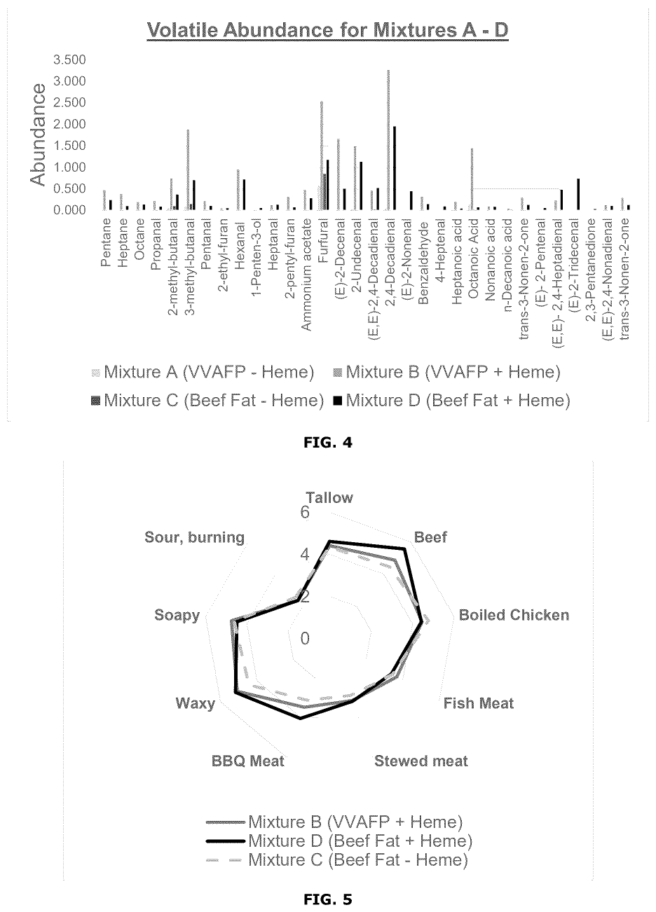

Mixtures A, B, C and D were then hydrated with water to form a biphasic solution system. This system was then heated in a crucible at 110° C. for 7 minutes with constant stirring until the solution had browned and flavours had been developed. The reacted system was then transferred into a 10 mL headspace glass vial and the headspace composition was extracted using Solid-Phase Microextraction Gas Chromatography (SPME-GCMS). The volatiles detected are shown in Table 3. The SPME spectra for Mixtures A and B are shown in FIG. 2, and Mixtures C and D are shown in FIG. 3. The volatile concentrations were quantified by normalising the peak area of a volatile against the peak area of the ethyl acetate internal standard for each run. This data is presented in FIG. 4 and Table 4.

To evaluate the flavours formed in the different mixtures, a sensory test (rate-all-that-apply) was employed, where panellists were first semi-trained on different odour references (see Table 5). Panellists were then asked to rate the odour of mixtures C and D against these references on a 0 to 10 score-based system where 0 signifies reference aroma was not present, indicates that the odour intensity was similar to reference and 10 indicates that odour was stronger than the reference. The data was then plotted in a radial diagram shown in FIG. 5.

Generally, Mixture B and D showed a greater abundance and diversity of volatiles compared to their respective negative controls, indicating that Heme flavour catalyst system catalyses the formation of more volatiles. Mixture B and D also showed a significant increase in aldehyde, alkanes and alcohol production, such as hexanal and 2,4-decadienal, volatiles which have been noted by colleagues to contribute to “meaty” odours in animal meats. Moreover, Mixture B's volatile profile was distinctly different from that of Mixture D, with Mixture D showing the presence of volatiles such as (E)-2-Nonenal, 4-Heptenal, (E)-2-Pentenal, (E)-2-Tridecanal and 2,3-Pentadione (see Table 4)., which are entirely absent in Mixture B. Moreover, the divergences in volatile outputs between the mixtures also translated into differences in flavour perception (see FIG. 5), as Mixture D was perceived to be 25% more beefy compared to Mixture C. These results also validate that the composition of fat system critically determines the volatile profile of the flavour mixture and in turn, dictates the flavour outcome. Finally, these results also validate that VVAF comprising of vegetable-derived lipids can similarly produce animal-identical when reacted with the Heme Flavour Catalyst technology, as evidenced as Mixture B has an aroma profile that is meatier than Mixture C, which utilises Beef Fat.

TABLE 3
Full list of Volatiles detected using GCMS-SPME on Mixtures A, B, C and D

| | Retention | Functional | Mixture | Mixture | Mixture | Mixture |
|---|---|---|---|---|---|---|
| Volatile | Time (min) | Group | A | B | C | D |
| Carbon dioxide | 5.273 | N/A | ✓ | ✓ | ✓ | ✓ |
| Pentane | 5.451 | Alkane | | ✓ | | ✓ |
| Hexane | 5.698 | Alkane | | ✓ | | ✓ |
| Methanethiol | 6.093 | Thiol | ✓ | ✓ | ✓ | ✓ |
| Heptane | 6.246 | Alkane | | ✓ | | |
| Glycidol | 6.251 | Epoxide | | | | ✓ |
| Acetaldehyde | 6.267 | Aldehyde | ✓ | | ✓ | |
| Propanal | 7.249 | Aldehyde | | ✓ | | ✓ |
| Octane | 7.342 | Alkane | | ✓ | | ✓ |
| Propanal, 2-methyl- | 7.583 | Aldehyde | | | | ✓ |
| 2-Propenal | 8.234 | Aldehyde | | | | ✓ |
| Butanal | 8.795 | Aldehyde | | | | ✓ |
| Ethyl Acetate | 9.034 | Internal | ✓ | ✓ | ✓ | ✓ |
| | | Standard | | | | |
| Butanal, 2-methyl- | 9.644 | Aldehyde | ✓ | ✓ | ✓ | ✓ |
| Butanal, 3-methyl- | 9.745 | Aldehyde | ✓ | ✓ | ✓ | ✓ |
| 2-Ethyl-1-butanol, | 10.302 | Ester | | | | ✓ |
| methyl ether | | | | | | |
| Furan, 2-ethyl- | 10.582 | Heterocycle | | ✓ | | ✓ |
| Pentanal | 11.331 | Aldehyde | | ✓ | | ✓ |
| Acetic acid, 2- | 12.298 | Ester | | | | ✓ |
| propenyl ester | | | | | | |
| 2-Butenal | 13.099 | Aldehyde | | | | ✓ |
| 2,3-Pentanedione | 13.374 | Ketone | | | | ✓ |
| Hexanal | 14.052 | Aldehyde | | ✓ | | ✓ |
| Diphosphoric acid, | 15.491 | Ester | | ✓ | | |
| diisooctyl ester | | | | | | |
| 2-Pentenal, (E)- | 15.495 | Aldehyde | | | | ✓ |
| 1-Penten-3-ol | 16.159 | Alcohol | | ✓ | | ✓ |
| Heptanal | 16.747 | Aldehyde | | ✓ | | ✓ |
| Furan, 2-pentyl- | 17.729 | Heterocycle | | ✓ | | ✓ |
| 1-Pentanol | 18.373 | Alcohol | | ✓ | | ✓ |
| Octanal | 19.388 | Aldehyde | | | | ✓ |
| Glycerin | 20.658 | Alcohol | | ✓ | ✓ | ✓ |
| 2-Heptenal, (Z)- | 20.740 | Aldehyde | | ✓ | | |
| Nonanal | 22.498 | Aldehyde | | | | ✓ |
| Ammonium acetate | 23.074 | Salt | | ✓ | | ✓ |
| Acetic acid | 23.211 | Carboxylic | ✓ | | | |
| | | Acid | | | | |
| 2-Octenal, (E)- | 23.392 | Aldehyde | | | | ✓ |
| Furfural | 23.892 | Aldehyde | ✓ | ✓ | ✓ | ✓ |
| Formic acid | 24.435 | Carboxylic | | | | ✓ |
| | | Acid | | | | |
| 2,4-Heptadienal, | 24.877 | Aldehyde | | ✓ | | ✓ |
| (E,E)- | | | | | | |
| Benzaldehyde | 25.645 | Aldehyde | | ✓ | | ✓ |
| 1-Decanol | 25.800 | Alcohol | | ✓ | | |
| 2-Nonenal, (E)- | 25.834 | Aldehyde | | | | ✓ |
| 2-Decenal, (E)- | 28.303 | Aldehyde | | ✓ | | |
| 2-Tridecenal, (E)- | 28.356 | Aldehyde | | | | ✓ |
| 2,4-Nonadienal, | 29.775 | Aldehyde | | ✓ | | ✓ |
| (E,E)- | | | | | | |
| 2-Undecenal | 30.959 | Aldehyde | ✓ | ✓ | ✓ | ✓ |
| 2H-Thiopyran-3,5- | 31.261 | Sulfur | | ✓ | | |
| diol, tetrahydro-4- | | Heterocycle | | | | |
| nitro-, monoacetate | | | | | | |
| (ester), [3S- | | | | | | |
| (3.alpha.,4.beta.,5.alpha.)]- | | | | | | |
| Acetic acid, | 31.287 | Ester | | | ✓ | |
| 3,7,11,15- | | | | | | |
| tetramethyl- | | | | | | |
| hexadecyl ester | | | | | | |
| 2,4-Decadienal, | 31.603 | Aldehyde | | ✓ | ✓ | ✓ |
| (E,E)- | | | | | | |
| 2,4-Decadienal | 32.424 | Aldehyde | ✓ | ✓ | | ✓ |
| 3-Nonen-5-yne, 4- | 33.454 | Alkyne | | ✓ | | ✓ |
| ethyl- | | | | | | |
| Cyclohexene, | 34.458 | Alkene | | | | ✓ |
| butenyl- | | | | | | |
| Heptanoic acid | 35.066 | Carboxylic | ✓ | ✓ | | ✓ |
| | | Acid | | | | |
| 1-Dodecanol | 35.576 | Alcohol | | | ✓ | |
| 2- | 36.933 | | | | | ✓ |
| Azabicyclo[2.2.1]heptane | | | | | | |
| Propanoic acid, 3- | 36.939 | Ester | | ✓ | | |
| (2-oxo-3- | | | | | | |
| cyclohexen-1-yl)- | | | | | | |
| Octanoic Acid | 37.625 | Carboxylic | ✓ | ✓ | ✓ | ✓ |
| | | Acid | | | | |
| trans-3-Nonen-2- | 39.028 | Ketone | | ✓ | | ✓ |
| one | | | | | | |
| 1,3-Dioxol-2- | 39.557 | Ketone | ✓ | ✓ | ✓ | ✓ |
| one,4,5-dimethyl- | | | | | | |
| Nonanoic acid | 40.147 | Carboxylic | | ✓ | ✓ | ✓ |
| | | Acid | | | | |
| 1-Tetradecanol | 40.441 | Alcohol | | | ✓ | ✓ |
| Decanohydrazide | 41.376 | Hydrazine | | | | ✓ |
| n-Decanoic acid | 42.859 | Carboxylic | | | ✓ | ✓ |
| | | Acid | | | | |
| 2-Hexen-1-ol, 2- | 42.997 | Alcohol | | | | ✓ |
| ethyl- | | | | | | |

TABLE 4
List of selected volatiles and their abundance levels
(relative to ethyl acetate internal standard).

| | | | Mix- | Mix- |
|---|---|---|---|---|
| | Mix- | Mix- | ture C | ture D |
| | ture A | ture B | (Beef | (Beef |
| | (VVAFP − | (VVAFP + | Fat − | Fat + |
| Volatiles | Heme) | Heme) | Heme) | Heme) |
| Pentane | x | 0.46 | x | 0.23 |
| Heptane | x | 0.37 | x | 0.09 |
| Octane | x | 0.19 | x | 0.13 |
| Propanal | x | 0.22 | x | 0.08 |
| 2-methyl-butanal | 0.07 | 0.74 | 0.09 | 0.36 |
| 3-methyl-butanal | 0.10 | 1.88 | 0.14 | 0.70 |
| Pentanal | x | 0.22 | x | 0.10 |
| 2-ethyl-furan | x | 0.05 | x | 0.04 |
| Hexanal | x | 0.94 | x | 0.71 |
| 1-Penten-3-ol | x | 0.01 | x | 0.05 |
| Heptanal | x | 0.12 | x | 0.13 |
| 2-pentyl-furan | x | 0.31 | x | 0.07 |
| Ammonium acetate | x | 0.47 | x | 0.28 |
| Furfural | 0.60 | 2.54 | 0.85 | 1.17 |
| (E)-2-Decenal | x | 1.66 | x | 0.50 |
| 2-Undecenal | 0.05 | 1.48 | x | 1.13 |
| (E,E)-2,4-Decadienal | x | 0.45 | 0.02 | 0.51 |
| 2,4-Decadienal | 0.05 | 3.27 | x | 1.95 |
| (E)-2-Nonenal | x | x | x | 0.44 |
| Benzaldehyde | x | 0.32 | x | 0.14 |
| 4-Heptenal | x | x | x | 0.09 |
| Heptanoic acid | 0.02 | 0.20 | x | 0.04 |
| Octanoic Acid | 0.15 | 1.44 | 0.02 | 0.07 |
| Nonanoic acid | x | 0.09 | 0.01 | 0.08 |
| n-Decanoic acid | x | x | 0.02 | 0.01 |
| trans-3-Nonen-2-one | x | 0.29 | x | 0.12 |
| (E)-2-Pentenal | x | x | x | 0.05 |
| (E,E)-2,4-Heptadienal | x | 0.23 | x | 0.47 |
| (E)-2-Tridecenal | x | x | x | 0.73 |
| 2,3-Pentanedione | x | x | x | 0.02 |
| (E,E)-2,4-Nonadienal | x | 0.13 | x | 0.10 |
| 2-methyl cyclohexane | x | x | x | 0.03 |
| trans-3-Nonen-2-one | x | 0.29 | x | 0.12 |

x indicates no detectable quantity of that volatile.

TABLE 5
References used for training sensory panellists
and for aroma evaluation of Mixture C and D

| Reference | Reference |
|---|---|
| Beef | Australian Angus Beef mince (25 g), pan fried for 3.5 min |
| Tallow | Remaining oil (sunflower and canola blend) (2 g) from pan |
| | frying beef |
| (Boiled) | Knorr Chicken stock cubes No added MSG (10 mg/mL) |
| Chicken | |
| Stewed | Heated control (Maillard mixture with coconut oil) |
| meat | |
| Waxy | Linoleic acid |
| Soapy | Oleic acid |
| Fish Meat | Knorr Fish Stock cubes (10 mg/mL) |
| Sour | 1% Acetic Acid Aqueous solution |
| burning | |
| BBQ Meat | Heated control (Maillard Mixture with canola oil) |

### Example 2: Interaction of Sodium Iron Chlorophyllin-Based Flavour Catalysts with Different Animal-Based Fat Systems

To test the generality of our VVAF hypothesis, we decided to determine the effects of the flavour catalyst technology on different animal-based fat systems, to ascertain if species-specificity is determined by the composition of different fatty acids. To this end, we prepared various flavour mixtures with the following compositions as shown in Table 6, whereby different plant-based fats and animal-based fats were used to selectively produce species-specific flavour outcomes upon reaction with our sodium iron chlorophyllin-based (SIC) flavour catalyst system.

TABLE 6
Example of species-specific replicas of different meat flavours.
Flavours and ingredients are from non-animal origins unless otherwise
stated. Units are in g/mL of the final hydrated solution.

| | Pork-replica | Fish-replica | Beef-replica | Mutton-replica |
|---|---|---|---|---|
| SIC or HIC | 0.00053 | 0.00053 | 0.00053 | 0.00053 |
| flavour | | | | |
| catalyst (g/mL) | | | | |
| Premix of L- | 0.067 | 0.067 | 0.067 | 0.067 |
| amino acid, | | | | |
| sugars, salt, | | | | |
| permitted flavour | | | | |
| enhancers and | | | | |
| vitamins (g/mL) | | | | |
| Canola oil (g/mL) | 0.12 | 0.18 | 0.05 | 0.05 |
| Specific | 0.038 g/ml of | 0.020 g/ml of | 0.15 g/mL of | 0.15 g/mL of |
| lipids (g/mL) | plant-sourced | algae-sourced | extracted beef | extracted |
| | linoleic acid | docosahexaenoic | fat (non-vegan) | mutton fat |
| | and 0.067 g/ml | acid. | | (non-vegan) |
| | of plant- | | | |
| | sourced oleic | | | |
| | acid | | | |

Each mixture was hydrated separately with water to form a water-and-oil mixture which was heated separately in a crucible at 110° C. for 7 minutes for flavour generation reactions to take place. The cooked mixtures were transferred to a 10 mL headspace glass vial and the headspace composition was analysed using Solid-Phase Microextraction (SPME) with gas-chromatography mass-spectrometry (GCMS). The profile of volatile odorous compounds is shown in Table 3, while there were some common volatiles, there were some unique volatiles to each formulation that may account for differences in the aroma. The volatiles mainly comprise of Maillard reaction products like 2 and 3-methyl butanal as well as lipid oxidation products like hexanal and 2,4-decadienal, which are also present in analysis of cooked animal meats. Compounds like 2-methyl-3-furanthiol contribute to a cooked meat smell and 4-methyl-5-thiazoleethanol contributes to a beefy flavour. Others like hexanal and (E,E)-2,4-decadienal contributes to a fatty flavour in meat.

TABLE 7
List of volatiles present in the heated samples

| Retention | | | | | | |
|---|---|---|---|---|---|---|
| time | | Functional | Pork- | Fish- | Beef- | Mutton- |
| (min) | Compound | group | replica | replica | replica | replica |
| 5.574 | Pentane | alkane | ✓ | ✓ | ✓ | ✓ |
| 6.407 | Heptane | alkane | ✓ | | ✓ | ✓ |
| 7.474 | 2,3-Dimethyl- | aldehyde | | ✓ | | |
| | pentanal | | | | | |
| 7.651 | Octane | alkane | ✓ | | ✓ | ✓ |
| 9.336 | Butanal | aldehyde | | | | ✓ |
| 10.313 | 2-Methyl butanal | aldehyde | | | ✓ | |
| 10.355 | 3-Methyl butanal | aldehyde | ✓ | ✓ | ✓ | ✓ |
| 10.996 | 2-Nonanol | alcohol | | | | ✓ |
| 11.306 | 2-Ethyl furan | furan | ✓ | ✓ | | ✓ |
| 12.129 | Pentanal | aldehyde | ✓ | ✓ | ✓ | ✓ |
| 13.338 | 1-Penten-3-one | ketone | | | | ✓ |
| 13.781 | 1-Decene | alkene | | | | ✓ |
| 13.984 | 2-Butenal | aldehyde | | | | ✓ |
| 14.281 | 2,3-Pentanedione | ketone | | ✓ | | ✓ |
| 14.925 | Hexanal | aldehyde | ✓ | ✓ | ✓ | ✓ |
| 16.32 | (E)-2-Pentenal | aldehyde | | | | ✓ |
| 16.921 | 1-Penten-3-ol | alcohol | ✓ | ✓ | | ✓ |
| 17.476 | Heptanal | aldehyde | ✓ | | | ✓ |
| 18.344 | 2-Pentyl furan | furan | ✓ | | | ✓ |
| 18.932 | 2,4-Nonadienal | aldehyde | ✓ | | | |
| 18.991 | 1-Pentanol | alcohol | ✓ | | | |
| 20.032 | Octanal | aldehyde | ✓ | | | ✓ |
| 20.304 | 2-Methyl-3- | Thiol | ✓ | | | |
| | furanthiol | | | | | |
| 20.503 | 2,3-Octanedione | ketone | ✓ | | | |
| 21.408 | (Z)-2-Heptenal | aldehyde | ✓ | | | ✓ |
| 22.538 | Nonanal | aldehyde | ✓ | ✓ | ✓ | ✓ |
| 22.954 | 1-Octen-3-ol | alcohol | | ✓ | | |
| 23.292 | (E)-2-Octenal | aldehyde | ✓ | ✓ | ✓ | ✓ |
| 23.592 | Furfural | furan | ✓ | ✓ | ✓ | ✓ |
| 24.07 | 2-Tetradecanol | alcohol | | | | ✓ |
| 24.492 | (E,E)-2,4- | aldehyde | ✓ | ✓ | ✓ | ✓ |
| | Heptadienal | | | | | |
| 25.279 | (E)-2-Nonenal | aldehyde | ✓ | ✓ | ✓ | ✓ |
| 25.982 | 3,5-Octadien-2- | ketone | | | | ✓ |
| | one | | | | | |
| 26.281 | (E,Z)-2,6- | aldehyde | | | | ✓ |
| | Nonadienal | | | | | |
| 26.419 | Hexadecanol | alcohol | | | | ✓ |
| 27.473 | (E)-2-Decenal | aldehyde | ✓ | | ✓ | ✓ |
| 28.023 | (E)-2-Tridecenal | aldehyde | | ✓ | | |
| 28.85 | (E,E)-2,4- | aldehyde | ✓ | ✓ | ✓ | ✓ |
| | Nonadienal | | | | | |
| 29.881 | 2-Undecenal | aldehyde | ✓ | ✓ | ✓ | ✓ |
| 30.49 | 4-Methyl-5- | Sulfur | | | ✓ | |
| | thiazoleethanol | Heterocycle | | | | |
| 31.432 | 2,4-Decadienal | aldehyde | ✓ | ✓ | ✓ | ✓ |
| 31.832 | (Z)-7- | aldehyde | ✓ | | | |
| | Tetradecenal | | | | | |
| 32.091 | Heptanoic acid | carboxylic | ✓ | | | |
| | | acid | | | | |
| 33.119 | Tetradecanoic | carboxylic | ✓ | | ✓ | |
| | acid | acid | | | | |
| 36.295 | 4-Heptenal | aldehyde | | ✓ | ✓ | ✓ |
| 36.438 | 2-Pentadecanone | ketone | | | | ✓ |
| 36.976 | Octanoic Acid | carboxylic | ✓ | | ✓ | ✓ |
| | | acid | | | | |
| 38.386 | trans-3-Nonen-2- | ketone | ✓ | ✓ | ✓ | ✓ |
| | one | | | | | |
| 39.584 | Nonanoic acid | carboxylic | ✓ | | ✓ | ✓ |
| | | acid | | | | |
| 39.935 | 2-Octenoic acid | carboxylic | ✓ | | | |
| | | acid | | | | |

Similar to the GCMS results, the different formulations resulted differing sensory experience. Simple flavour descriptions were provided for each sample, presented in Table 8.

TABLE 8
Description of the flavours of heated example formulations

| Example | Flavour description of cooked samples |
|---|---|
| Pork-replica | Cooked pork, bacon-like |
| Fish-replica | Fatty fish, reminiscent of salmon, |
| | grilled mackerel |
| Beef-replica | Grilled beef steak, tallow |
| Mutton-replica | Grilled mutton, gamey |

Therefore, the results in Table 8 strongly validates the notion that different fatty acid compositions critically determine the species-specificity of the flavour outcome, by dictating the types of volatiles formed during the cooking process. Most notably, the pork-replica and fish-replica were constructed using entirely vegetable-derived fatty acids, yet still formed flavour outcomes that are strongly reminiscent of their animal-based targets. Hence, this indicates that the VVAF concept is functional and correct. Moreover, these results also imply that beef-replica and mutton-replica can be translated into completely vegan ingredients should the correct flavour precursors, which are most likely lipid-based molecules, be identified and be incorporated into VVAF.

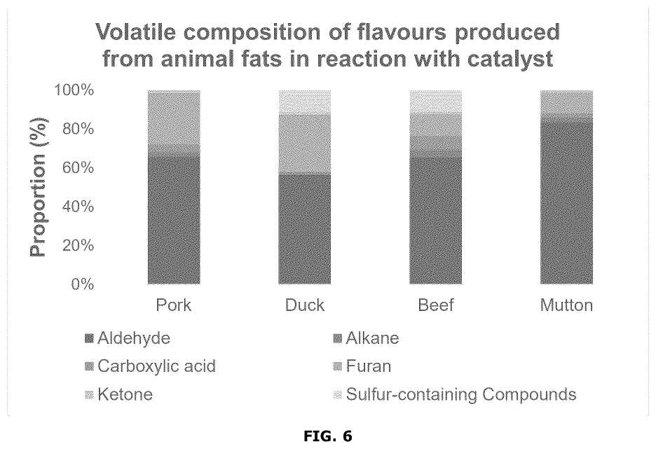

The specific composition (identity and quantity) of the volatile matrix determines the species-specificity of a flavour. Based on our studies (FIG. 6 and Table 9), the volatiles produced from pork flavour approximately consists of 65% aldehydes, 3% alkanes, 4% carboxylic acids, 27% furans, 1% ketones. Duck flavour produces volatiles that contain approximately 56% aldehydes, 1% alkanes, 1% carboxylic acids, 29% furans, 1% ketones and 11% sulfur-containing compounds. Beef Flavour produces volatiles that approximately contain 65% aldehydes, 4% alkanes, 7% carboxylic acids, 11% furans, 1% ketones, 11% sulfur-containing compounds. Mutton flavour produces a volatile matrix that approximately contains 83% aldehydes, 2% alkanes, 2% carboxylic acids, 11% furans and 1% ketones.

TABLE 9
Volatile matrices of the different flavours

| | Fat Type | | | |
|---|---|---|---|---|
| Volatile type | Pork | Duck | Beef | Mutton |
| Aldehyde | 65% | 56% | 65% | 83% |
| Alkane | 3% | 1% | 4% | 2% |
| Carboxylic acid | 4% | 1% | 7% | 2% |
| Furan | 27% | 29% | 11% | 11% |
| Ketone | 1% | 1% | 1% | 1% |
| Sulfur-containing Compounds | 0% | 11% | 11% | 0% |

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout this specification and the claims which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A lipid composition, comprising:
a) monounsaturated fatty acids at about 10% w/w to about 50% w/w relative to the lipid composition;
b) polyunsaturated fatty acids at about 5% w/w to about 40% w/w relative to the lipid composition;
c) glycerides at about 30% w/w to about 70% w/w relative to the lipid composition; and
d) a catalyst for oxidising the fatty acids and glycerides into volatiles in the presence of heat.

2. The lipid composition according to claim 1, wherein the monounsaturated fatty acids, polyunsaturated fatty acids and glycerides are derived from plant, fungal, insect, bacterial, in vitro origin and a combination thereof.

3. The lipid composition according to claim 1, wherein the monounsaturated fatty acids, polyunsaturated fatty acids and glycerides are derived from a plant source, the plant source is a vegetable oil, the vegetable oil comprising less than about 1 wt % of antioxidants.

4. The lipid composition according to claim 1, wherein the monounsaturated fatty acids comprise a first C₁₀-C₂₄ monounsaturated fatty acid and a second C₁₀-C₂₄ monounsaturated fatty acid, wherein a concentration of the first monounsaturated fatty acid is about 0.5 times to about 5 times more than a concentration of the second monounsaturated fatty acid.

5. The lipid composition according to claim 1, wherein the polyunsaturated fatty acids comprise a first C₁₀-C₂₄ polyunsaturated fatty acid and a second C₁₀-C₂₄ polyunsaturated fatty acid, wherein a concentration of the first polyunsaturated fatty acid is about 0.5 times to about 5 times more than a concentration of the second polyunsaturated fatty acid.

6. The lipid composition according to claim 1, wherein the catalyst is an iron-containing complex selected from heme, iron chlorophyllin, a derivative, salt, solvate and a combination thereof.

7. The lipid composition according to claim 1, wherein the catalyst is at about 0.05% w/w to about 2% w/w relative to the lipid composition.

8. The lipid composition according to claim 1, wherein the lipid composition further comprises a saturated fatty acid at about 20% w/w to about 60% w/w relative to the lipid composition.

9. The lipid composition according to claim 1, wherein the volatiles comprise alkane, aldehyde, epoxide, thiol, salt, ester, ketone, alcohol, heterocycle, carboxylic acid, hydrazine, or a combination thereof.

10. The lipid composition according to claim 1, wherein when heated, the lipid composition is characterised by a volatile profile comprising C₁ to C₁₅ acyl compound, wherein the lipid composition is characterised by a wt % of about 0.5 wt % to about 90 wt % of C₁ to C₁₅ acyl compound relative to the volatile profile.

11. The lipid composition according to claim 1, wherein when heated, the lipid composition is characterised by a volatile profile further comprising C₁ to C₁₅ alcohol; wherein the lipid composition is characterised by a wt % of about 5 wt % to about 20 wt % of C₁ to C₁₅ alcohol relative to the volatile profile.

12. The lipid composition according to claim 1, wherein when heated, the lipid composition is characterised by a volatile profile further comprising C₁ to C₁₅ carboxyl compound; wherein the lipid composition is characterised by a wt % of about 0.5 wt % to about 20 wt % of C₁ to C₁₅ carboxyl compound relative to the volatile profile.

13. The lipid composition according to claim 1, wherein when heated, the lipid composition is characterised by a volatile profile further comprising C₅ to C₁₅ alkane; wherein the lipid composition is characterised by a wt % of about 0.5 wt % to about 20 wt % of C₅ to C₁₅ alkane relative to the volatile profile.

14. The lipid composition according to claim 1, wherein when heated, the lipid composition is characterised by a volatile profile further comprising C₄ to C₁₀ furan; wherein the lipid composition is characterised by a wt % of about 1 wt % to about 35 wt % of C₄ to C₁₀ furan relative to the volatile profile.

15. The lipid composition according to claim 1, wherein when heated, the lipid composition is characterised by a volatile profile further comprising C₁ to C₁₅ sulfur-containing compound; wherein the lipid composition is characterised by a wt % of 0 wt % to about 20 wt % of C₁ to C₁₅ sulfur-containing compound relative to the volatile profile.

16. A method of generating a flavour profile, comprising heating a lipid composition according to claim 1.

17. A method of generating a flavour profile, comprising heating a mixture, the mixture comprising a lipid composition according to claim 1.

18. The method according to claim 17, wherein the mixture comprises at least one flavour precursor selected from sugar, amino acid, vitamin, flavour enhancer, salt and a combination thereof.

19. The method according to claim 18, wherein the mixture is characterised by a % w/w of lipid composition of about 40% w/w to about 80% w/w relative to the mixture.

20. The method according to claim 18, wherein the mixture is oxidised to form volatiles, generating a flavour profile, the volatiles comprising alkane, aldehyde, epoxide, thiol, salt, ester, ketone, alcohol, heterocycle, carboxylic acid, hydrazine, or a combination thereof; wherein the flavour profile is characterised by a positive correlation to the amount of volatiles.
